(19) United States
(12) Patent Application Publication
(10) Pub. No.: US 2007/0232492 A1
(43) Pub. Date: Oct. 4, 2007

(54) Herbicidal Composition

(75) Inventors: Hiroshi Kikugawa, Kusatsu-shi (JP); Ken Ohno, Kusatsu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ishihara Sangyo Kaisha, LTD., Oaska (JP)

(21) Appl. No.: 11/575,229

(22) PCT Filed: Sep. 16, 2005
(86) PCT No.: PCT/JP05/17198

§ 371 Date: Mar. 14, 2007

(30) Foreign Application Priority Data
Sep. 17, 2004 (JP) 2004-271283
Oct. 22, 2004 (JP) 2004-307850
Nov. 18, 2004 (JP) 2004-334938
Dec. 7, 2004 (JP) 2004-353851
Dec. 20, 2004 (JP) 2005-367296
Feb. 10, 2005 (JP) 2005-035195
Feb. 25, 2005 (JP) 2005-051663
Mar. 10, 2005 (JP) 2005-067110
Jul. 12, 2005 (JP) 2005-202840

(51) Int. Cl. A01N 41/00; A01N 25/00; A01N 33/00

(52) U.S. Cl. 504/118; 504/130; 504/136; 504/144; 504/148; 504/149

(57) ABSTRACT

To provide a herbicidal composition having a wide herbicidal spectrum, being highly active and having a long lasting effect.
A herbicidal composition comprising (α) a compound of the formula (I) or its salt: 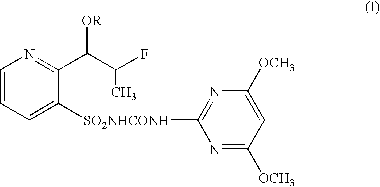
wherein R is a hydrogen atom or —COCH₂OCH₃ and (β): at least one compound selected from the group consisting of the following compounds, as active ingredients: at least one sulfonylurea compound selected from (B1.1) bensulfuron-methyl, (B1.2) azimsulfuron, etc.; (B2.1) pyriminobac-methyl; an acetamide compound such as (B3.1) pretilachlor, etc.; at least one benzoyl compound selected from (B4.1) benzobicyclon, (B4.2) mesotrione, etc.; (B5.1) simetryn; and so on.

### TECHNICAL FIELD

The present invention relates to a herbicidal composition comprising (α) {a compound of the after-mentioned formula (I) or its salt} and (β) at least one compound selected from the group consisting of {after-mentioned compounds (B), (C) and (D)} as active ingredients. Further, it relates to a method to reduce unfavorable effects of (α) {a compound of the after-mentioned formula (I) or its salt} against useful crop plants.

### BACKGROUND ART

In recent years, so-called selective herbicides having both safety for useful crop plants and herbicidal effects against undesired plants are actively used, but even a highly selective herbicide has phytotoxicity depending upon various conditions such as weather conditions, soil conditions, varieties of the crop plants, and the timing for the application of the herbicide in some cases. To cope with such an unanticipated situation, use of various safener has been studied, but the selection of the safener varies depending upon the type of the herbicide with which the safener is used in combination and depends on trial and error studies. Further, it is more desired to apply a herbicide with broad herbicidal spectrum to crop plants at a dosage as low as possible, thus reducing the load to the ecosystem such as rivers, the soil and the ocean. Heretofore, search for compounds to be novel herbicidally active ingredients has been conducted, but the search is not easy and takes long, and accordingly it has been attempted to combine existing herbicides to develop synergistic herbicidal effects. However, this attempt also depends on trial and error studies in the same manner as above.

WO02/30921 or WO92/14728 discloses a compound of the after-mentioned formula (I), and the latter exemplifies known herbicidal ingredients which may be mixed with the compound of the after-mentioned formula (I) wherein substituent R is a hydrogen atom. In such exemplification, some compounds among the after-mentioned compound group (β) are disclosed. However, they are simply listed as known herbicidal ingredients and not specifically described as specified in the after-mentioned herbicidal composition of the present invention. Further, these publications fail to disclose any technique to reduce unfavorable effects of the after-mentioned compound of the formula (I) or its salt against crop plants.

Patent Document 1: WO02/30921

Patent Document 2: WO92/14728

### DISCLOSURE OF THE INVENTION

### Object to be Accomplished by the Invention

At present, many herbicidal compositions have been developed and used. However, types of weeds to be controlled are also many, and their emergence extends over a long period. Accordingly, it is desired that a herbicidal composition be developed which has a wider herbicidal spectrum and which is highly active and has a long lasting effect. Further, (α) {a compound of the after-mentioned formula (I) or its salt} brings about unfavorable effects against crop plants in some cases depending upon various conditions at the actual application site, and accordingly it is preferred to take steps to reduce possibility of such problems as far as possible, so as to improve usefulness.

### MEANS TO ACCOMPLISH THE OBJECT

The present inventors have conducted extensive studies to achieve the above object and as a result, they have found that a highly useful herbicidal composition can be obtained by using (α) {a compound of the after-mentioned formula (I) or its salt} and (β) at least one compound selected from {after-mentioned compounds (B), (C) and (D)} in combination. In addition, they have further found that a herbicidal composition which reduces unfavorable effects of (α) {a compound of the after-mentioned formula (I) or its salt} against crop plants which may possibly be brought about depending upon various conditions, can be obtained by combination with the after-mentioned compound (D). The present invention has been accomplished based on these discoveries.

Namely, the present invention relates to a herbicidal composition comprising (α): {a compound of the formula (I) or its salt (hereinafter referred to simply as the compound (α)): 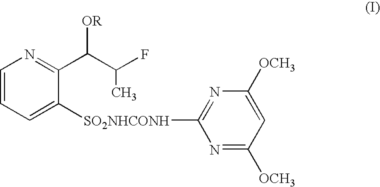
wherein R is a hydrogen atom or —COCH₂OCH₃} and

(β): at least one compound selected from the group consisting of [(B): {at least one sulfonylurea compound selected from (B1.1) bensulfuron-methyl, (B1.2) azimsulfuron, (B1.3) pyrazosulfuron-ethyl, (B1.4) imazosulfuron, (B1.5) ethoxysulfuron and (B1.6) halosulfuron-methyl;

at least one pyrimidinyl salicylic acid compound selected from (B2.1) pyriminobac-methyl and (B2.2) KUH-021;

at least one acetamide compound selected from (B3.1) pretilachlor and (B3.2) thenylchlor;

at least one benzoyl compound selected from (B4.1) benzobicyclon, (B4.2) mesotrione, (B4.3) pyrazoxyfen, (B4.4) AVH-301, (B4.5) pyrazolynate and (B4.6) benzofenap;

(B5.1) simetryn;

at least one cumylamine compound selected from (B6.1) bromobutide and (B6.2) cumyluron;

(B7.1) bentazone;

(B8.1) benfuresate;

(B9.1) cafenstrole;

(B10.1) indanofan; and

(B11.1) penoxsulam} (hereinafter referred to simply as the compound (B)),

(C): {a compound of the formula (II), its salt or its ester: 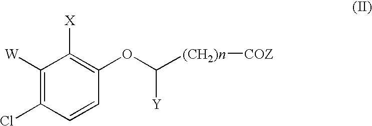
wherein W is a hydrogen atom or a methyl group, X is a chlorine atom or a methyl group, Y is a hydrogen atom or a methyl group, n is 0, 1 or 2, Z is —OH, —SH or —NT₁T₂, and each of T₁ and T₂ is a hydrogen atom, an alkyl group or a phenyl group which may be substituted} (hereinafter referred to simply as the compound (C)), and

(D): {(D1.1) 1-(1-methyl-1-phenylethyl)-3-p-tolylurea (common name: daimuron), (D2.1) S-1-methyl-1-phenylethyl piperidine-1-carbothioate (common name: dimepiperate), (D2.2) S-ethyl azepane-1-carbothioate (common name: molinate), (D2.3) O-3-tert-butylphenyl 6-methoxy-2-pyridyl(methyl)thiocarbamate (common name: pyributicarb) and their salts} (hereinafter referred to simply as the compound (D))] (hereinafter referred to simply as the compound (β)) as active ingredients, a method for controlling undesired plants or inhibiting their growth by applying a herbicidally effective amount of such a herbicidal composition, and a method for controlling undesired plants or inhibiting their growth by applying a herbicidally effective amount of the above compound (α) and a herbicidally effective amount of the compound (β).

Further, the present invention relates to a method for reducing unfavorable effects of the compound (α) against crop plants by the compound (D).

### EFFECTS OF THE INVENTION

The herbicidal composition of the present invention, i.e. the herbicidal composition comprising the compound (α) and the compound (β) as active ingredients, is capable of controlling a wide range of weeds emerging in cropland or non-cropland, and it surprisingly presents a synergistic herbicidal effect i.e. a herbicidal effect higher than the mere addition of the respective herbicidal effects of the active ingredients. With such a herbicidal composition of the present invention, not only it can be applied at a low dose as compared with a case where the respective active ingredients are applied individually, but also the herbicidal spectrum will be enlarged, and further the herbicidal effects will last over a long period of time.

When the herbicidal activity in a case where two active ingredients are combined, is larger than the simple sum of the respective herbicidal activities of the two active ingredients (the expected activity), it is called a synergistic effect. The activity expected by the combination of two active ingredients can be calculated as follows (Colby S. R., “Weed”, vol. 15, p. 20-22, 1967).
E=p+q−(p×q÷100)
where p: growth inhibition rate when treated with x (g/a) of herbicide X,

q: growth inhibition rate when treated with y (g/a) of herbicide Y,

E: growth inhibition rate expected when treated with x (g/a) of herbicide X and y (g/a) of herbicide Y.

Namely, when the actual growth inhibition rate (observed value) is larger than the growth inhibition rate by the above calculation (expected value), the activity by the combination can be regarded as showing a synergistic effect. The herbicidal composition of the present invention shows a synergistic effect when calculated by the above formula.

### BEST MODE FOR CARRYING OUT THE INVENTION

The compound of the formula (I) has two asymmetric carbon atoms and thus has an isomer such as erythro or threo. Accordingly, the compound of the formula (I) in the present invention includes each of such isomers and a mixture of such isomers.

The salt of the compound of the formula (I) may be any salt so long as it is agriculturally acceptable, and it may, for example, be an alkali metal salt such as a sodium salt or a potassium salt; an alkaline earth metal salt such as a magnesium salt or a calcium salt; an ammonium salt such as a dimethylammonium salt or a triethylammonium salt; an inorganic acid salt such as a hydrochloride, a perchlorate, a sulfate or a nitrate; or an organic acid salt such as an acetate or a methanesulfonate.

Compounds of the formula (I), i.e. a compound wherein substituent R is a hydrogen atom (simply referred to as compound A1) and a compound wherein R is —COCH₂OCH₃ (simply referred to as compound A2), both show preferred effects in the present invention. Among them, the compound A2 wherein R is —COCH₂OCH₃ (common name: flucetosulfuron) is more preferred in the present invention.

The compound (B) includes compounds having various isomers (such as geometrical isomers and tautomers), and in the present invention, it includes each of such isomers and a mixture of such isomers.

Further, the compound (B) includes a compound in the form of a salt, and such a salt may be any salt so long as it is agriculturally acceptable and may, for example, be the same salt as the above-mentioned salt of the compound of the formula (I).

The salt of a compound included in the compound (C) may be any salt so long as it is agriculturally acceptable, and it may, for example, be an alkali metal salt such as a sodium salt, a potassium salt or a lithium salt; an alkaline earth metal salt such as a magnesium salt or a calcium salt; or an ammonium salt such as an ammonium salt, a dimethylammonium salt, a diethylammonium salt, a triethylammonium salt, a diethanolammonium salt, a triethanolammonium salt or a benzyltriethanolammonium salt.

The ester of the compound (C) may be any ester so long as it is agriculturally acceptable, and it may, for example, be an alkyl ester or an alkenyl ester, and may, more specifically, be a C₁₋₁₀ linear or branched ester such as methyl, ethyl, propyl, isopropyl, butyl, isobutyl, tert-butyl, pentyl, hexyl, heptyl, octyl, isooctyl, nonyl, decanyl, vinyl, 1-propenyl, allyl, isopropenyl, 1-butenyl, 1,3-butadienyl or 1-hexenyl.

The compound (C) has various isomers such as optical isomers in some cases depending upon the type of the substituent, and in the present invention, it includes each of such isomers and a mixture of such isomers.

Among the compounds (D), pyributicarb can form a salt, and the salt may be any salt so long as it is agriculturally acceptable and may, for example, be an inorganic acid salt such as a hydrochloride, a perchlorate, a sulfate or a nitrate; or an organic acid salt such as an acetate or a methanesulfonate.

The compound (B) will be described in further detail.

Compound (B1.1) is bensulfuron-methyl by common name and is a compound having the following chemical structure:

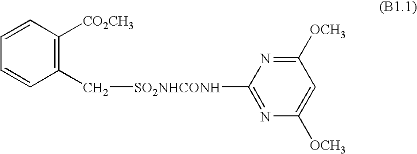

Compound (B1.2) is azimsulfuron by common name and is a compound having the following chemical structure:

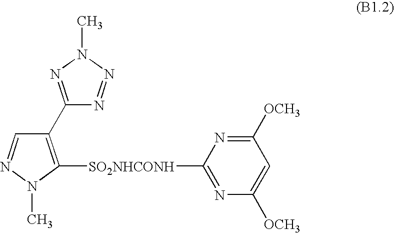

Compound (B1.3) is pyrazosulfuron-ethyl by common name and is a compound having the following chemical structure:

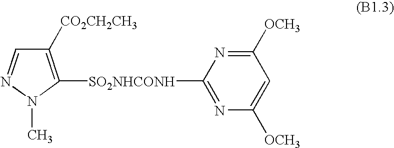

Compound (B1.4) is imazosulfuron by common name and is a compound having the following chemical structure:

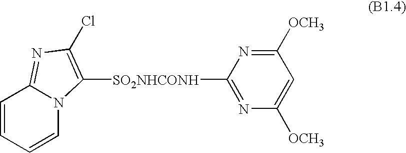

Compound (B1.5) is ethoxysulfuron by common name and is a compound having the following chemical structure:

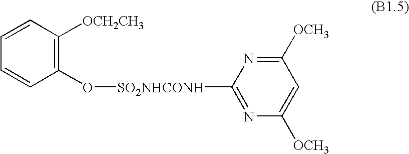

Compound (B1.6) is halosulfuron-methyl by common name and is a compound having the following chemical structure:

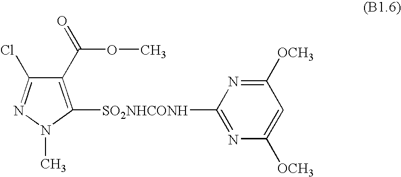

Compound (B2.1) is pyriminobac-methyl by common name and is a compound having the following chemical structure:

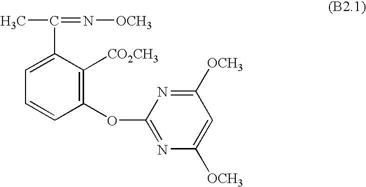

Compound (B2.2) is KUH-021 by developing code (under application for common name pyrimisulfan) and is a compound having the following chemical structure:

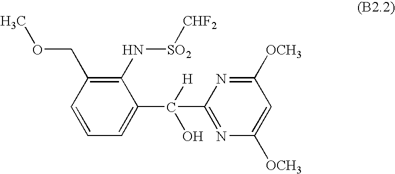

Compound (B3.1) is pretilachlor by common name and is a compound having the following chemical structure:

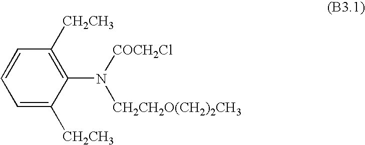

Compound (B3.2) is thenylchlor by common name and is a compound having the following chemical structure:

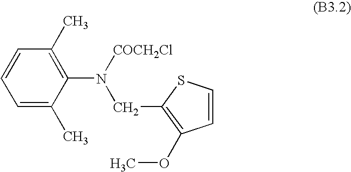

Compound (B4.1) is benzobicyclon by common name and is a compound having the following chemical structure:

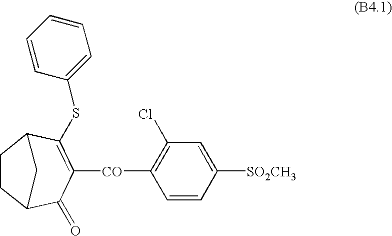

Compound (B4.2) is mesotrione by common name and is a compound having the following chemical structure:

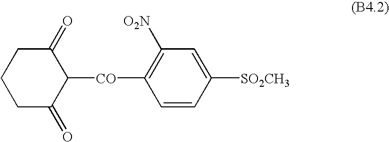

Compound (B4.3) is pyrazoxyfen by common name and is a compound having the following chemical structure:

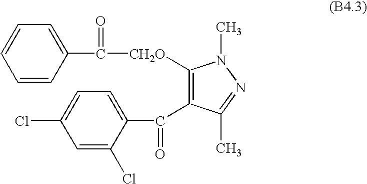

Compound (B4.4) is AVH-301 by developing code and is a compound having the following chemical structure:

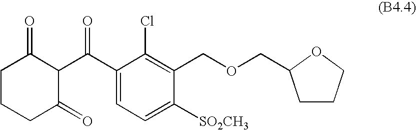

Compound (B4.5) is pyrazolynate (or pirazolate) by common name and is a compound having the following chemical structure:

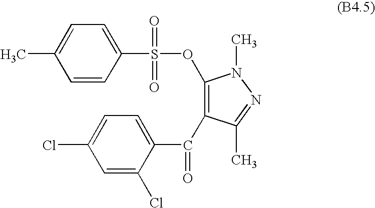

Compound (B4.6) is benzofenap by common name and is a compound having the following chemical structure:

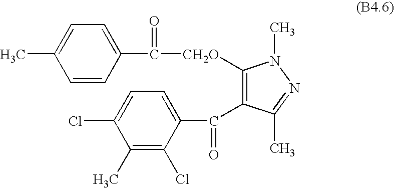

Compound (B5.1) is simetryn by common name and is a compound having the following chemical structure:

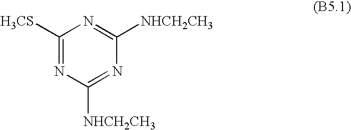

Compound (B6.1) is bromobutide by common name and is a compound having the following chemical structure:

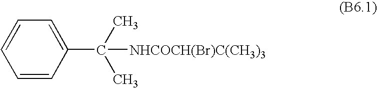

Compound (B6.2) is cumyluron by common name and is a compound having the following chemical structure:

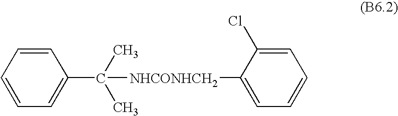

Compound (B7.1) is bentazone by common name and is a compound having the following chemical structure:

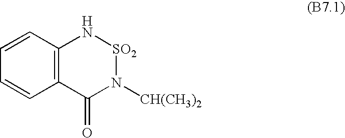

Compound (B8.1) is benfuresate by common name and is a compound having the following chemical structure:

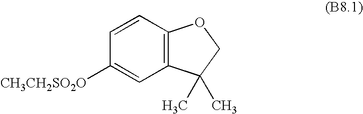

Compound (B9.1) is cafenstrole by common name and is a compound having the following chemical structure:

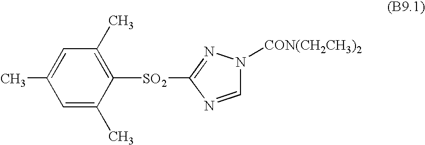

Compound (B10.1) is indanofan by common name and is a compound having the following chemical structure:

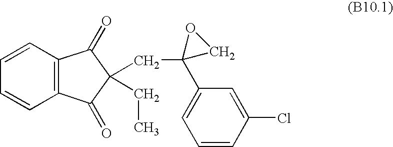

Compound (B11.1) is penoxsulam by common name and is a compound having the following chemical structure:

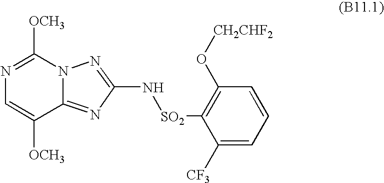

The compound (C) will be described in further detail.

In the present invention, among the compounds of the formula (II), preferred is a compound wherein W is a hydrogen atom, X is a methyl group, Y is a hydrogen atom or a methyl group, n is 0, 1 or 2, Z is —OH, —SH or —NT₁T₂, and each of T₁ and T₂ is a hydrogen atom, an alkyl group or a phenyl group which may be substituted (the substituent of such a phenyl group may, for example, be a halogen atom, an alkyl group or a haloalkyl group), its salt or its ester. As specific examples thereof, following compounds (common names) may be mentioned.

(1) A compound wherein Y is a hydrogen atom, n is 0 and Z is —OH (MCP (or MCPA)), its salt or its ester may, for example, be MCP sodium, MCP potassium, MCP calcium, MCP lithium, MCP dimethylammonium, MCP benzyltriethanolammonium, MCP ethyl, MCP butyl, MCP isooctyl or MCP allyl.

(2) A compound wherein Y is a methyl group, n is 0 and Z is —OH (MCPP (or mecoprop), MCPP-P (or mecoprop-P)), its salt or its ester may, for example, be MCPP sodium, MCPP potassium, MCPP-P potassium, MCPP dimethylammonium, MCPP-P dimethylammonium, MCPP diethanolammonium or MCPP-β isobutyl.

(3) A compound wherein Y is a hydrogen atom, n is 0 and Z is —SH, its salt or its ester may, for example, be MCPA thioethyl (or phenothiol).

(4) A compound wherein Y is a hydrogen atom, n is 0 and Z is —NT₁T₂ (MCPAN (T₁ is a hydrogen atom and T₂ is a phenyl group), MCPCA (T₁ is a hydrogen atom and T₂ is an o-chloro-phenyl group), MCPFA (T₁ is a hydrogen atom and T₂ is a m-trifluoromethyl-phenyl group)) or a salt thereof may, for example, be mentioned.

(5) A compound wherein Y is a hydrogen atom, n is 2 and Z is —OH (MCPB), its salt or its ester may, for example, be MCPB sodium or MCPB ethyl.

Further, in the present invention, among the compounds of the formula (II), preferred is a compound wherein W is a hydrogen atom or a methyl group, X is a chlorine atom, Y is a hydrogen atom or a methyl group, n is 0, 1 or 2, Z is —OH, —SH or —NT₁T₂, and each of T₁ and T₂ is a hydrogen atom, an alkyl group or a phenyl group which may be substituted (the substituent of such a phenyl group may, for example, be a halogen atom, an alkyl group or a haloalkyl group), its salt or its ester. As specific examples thereof, the following compounds (common names) may be mentioned.

(1) A compound wherein W is a hydrogen atom, Y is a hydrogen atom, n is 0 and Z is —OH (2,4-D), its salt or its ester may, for example, be 2,4-D sodium, 2,4-D dimethylammonium, 2,4-D diethylammonium, 2,4-D diethanolammonium, 2,4-D lithium, 2,4-D ethyl, 2,4-D isopropyl, 2,4-D butyl or 2,4-D isooctyl.

(2) A compound wherein W is a hydrogen atom, Y is a methyl group, n is 0 and Z is —OH (2,4-DP (or dichlorprop), 2,4-DP-P (or dichlorprop-P)), its salt or its ester may, for example, be 2,4-DP potassium, 2,4-DP dimethylammonium, 2,4-DP triethanolammonium or 2,4-DP isooctyl.

(3) A compound wherein W is a hydrogen atom, Y is a hydrogen atom, n is 0 and Z is —NT₁T₂ (2,4-D amide (T₁ and T₂ are hydrogen atoms)), its salt or its ester may, for example, be mentioned.

(4) A compound wherein W is a hydrogen atom, Y is a hydrogen atom, n is 2 and Z is —OH, its salt or its ester may, for example, be 2,4-DB, 2,4-DB sodium, 2,4-DB potassium, 2,4-DB ammonium, 2,4-DB dimethylammonium, 2,4-DB butyl or 2,4-DB isooctyl.

(5) A compound wherein W is a methyl group, Y is a methyl group, n is 0 and Z is —NT₁T₂ (clomeprop (T₁ is a hydrogen atom and T₂ is a phenyl group)), its salt or its ester may, for example, be mentioned.

Among the above compounds of the formula (II), their salts and their esters, particularly preferred are MCP (simply referred to as compound C1), MCP ethyl (simply referred to as compound C2), MCPB (simply referred to as compound C3), MCPB ethyl (simply referred to as compound C4), 2,4-D (simply referred to as compound C5), 2,4-D ethyl (simply referred to as compound C6), etc.

The compound (D) will be described in further detail.

Compound (D1.1) 1-(1-methyl-1-phenylethyl)-3-p-tolylurea (common name: daimuron) is classified as a cumylamine compound. Its chemical structural formula is as follows:

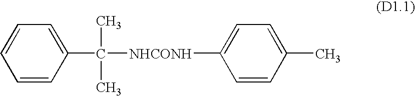

Compounds (D2.1) to (D2.3) are classified as carbamate compounds.

The chemical structural formula of compound (D2.1) S-1-methyl-1-phenylethyl piperidine-1-carbothioate (common name: dimepiperate) is as follows:

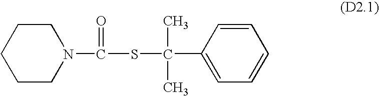

The chemical structural formula of compound (D2.2) S-ethyl azepane-1-carbothioate (common name: molinate) is as follows:

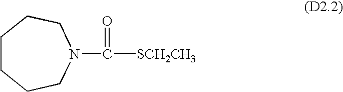

The chemical structural formula of compound (D2.3) O-3-tert-butylphenyl 6-methoxy-2-pyridyl(methyl)thiocarbamate (common name: pyributicarb) is as follows.

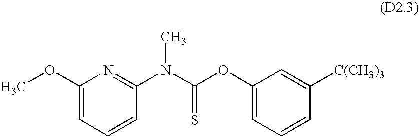

The mix ratio of the compound (α) and the compound (β), as active ingredients in the herbicidal composition of the present invention varies depending upon various conditions such as the types of the formulations, weather conditions, the types and growth conditions of the plants to be controlled and can not generally be defined. However, usually, the amount of the compound (β) is as follows, per part by weight of the compound (α).

(B1.1) is from 1 to 20 parts by weight, preferably from 1 to 10 parts by weight.

(B1.2) is from 0.005 to 1 part by weight, preferably from 0.05 to 0.95 part by weight.

(B1.3) is from 0.01 to 100 parts by weight, preferably from 0.1 to 10 parts by weight.

(B1.4) is from 1 to 100 parts by weight, preferably from 1 to 20 parts by weight.

(B1.5) is from 0.01 to 100 parts by weight, preferably from 0.1 to 10 parts by weight.

(B1.6) is from 1 to 20 parts by weight, preferably from 1 to 10 parts by weight.

(B2.1) is from 1 to 40 parts by weight, preferably from 1 to 20 parts by weight.

(B2.2) is from 1 to 20 parts by weight, preferably from 1 to 10 parts by weight.

(B3.1) is from 1 to 500 parts by weight, preferably from 1 to 100 parts by weight.

(B3.2) is from 1 to 500 parts by weight, preferably from 1 to 100 parts by weight.

(B4.1) is from 1 to 100 parts by weight, preferably from 1 to 40 parts by weight.

(B4.2) is from 1 to 20 parts by weight, preferably from 1 to 10 parts by weight.

(B4.3) is from 2 to 1,000 parts by weight, preferably from 10 to 300 parts by weight.

(B4.4) is from 0.1 to 500 parts by weight, preferably from 1 to 50 parts by weight.

(B4.5) is from 1 to 500 parts by weight, preferably from 10 to 150 parts by weight.

(B4.6) is from 1 to 500 parts by weight, preferably from 10 to 150 parts by weight.

(B5.1) is from 1 to 200 parts by weight, preferably from 1 to 50 parts by weight.

(B6.1) is from 1 to 500 parts by weight, preferably from 10 to 150 parts by weight.

(B6.2) is from 1 to 500 parts by weight, preferably from 10 to 150 parts by weight.

(B7.1) is from 1 to 5,000 parts by weight, preferably from 20 to 1,000 parts by weight.

(B8.1) is from 1 to 500 parts by weight, preferably from 5 to 100 parts by weight.

(B9.1) is from 0.1 to 500 parts by weight, preferably from 1 to 50 parts by weight.

(B10.1) is from 0.1 to 500 parts by weight, preferably from 1 to 50 parts by weight.

(B11.1) is from 0.001 to 200 parts by weight, preferably from 0.01 to 20 parts by weight.

The amount of the compound (C) is usually from 0.1 to 200 parts by weight, preferably from 1 to 150 parts by weight, more preferably from 5 to 100 parts by weight, per part by weight of the compound (α).

The mix ratio (weight ratio) of the compound (α) to the compound (D) is usually from 1:1,000 to 50:1, preferably from 1:500 to 50:1.

The mix ratio (weight ratio) of the compound (α) to compound (D1.1) is usually from 1:1,000 to 50:1, preferably from 1:500 to 50:1, more preferably from 1:200 to 10:1.

In the present invention, when the mix ratio (weight ratio) of the compound (α) to compound (D1.1) is usually from 1:5 to 1:200, preferably from 1:10 to 1:150, unfavorable effects of the compound (α) to crop plants can be remarkably reduced, and further, a synergistic effect will be obtained when undesired plants are controlled or their growth is inhibited.

Further, in the present invention, when the mix ratio (weight ratio) of the compound (α) to compound (D1.1) is usually from 1:200 to 50:1, preferably from 1:150 to 10:1, more preferably from 1:50 to 5:1, unfavorable effects of the compound (α) to crop plants can be remarkably reduced.

Further, in the present invention, when the mix ratio (weight ratio) of the compound (α) to compound (D1.1) is usually from 1:5 to 1:500, preferably from 1:10 to 1:200, a synergistic effect will be obtained when undesired plants are controlled or their growth is inhibited.

The mix ratio (weight ratio) of the compound (α) to compound (D2.1), as active ingredients in the herbicidal composition of the present invention is usually from 1:1,000 to 50:1, preferably from 1:500 to 50:1, more preferably from 1:500 to 5:1.

In the present invention, when the mix ratio (weight ratio) of the compound (α) to compound (D2.1) is usually from 1:2 to 1:500, preferably from 1:5 to 1:250, unfavorable effects of the compound (α) to crop plants can be remarkably reduced, and a synergistic effect will be obtained when undesired plants are controlled or their growth is inhibited.

Further, in the present invention, when the mix ratio (weight ratio) of the compound (α) to compound (D2.1) is usually from 1:500 to 50:1, preferably from 1:250 to 10:1, more preferably from 1:50 to 5:1, unfavorable effects of the compound (α) to crop plants can be remarkably reduced.

Further, in the present invention, when the mix ratio (weight ratio) of the compound (α) to compound (D2.1) is usually from 1:2 to 1:1,000, preferably from 1:5 to 1:500, a synergistic effect will be obtained when undesired plants are controlled or their growth is inhibited.

The mix ratio (weight ratio) of the compound (α) to compound (D2.2), as active ingredients in the herbicidal composition of the present invention is usually from 1:1,000 to 50:1, preferably from 1:500 to 50:1, more preferably from 1:500 to 5:1.

In the present invention, when the mix ratio (weight ratio) of the compound (α) to compound (D2.2) is usually from 1:2 to 1:500, preferably from 1:5 to 1:250, unfavorable effects of the compound (α) to crop plants can be remarkably reduced, and a synergistic effect will be obtained when undesired plants are controlled or their growth is inhibited.

In the present invention, when the mix ratio (weight ratio) of the compound (α) to compound (D2.2) is usually from 1:500 to 50:1, preferably from 1:250 to 10:1, more preferably from 1:50 to 5:1, unfavorable effects of the compound (α) to crop plants can be remarkably reduced.

Further, in the present invention, when the mix ratio (weight ratio) of the compound (α) to compound (D2.2) is usually from 1:2 to 1:1,000, preferably from 1:5 to 1:500, a synergistic effect will be obtained when undesired plants are controlled or their growth is inhibited.

The mix ratio (weight ratio) of the compound (α) to compound (D2.3), as active ingredients in the herbicidal composition of the present invention is usually from 1:1,000 to 50:1, preferably from 1:500 to 50:1, more preferably from 1:100 to 5:1.

In the present invention, when the mix ratio (weight ratio) of the compound (α) to compound (D2.3) is usually from 1:2 to 1:500, preferably from 1:5 to 1:250, unfavorable effects of the compound (α) to crop plants can be remarkably reduced, and a synergistic effect will be obtained when undesired plants are controlled or their growth is inhibited.

Further, in the present invention, when the mix ratio (weight ratio) of the compound (α) to compound (D2.3) is usually from 1:500 to 50:1, preferably from 1:250 to 10:1, more preferably from 1:50 to 5:1, unfavorable effects of the compound (α) to crop plants can be remarkably reduced.

Further, in the present invention, when the mix ratio (weight ratio) of the compound (α) to compound (D2.3) is usually from 1:2 to 1:500, preferably from 1:5 to 1:100, a synergistic effect will be obtained when undesired plants are controlled or their growth is inhibited.

Further, the present invention includes a herbicidal composition comprising the compound (α) and two herbicidal active ingredients in addition to the compound (α). In such a case, the ratio varies depending upon various conditions such as the types of the compounds and the plants to be controlled and further, weather and soil conditions, varieties of crop plants, the timing for the application of the herbicide and the types of the formulations and can not generally be defined. However, for example, the ratio of the compound (α) and the other two herbicidal active ingredients is as follows.

Usually, (compound (α)): (B8.1):(B5.1)=1:1 to 500:1 to 200, preferably (compound (α)): (B8.1):(B5.1)=1:5 to 100:1 to 50.

Usually, (compound (α)): (B8.1):(B4.3)=1:1 to 500:2 to 1,000, preferably (compound (α)): (B8.1):(B4.3)=1:5 to 100:10 to 300.

Usually, (compound (α)): (B1.2):(B5.1)=1:0.005 to 1:1 to 200, preferably (compound (α)): (B1.2):(B5.1)=1:0.05 to 0.95:1 to 50.

Usually, (compound (α)): (B3.1):(B8.1)=1:1 to 500:1 to 500, preferably (compound (α)):(B3.1):(B8.1)=1:1 to 100:5 to 100.

Usually, (compound (α)): (B3.1):(B4.1)=1:1 to 500:1 to 100, preferably (compound (α)): (B3.1):(B4.1)=1:1 to 100:1 to 40.

Usually, (compound (α)): (B3.1):(B6.1)=1:1 to 500:1 to 500, preferably (compound (α)): (B3.1):(B6.1)=1:1 to 100:10 to 150.

Usually, (compound (α)): (B9.1):(B8.1)=1:0.1 to 500:1 to 500, preferably (compound (α)): (B9.1):(B8.1)=1:1 to 50:5 to 100.

Usually, (compound (α)): (B9.1):(B4.1)=1:0.1 to 500:1 to 100, preferably (compound (α)): (B9.1):(B4.1)=1:1 to 50:1 to 40.

Usually, (compound (α)): (B9.1):(B6.1)=1:0.1 to 500:1 to 500, preferably (compound (α)): (B9.1):(B6.1)=1:1 to 50:10 to 150.

Usually, (compound (α)): (B3.2):(B8.1)=1:1 to 500:1 to 500, preferably (compound (α)): (B3.2):(B8.1)=1:1 to 100:5 to 100.

Usually, (compound (α)): (B3.2):(B4.1)=1:1 to 500:1 to 100, preferably (compound (α)):(B3.2):(B4.1)=1:1 to 100:1 to 40.

Usually, (compound (α)): (B3.2):(B6.1)=1:1 to 500:1 to 500, preferably (compound (α)):(B3.2):(B6.1)=1:1 to 100:10 to 150.

Usually, (compound (α)): (D2.3):(B8.1)=1:0.02 to 1,000:1 to 500, preferably (compound (α)): (D2.3):(B8.1)=1:0.02 to 500:5 to 100.

Usually, (compound (α)): (D2.3):(B4.1)=1:0.02 to 1,000:1 to 100, preferably (compound (α)): (D2.3):(B4.1)=1:0.02 to 500:1 to 40.

Usually, (compound (α)): (D2.3):(B6.1)=1:0.02 to 1,000:1 to 500, preferably (compound (α)): (D2.3):(B6.1)=1:0.02 to 500:10 to 150.

Usually, (compound (α)):(B10.1): (B8.1)=1:0.1 to 500:1 to 500, preferably (compound (α)): (B10.1):(B8.1)=1:1 to 50:5 to 100.

Usually, (compound (α)):(B10.1): (B4.1)=1:0.1 to 500:1 to 100, preferably (compound (α)): (B10.1):(B4.1)=1:1 to 50:1 to 40.

Usually, (compound (α)):(B10.1): (B6.1)=1:0.1 to 500:1 to 500, preferably (compound (α)): (B10.1):(B6.1)=1:1 to 50:10 to 150.

Usually, (compound (α)):(D1.1):(B4.1)=1:0.02 to 1,000:1 to 100, preferably (compound (α)):(D1.1):(B4.1)=1:0.02 to 500:1 to 40.

The respective mix ratios in the respective applications vary depending upon various conditions such as the types of the compounds and the plants to be controlled and further, weather and soil conditions, varieties of crop plants, the timing for the application of the herbicide and the types of the formulations and can not generally be defined, and thus the optimum ratio can be individually determined considering the above various conditions e.g. by suitably carrying out a preliminary test.

The present invention includes the herbicidal composition having the above-mentioned mix ratio, and a method for controlling undesired plants or inhibiting their growth, which comprises applying a herbicidally effective amount of the herbicidal composition. In its application, the application to the undesired plants or the application to a place where they grow (either before or after the emergence of the undesired plants) may optionally be selected.

The application amount of the herbicidal composition of the present invention can not generally be defined, since it varies depending upon various conditions such as the mix ratio of the compound (α) and the compound (β), the types of the formulations, weather conditions, the types and growth conditions of the plants to be controlled. However, the compound of the formula (I) or its salt is usually from 0.001 to 50 g/a, preferably from 0.01 to 1 g/a, and the compounds (β) and the suitable total application amount thereof are as follows.

(B1.1) is from 0.001 to 50 g/a, preferably from 0.01 to 1 g/a, and the suitable total application amount thereof with the compound of the formula (I) or its salt, is from 0.002 to 100 g/a, preferably from 0.02 to 2 g/a.

(B1.2) is from 0.0001 to 3 g/a, preferably from 0.001 to 0.3 g/a, and the suitable total application amount thereof with the compound of the formula (I) or its salt, is from 0.0011 to 53 g/a, preferably from 0.011 to 1.3 g/a.

(B1.3) is from 0.001 to 10 g/a, preferably from 0.01 to 1 g/a, and the suitable total application amount thereof with the compound of the formula (I) or its salt, is from 0.002 to 60 g/a, preferably from 0.02 to 2 g/a.

(B1.4) is from 0.001 to 50 g/a, preferably from 0.01 to 5 g/a, and the suitable total application amount thereof with the compound of the formula (I) or its salt, is from 0.002 to 100 g/a, preferably from 0.02 to 6 g/a.

(B1.5) is from 0.001 to 10 g/a, preferably from 0.01 to 1 g/a, and the suitable total application amount thereof with the compound of the formula (I) or its salt, is from 0.002 to 60 g/a, preferably from 0.02 to 2 g/a.

(B1.6) is from 0.001 to 50 g/a, preferably from 0.01 to 1 g/a, and the suitable total application amount thereof with the compound of the formula (I) or its salt, is from 0.002 to 100 g/a, preferably from 0.02 to 2 g/a.

(B2.1) is from 0.001 to 50 g/a, preferably from 0.01 to 1 g/a, and the suitable total application amount thereof with the compound of the formula (I) or its salt, is from 0.002 to 100 g/a, preferably from 0.02 to 2 g/a.

(B2.2) is from 0.001 to 50 g/a, preferably from 0.01 to 1 g/a, and the suitable total application amount thereof with the compound of the formula (I) or its salt, is from 0.002 to 100 g/a, preferably from 0.02 to 2 g/a.

(B3.1) is from 0.01 to 500 g/a, preferably from 0.1 to 10 g/a, and the suitable total application amount thereof with the compound of the formula (I) or its salt, is from 0.011 to 550 g/a, preferably from 0.11 to 11 g/a.

(B3.2) is from 0.01 to 500 g/a, preferably from 0.1 to 10 g/a, and the suitable total application amount thereof with the compound of the formula (I) or its salt, is from 0.011 to 550 g/a, preferably from 0.11 to 11 g/a.

(B4.1) is from 0.01 to 500 g/a, preferably from 0.1 to 10 g/a, and the suitable total application amount thereof with the compound of the formula (I) or its salt, is from 0.011 to 550 g/a, preferably from 0.11 to 11 g/a.

(B4.2) is from 0.001 to 50 g/a, preferably from 0.01 to 1 g/a, and the suitable total application amount thereof with the compound of the formula (I) or its salt, is from 0.002 to 100 g/a, preferably from 0.02 to 2 g/a.

(B4.3) is from 0.1 to 200 g/a, preferably from 1 to 50 g/a, and the suitable total application amount thereof with the compound of the formula (I) or its salt, is from 0.101 to 250 g/a, preferably from 1.01 to 51 g/a.

(B4.4) is from 0.1 to 1,000 g/a, preferably from 1 to 100 g/a, and the suitable total application amount thereof with the compound of the formula (I) or its salt, is from 0.101 to 1,050 g/a, preferably from 1.01 to 101 g/a.

(B4.5) is from 0.05 to 2,000 g/a, preferably from 0.5 to 50 g/a, and the suitable total application amount thereof with the compound of the formula (I) or its salt, is from 0.051 to 2,050 g/a, preferably from 0.51 to 51 g/a.

(B4.6) is from 0.05 to 2,000 g/a, preferably from 0.5 to 50 g/a, and the suitable total application amount thereof with the compound of the formula (I) or its salt, is from 0.051 to 2,050 g/a, preferably from 0.51 to 51 g/a.

(B5.1) is from 0.01 to 500 g/a, preferably from 0.1 to 10 g/a, and the suitable total application amount thereof with the compound of the formula (I) or its salt, is from 0.011 to 550 g/a, preferably from 0.11 to 11 g/a.

(B6.1) is from 0.05 to 2,000 g/a, preferably from 0.5 to 50 g/a, and the suitable total application amount thereof with the compound of the formula (I) or its salt, is from 0.051 to 2,050 g/a, preferably from 0.51 to 51 g/a.

(B6.2) is from 0.05 to 2,000 g/a, preferably from 0.5 to 50 g/a, and the suitable total application amount thereof with the compound of the formula (I) or its salt, is from 0.051 to 2,050 g/a, preferably from 0.51 to 51 g/a.

(B7.1) is from 0.01 to 500 g/a, preferably from 0.1 to 100 g/a, and the suitable total application amount thereof with the compound of the formula (I) or its salt, is from 0.011 to 550 g/a, preferably from 0.11 to 101 g/a.

(B8.1) is from 0.01 to 500 g/a, preferably from 0.1 to 20 g/a, and the suitable total application amount thereof with the compound of the formula (I) or its salt, is from 0.011 to 550 g/a, preferably from 0.11 to 21 g/a.

(B9.1) is from 0.01 to 100 g/a, preferably from 0.1 to 10 g/a, and the suitable total application amount thereof with the compound of the formula (I) or its salt, is from 0.011 to 150 g/a, preferably from 0.11 to 11 g/a.

(B10.1) is from 0.01 to 200 g/a, preferably from 0.1 to 20 g/a, and the suitable total application amount thereof with the compound of the formula (I) or its salt, is from 0.011 to 250 g/a, preferably from 0.11 to 21 g/a.

(B11.1) is from 0.001 to 50 g/a, preferably from 0.01 to 1 g/a, and the suitable total application amount thereof with the compound of the formula (I) or its salt, is from 0.002 to 100 g/a, preferably from 0.02 to 2 g/a.

The application amount of the herbicidal composition of the present invention can not generally be defined, since it varies depending upon various conditions such as the mix ratio of the compound (α) and the compound (C), the types of the formulations, weather conditions, the types and growth conditions of the plants to be controlled. However, the compound (C) is usually from 0.01 to 500 g/a, preferably from 1 to 10 g/a, and the suitable total application amount thereof is usually from 0.011 to 500 g/a, preferably from 0.5 to 10 g/a.

The application amounts of the compound (α) and compound (D1.1) can not generally be defined, since they vary depending upon various conditions such as the types of the compounds and the plants to be controlled and further, weather and soil conditions, varieties of crop plants, the timing for the application of the herbicide and the types of the formulations. However, the application amount of the compound (α) is usually from 0.1 to 5,000 g/ha, preferably from 5 to 100 g/ha, and the application amount of compound (D1.1) is usually from 100 to 50,000 g/ha, preferably from 100 to 20,000 g/ha. However, the optimum application amounts can be individually determined considering the above various conditions, etc. e.g. by suitably carrying out a preliminary test.

In the present invention, when the application amount of the compound (α) is usually from 1 to 5,000 g/ha, preferably from 5 to 100 g/ha, and the application amount of compound (D1.1) is usually from 100 to 2,000 g/ha, preferably from 300 to 1,000 g/ha, unfavorable effects of the compound (α) to crop plants can be remarkably reduced, and a synergistic effect will be obtained when undesired plants are controlled or their growth is inhibited.

Further, in the present invention, when the application amount of the compound (α) is usually from 1 to 5,000 g/ha, preferably from 5 to 100 g/ha, and the application amount of the compound (D1.1) is usually from 100 to 2,000 g/ha, preferably from 100 to 1,000 g/ha, unfavorable effects of the compound (α) to crop plants can be remarkably reduced.

Still further, in the present invention, when the application amount of the compound (α) is usually from 0.1 to 5,000 g/ha, preferably from 1 to 100 g/ha, and the application amount of compound (D1.1) is usually from 100 to 50,000 g/ha, preferably from 300 to 20,000 g/ha, a synergistic effect will be obtained when undesired plants are controlled or their growth is inhibited.

The application amounts of the compound (α) and compound (D2.1) can not generally be defined, since they vary depending upon various conditions such as the types of the compounds and the plants to be controlled and further, weather and soil conditions, varieties of crop plants, the timing for the application of the herbicide and the types of the formulations. However, the application amount of the compound (α) is usually from 0.1 to 5,000 g/ha, preferably from 5 to 100 g/ha, and the application amount of compound (D2.1) is usually from 100 to 100,000 g/ha, preferably from 100 to 20,000 g/ha. However, the optimum application amounts can be individually determined considering the above various conditions, etc. e.g. by suitably carrying out a preliminary test.

In the present invention, when the application amount of the compound (α) is usually from 1 to 5,000 g/ha, preferably from 5 to 100 g/ha, and the application amount of compound (D2.1) is usually from 100 to 2,000 g/ha, preferably from 500 to 1,000 g/ha, unfavorable effects of the compound (α) to crop plants can be remarkably reduced, and a synergistic effect will be obtained when undesired plants are controlled or their growth is inhibited.

Further, in the present invention, when the application amount of the compound (α) is usually from 1 to 5,000 g/ha, preferably from 5 to 100 g/ha, and the application amount of compound (D2.1) is usually from 100 to 2,000 g/ha, preferably from 100 to 1,000 g/ha, unfavorable effects of the compound (α) to crop plants can be remarkably reduced.

Still further, in the present invention, when the application amount of the compound (α) is usually from 0.1 to 5,000 g/ha, preferably from 1 to 100 g/ha, and the application amount of the compound (D2.1) is usually from 100 to 100,000 g/ha, preferably from 500 to 20,000 g/ha, a synergistic effect will be obtained when undesired plants are controlled or their growth is inhibited.

The application amounts of the respective compounds in the respective applications can not generally be defined, since they vary depending upon various condition such as the types of the compounds and the plants to be controlled and further, weather and soil conditions, varieties of crop plants, the timing for the application of the herbicide and the types of the formulations. Accordingly, the optimum ratio can be individually determined considering the above various conditions, etc. e.g. by suitably carrying out a preliminary test.

The application amounts of the compound (α) and compound (D2.2) can not generally be defined, since they vary depending upon various conditions such as the types of the compounds and the plants to be controlled and further, weather and soil conditions, varieties of crop plants, the timing for the application of the herbicide and the types of the formulations. However, the application amount of the compound (α) is usually from 0.1 to 5,000 g/ha, preferably from 5 to 100 g/ha, and the application amount of compound (D2.2) is usually from 100 to 100,000 g/ha, preferably from 100 to 20,000 g/ha. However, the optimum application amounts can be individually determined considering the above various conditions, etc. e.g. by suitably carrying out a preliminary test.

In the present invention, when the application amount of the compound (α) is usually from 1 to 5,000 g/ha, preferably from 5 to 100 g/ha, and the application amount of compound (D2.2) is usually from 100 to 2,000 g/ha, preferably from 500 to 1,000 g/ha, unfavorable effects of the compound (α) to crop plants can be remarkably reduced, and a synergistic effect will be obtained when undesired plants are controlled or their growth is inhibited.

Further, in the present invention, when the application amount of the compound (α) is usually from 1 to 5,000 g/ha, preferably from 5 to 100 g/ha, and the application amount of compound (D2.2) is usually from 100 to 2,000 g/ha, preferably from 100 to 1,000 g/ha, unfavorable effects of the compound (α) to crop plants can be remarkably reduced.

Still further, in the present invention, when the application amount of the compound (α) is usually from 0.1 to 5,000 g/ha, preferably from 1 to 100 g/ha, and the application amount of the compound (D2.2) is usually from 100 to 100,000 g/ha, preferably from 500 to 20,000 g/ha, a synergistic effect will be obtained when undesired plants are controlled or their growth is inhibited.

The application amounts of the respective compounds in the respective applications can not generally be defined, since they vary depending upon various condition such as the types of the compounds and the plants to be controlled and further, weather and soil conditions, varieties of crop plants, the timing for the application of the herbicide and the types of the formulations. Accordingly, the optimum ratio can be individually determined considering the above various conditions, etc. e.g. by suitably carrying out a preliminary test.

The application amounts of the compound (α) and compound (D2.3) can not generally be defined, since they vary depending upon various conditions such as the types of the compounds and the plants to be controlled and further, weather and soil conditions, varieties of crop plants, the timing for the application of the herbicide and the types of the formulations. However, the application amount of the compound (α) is usually from 0.1 to 5,000 g/ha, preferably from 5 to 100 g/ha, and the application amount of compound (D2.3) is usually from 10 to 10,000 g/ha, preferably from 100 to 1,000 g/ha. However, the optimum application amounts can be individually determined considering the above various conditions, etc. e.g. by suitably carrying out a preliminary test.

In the present invention, when the application amount of the compound (α) is usually from 1 to 5,000 g/ha, preferably from 5 to 100 g/ha, and the application amount of the compound (D2.3) is usually from 100 to 2,000 g/ha, preferably from 100 to 1,000 g/ha, unfavorable effects of the compound (α) to crop plants can be remarkably reduced, and a synergistic effect will be obtained when undesired plants are controlled or their growth is inhibited.

Further, in the present invention, when the application amount of the compound (α) is usually from 1 to 5,000 g/ha, preferably from 5 to 100 g/ha, and the application amount of compound (D2.3) is usually from 100 to 2,000 g/ha, preferably from 100 to 1,000 g/ha, unfavorable effects of the compound (α) to crop plants can be remarkably reduced.

Still further, in the present invention, when the application amount of the compound (α) is usually from 0.1 to 5,000 g/ha, preferably from 1 to 100 g/ha, and the application amount of the compound (D2.3) is usually from 10 to 10,000 g/ha, preferably from 100 to 1,000 g/ha, a synergistic effect will be obtained when undesired plants are controlled or their growth is inhibited.

Further, the present invention also includes a herbicidal composition comprising the compound (α) and two herbicidal active ingredients in addition to the compound (α). In such a case, their application amounts can not generally be defined since they vary depending upon various conditions such as the types of the compounds and the plants to be controlled and further, weather and soil condition, varieties of the crop plants, the timing for the application of the herbicide and the types of the formulations. However, the application amount of the compound (α), the application amounts of the other two herbicidal active ingredients, and the suitable total application amount thereof are as follows.

When the compound (α), (B8.1) and (B5.1) are applied, the application amount of the compound (α) is usually from 0.001 to 50 g/a, preferably from 0.01 to 1 g/a, the application amount of (B8.1) is usually from 0.01 to 500 g/a, preferably from 0.1 to 20 g/a, the application amount of (B5.1) is usually from 0.01 to 500 g/a, preferably from 0.1 to 10 g/a, and the suitable total application amount thereof is from 0.021 to 1,050 g/a, preferably from 0.21 to 31 g/a.

When the compound (α), (B8.1) and (B4.3) are applied, the application amount of the compound (α) is usually from 0.001 to 50 g/a, preferably from 0.01 to 1 g/a, the application amount of (B8.1) is usually from 0.01 to 500 g/a, preferably from 0.1 to 20 g/a, the application amount of (B4.3) is usually from 0.1 to 200 g/a, preferably from 1 to 50 g/a, and the suitable total application amount thereof is from 0.111 to 750 g/a, preferably from 1.11 to 71 g/a.

When the compound (α), (B1.2) and (B5.1) are applied, the application amount of the compound (α) is usually from 0.001 to 50 g/a, preferably from 0.01 to 1 g/a, the application amount of (B1.2) is usually from 0.0001 to 3 g/a, preferably from 0.001 to 0.3 g/a, the application amount of (B5.1) is usually from 0.01 to 500 g/a, preferably from 0.1 to 10 g/a, and the suitable total application amount thereof is from 0.0111 to 553 g/a, preferably from 0.111 to 11.3 g/a.

When the compound (α), (B3.1) and (B8.1) are applied, the application amount of the compound (α) is usually from 0.001 to 50 g/a, preferably from 0.01 to 1 g/a, the application amount of (B3.1) is usually from 0.01 to 500 g/a, preferably from 0.1 to 10 g/a, the application amount of (B8.1) is usually from 0.01 to 500 g/a, preferably from 0.1 to 10 g/a, and the suitable total application amount thereof is from 0.021 to 1,050 g/a, preferably from 0.21 to 21 g/a.

When the compound (α), (B3.1) and (B4.1) are applied, the application amount of the compound (α) is usually from 0.001 to 50 g/a, preferably from 0.01 to 1 g/a, the application amount of (B3.1) is usually from 0.01 to 500 g/a, preferably from 0.1 to 10 g/a, the application amount of (B4.1) is usually from 0.01 to 500 g/a, preferably from 0.1 to 10 g/a, and the suitable total application amount thereof is from 0.021 to 1,050 g/a, preferably from 0.21 to 21 g/a.

When the compound (α), (B3.1) and (B6.1) are applied, the application amount of the compound (α) is usually from 0.001 to 50 g/a, preferably from 0.01 to 1 g/a, the application amount of (B3.1) is usually from 0.01 to 500 g/a, preferably from 0.1 to 10 g/a, the application amount of (B6.1) is usually from 0.05 to 2,000 g/a, preferably from 0.5 to 50 g/a, and the suitable total application amount thereof is from 0.061 to 2,550 g/a, preferably from 0.61 to 61 g/a.

When the compound (α), (B9.1) and (B8.1) are applied, the application amount of the compound (α) is usually from 0.001 to 50 g/a, preferably from 0.01 to 1 g/a, the application amount of (B9.1) is usually from 0.01 to 100 g/a, preferably from 0.1 to 10 g/a, the application amount of (B8.1) is usually from 0.01 to 500 g/a, preferably from 0.1 to 10 g/a, and the suitable total application amount thereof is from 0.021 to 650 g/a, preferably from 0.21 to 21 g/a.

When the compound (α), (B9.1) and (B4.1) are applied, the application amount of the compound (α) is usually from 0.001 to 50 g/a, preferably from 0.01 to 1 g/a, the application amount of (B9.1) is usually from 0.01 to 100 g/a, preferably from 0.1 to 10 g/a, the application amount of (B4.1) is usually from 0.01 to 500 g/a, preferably from 0.1 to 10 g/a, and the suitable total application amount thereof is from 0.021 to 650 g/a, preferably from 0.21 to 21 g/a.

When the compound (α), (B9.1) and (B6.1) are applied, the application amount of the compound (α) is usually from 0.001 to 50 g/a, preferably from 0.01 to 1 g/a, the application amount of (B9.1) is usually from 0.01 to 100 g/a, preferably from 0.1 to 10 g/a, the application amount of (B6.1) is usually from 0.05 to 2,000 g/a, preferably from 0.5 to 50 g/a, and the suitable total application amount thereof is from 0.061 to 2,150 g/a, preferably from 0.61 to 61 g/a.

When the compound (α), (B3.2) and (B8.1) are applied, the application amount of the compound (α) is usually from 0.001 to 50 g/a, preferably from 0.01 to 1 g/a, the application amount of (B3.2) is usually from 0.01 to 500 g/a, preferably from 0.1 to 10 g/a, the application amount of (B8.1) is usually from 0.01 to 500 g/a, preferably from 0.1 to 10 g/a, and the suitable total application amount thereof is from 0.021 to 1,050 g/a, preferably from 0.21 to 21 g/a.

When the compound (α), (B3.2) and (B4.1) are applied, the application amount of the compound (α) is usually from 0.001 to 50 g/a, preferably from 0.01 to 1 g/a, the application amount of (B3.2) is usually from 0.01 to 500 g/a, preferably from 0.1 to 10 g/a, the application amount of (B4.1) is usually from 0.01 to 500 g/a, preferably from 0.1 to 10 g/a, and the suitable total application amount thereof is from 0.021 to 1,050 g/a, preferably from 0.21 to 21 g/a.

When the compound (α), (B3.2) and (B6.1) are applied, the application amount of the compound (α) is usually from 0.001 to 50 g/a, preferably from 0.01 to 1 g/a, the application amount of (B3.2) is usually from 0.01 to 500 g/a, preferably from 0.1 to 10 g/a, the application amount of (B6.1) is usually from 0.05 to 2,000 g/a, preferably from 0.5 to 50 g/a, and the suitable total application amount thereof is from 0.061 to 2,550 g/a, preferably from 0.61 to 61 g/a.

When the compound (α), (D2.3) and (B8.1) are applied, the application amount of the compound (α) is usually from 0.001 to 50 g/a, preferably from 0.01 to 1 g/a, the application amount of (D2.3) is usually from 0.1 to 100 g/a, preferably from 1 to 10 g/a, the application amount of (B8.1) is usually from 0.01 to 500 g/a, preferably from 0.1 to 10 g/a, and the suitable total application amount thereof is from 0.111 to 650 g/a, preferably from 1.11 to 21 g/a.

When the compound (α), (D2.3) and (B4.1) are applied, the application amount of the compound (α) is usually from 0.001 to 50 g/a, preferably from 0.01 to 1 g/a, the application amount of (D2.3) is usually from 0.1 to 100 g/a, preferably from 1 to 10 g/a, the application amount of (B4.1) is usually from 0.01 to 500 g/a, preferably from 0.1 to 10 g/a, and the suitable total application amount thereof is from 0.111 to 650 g/a, preferably from 1.11 to 21 g/a.

When the compound (α), (D2.3) and (B6.1) are applied, the application amount of the compound (α) is usually from 0.001 to 50 g/a, preferably from 0.01 to 1 g/a, the application amount of (D2.3) is usually from 0.1 to 100 g/a, preferably from 1 to 10 g/a, the application amount of (B6.1) is usually from 0.05 to 2,000 g/a, preferably from 0.5 to 50 g/a, and the suitable total application amount thereof is from 0.151 to 2,150 g/a, preferably from 1.51 to 61 g/a.

When the compound (α), (B10.1) and (B8.1) are applied, the application amount of the compound (α) is usually from 0.001 to 50 g/a, preferably from 0.01 to 1 g/a, the application amount of (B10.1) is usually from 0.01 to 200 g/a, preferably from 0.1 to 20 g/a, the application amount of (B8.1) is usually from 0.01 to 500 g/a, preferably from 0.1 to 10 g/a, and the suitable total application amount thereof is from 0.021 to 750 g/a, preferably from 0.21 to 31 g/a.

When the compound (α), (B10.1) and (B4.1) are applied, the application amount of the compound (α) is usually from 0.001 to 50 g/a, preferably from 0.01 to 1 g/a, the application amount of (B10.1) is usually from 0.01 to 200 g/a, preferably from 0.1 to 20 g/a, the application amount of (B4.1) is usually from 0.01 to 500 g/a, preferably from 0.1 to 10 g/a, and the suitable total application amount thereof is from 0.021 to 750 g/a, preferably from 0.21 to 31 g/a.

When the compound (α), (B10.1) and (B6.1) are applied, the application amount of the compound (α) is usually from 0.001 to 50 g/a, preferably from 0.01 to 1 g/a, the application amount of (B10.1) is usually from 0.01 to 200 g/a, preferably from 0.1 to 20 g/a, the application amount of (B6.1) is usually from 0.05 to 2,000 g/a, preferably from 0.5 to 50 g/a, and the suitable total application amount thereof is from 0.061 to 2,250 g/a, preferably from 0.61 to 71 g/a.

When the compound (α), (D1.1) and (B4.1) are applied, the application amount of the compound (α) is usually from 0.001 to 50 g/a, preferably from 0.01 to 1 g/a, the application amount of (D1.1) is usually from 1 to 500 g/a, preferably from 1 to 200 g/a, the application amount of (B4.1) is usually from 0.01 to 500 g/a, preferably from 0.1 to 10 g/a, and the suitable total application amount thereof is from 1.011 to 1,050 g/a, preferably from 1.11 to 211 g/a.

The application amounts of the respective compounds in the respective applications can not generally be defined since they vary depending upon various conditions such as the types of the compounds and the plants to be controlled and further, weather and soil conditions, varieties of the crop plants, the timing for the application of the herbicide and the types of the formulations. Accordingly, the optimum ratio can be individually determined considering the above various conditions, etc. e.g. by suitably carrying out a preliminary test.

The present invention includes a method for controlling undesired plants or inhibiting their growth, which comprises applying the compound (α) and the compound (β) in the respectively above-mentioned application amounts or applying them in the above-mentioned suitable total application amount. In the application, the application to the undesired plants or the application to a place where they grow (either before or after the emergence of the undesired plants) may optionally be selected.

The herbicidal composition of the present invention is capable of controlling a wide range of undesired plants such as annual weeds and perennial weeds, at a low dose. The undesired plants include grasses (or gramineae) such as barnyardgrass (Echinochloa crus-galli L., Echinochloa oryzicola vasing), crabgrass (Digitaria sanguinalis L.), greenfoxtail (Setaria viridis L.), giant foxtail (Setaria faberi Herrm.), goosegrass (Eleusine indica L.), wild oat (Avena fatua L.), johnsongrass (Sorghum halepense L.), quackgrass (Agropyron repens L.), alexandergrass (Brachiaria plantaginea), paragrass (Panicum purpurascens), sprangletop (Leptochloa chinensis), red sprangletop (Leptochloa panicea), annual bluegrass (Poa annua L.), black grass (Alopecurus myosuroides Huds.) and cholorado bluestem (Agropyron tsukushiense (Honda) Ohwi), sedges (or Cyperaceae) such as rice flatsedge (Cyperus iria L.), purple nutsedge (Cyperus rotundus L.), yellow nutsedge (Cyperus esculentus L.), Japanese bulrush (Scirpus juncoides), flatsedge (Cyperus serotinus), small-flower umbrellaplant (Cyperus difformis), slender spikerush (Eleocharis acicularis) and water chestnut (Eleocharis kuroguwai), alismataceae such as Japanese ribbon waparo (Sagittaria pygmaea), arrow-head (Sagittaria trifolia) and narrowleaf waterplantain (Alisma canaliculatum), pontederiaceae such as monochoria (Monochoria Vaginalis) and monochoria species (Monochoria korsakowii), scrophulariaceae such as false pimpernel (Lindernia pyxidaria) and abunome (Dopatrium junceum), lythraceae such as toothcup (Rotala india) and red stem (Ammannia multiflora), and broad leaves such as velvetleaf (Abutilon theophrasti MEDIC.), tall morningglory (Ipomoea purpurea L.), common lambsquarters (Chenopodium album L.), prickly sida (Sida spinosa L.), common purslane (Portulaca oleracea L.), slender amaranth (Amaranthus viridis L.), redroot pigweed (Amaranthus retroflexus L.), sicklepod (Cassia obtusifolia L.), black nightshade (Solanum nigrum L.), pale smartweed (Polygonum lapathifolium L.), common chickweed (Stellaria media L.), long stem waterwort (Elatine triandra SCHK.), common cocklebur (Xanthium strumarium L.), flexuous bittercress (Cardamine flexuosa WITH.), henbit (Lamium amplexicaule L.), common ragweed (Ambrosia elatior L.), catchweed (Galium spurium L.), field bindweed (Calystegia arvensis L.), jimsonweed (Datura stramonium), thistle (Breea setosa (BIEB.) KITAM.) and threeseeded copperleaf (Acalypha australis L.). Further, the herbicidal composition of the present invention is capable of providing good effects when applied at either stage of before or after the germination of the weeds.

The herbicidal composition of the present invention may take various application forms such as soil application, foliar application and water application and is useful for controlling undesired plants in agricultural fields such as upland fields, orchards or paddy fields, or non-agricultural fields such as levee, fallow field, play grounds, vacant grounds, forests, factory sites, railway sides or road sides.

Further, so long as the object of the present invention is met, the composition of the present invention may further contain another herbicidally active ingredient in addition to the above-described active ingredients, whereby it may sometimes be possible to improve e.g. the herbicidal activities, the timing for the application of the herbicide or the range of the weeds to be controlled. Such another herbicidally active ingredient includes, for example, the following compounds (common names including ones under application for approval by ISO, or developing codes). Even when not specifically mentioned here, in a case where such compounds have salts, alkyl esters, etc., they are, of course, all included.

(1) Those which are believed to exhibit herbicidal effects by disturbing hormone activities of plants, such as a phenoxy type such as 2,4-D, 2,4-DB, 2,4-DP, MCPA, MCPB, MCPP or naproanilide, an aromatic carboxylic acid type such as 2,3,6-TBA, dicamba, dichlobenil, picloram, triclopyr, clopyralid or aminopyralid, and others such as naptalam, benazolin, quinclorac, quinmerac, diflufenzopyr and thiazopyr.

(2) Those which are believed to exhibit herbicidal effects by inhibiting photosynthesis of plants, such as a urea type such as chlorotoluron, diuron, fluometuron, linuron, isoproturon, metobenzuron or tebuthiuron, a triazine type such as simazine, atrazine, atratone, simetryn, prometryn, dimethametryn, hexazinone, metribuzin, terbuthylazine, cyanazine, ametryn, cybutryne, triaziflam or propazine, a uracil type such as bromacil, lenacil or terbacil, an anilide type such as propanil or cypromid, a carbamate type such as swep, desmedipham or phenmedipham, a hydroxybenzonitrile type such as bromoxynil, bromoxynil-octanoate or ioxynil, and others such as pyridate, bentazone, amicarbazone and methazole.

(3) Quaternary ammonium salt type such as paraquat or diquat, which is believed to be converted to free radicals by itself to form active oxygen in the plant body.

(4) Those which are believed to exhibit herbicidal effects by inhibiting chlorophyll biosynthesis of plants and abnormally accumulating a photosensitizing peroxide substance in the plant body, such as a diphenylether type such as nitrofen, chlomethoxyfen, bifenox, acifluorfen-sodium, fomesafen, oxyfluorfen, lactofen or ethoxyfen-ethyl, a cyclic imide type such as chlorphthalim, flumioxazin, flumiclorac-pentyl or fluthiacet-methyl, and others such as oxadiargyl, oxadiazon, sulfentrazone, carfentrazone-ethyl, thidiazimin, pentoxazone, azafenidin, isopropazole, pyraflufen-ethyl, benzfendizone, butafenacil, metobenzuron, cinidon-ethyl, flupoxam, fluazolate, profluazol, pyrachlonil, flufenpyr-ethyl and bencarbazone.

(5) Those which are believed to exhibit herbicidal effects characterized by bleaching activities by inhibiting chromogenesis of plants such as carotenoids, such as a pyridazinone type such as norflurazon, chloridazon or metflurazon, a pyrazole type such as pyrazolate, pyrazoxyfen, benzofenap, topramezone (BAS-670H) or pyrasulfotole, and others such as amitrol, fluridone, flurtamone, diflufenican, methoxyphenone, clomazone, sulcotrione, mesotrione, AVH-301, isoxaflutole, difenzoquat, isoxachlortole, benzobicyclone, picolinafen and beflubutamid.

(6) Those which exhibit strong herbicidal effects specifically to gramineous plants, such as an aryloxyphenoxypropionic acid type such as diclofop-methyl, flamprop-M-methyl, pyriphenop-sodium, fluazifop-butyl, haloxyfop-methyl, quizalofop-ethyl, cyhalofop-butyl, fenoxaprop-ethyl or metamifop-propyl, and a cyclohexanedione type such as alloxydim-sodium, clethodim, sethoxydim, tralkoxydim, butroxydim, tepraloxydim, caloxydim, clefoxydim or profoxydim.

(7) Those which are believed to exhibit herbicidal effects by inhibiting an amino acid biosynthesis of plants, such as a sulfonylurea type such as chlorimuron-ethyl, sulfometuron-methyl, primisulfuron-methyl, bensulfuron-methyl, chlorsulfuron, metsulfuron-methyl, cinosulfuron, pyrazosulfuron-ethyl, azimsulfuron, flazasulfuron, rimsulfuron, nicosulfuron, imazosulfuron, cyclosulfamuron, prosulfuron, flupyrsulfuron, trisulfuron-methyl, halosulfuron-methyl, thifensulfuron-methyl, ethoxysulfuron, oxasulfuron, ethametsulfuron, flupyrsulfuron, iodosulfuron, sulfosulfuron, triasulfuron, tribenuron-methyl, tritosulfuron, foramsulfuron, trifloxysulfuron, isosulfuron-methyl, mesosulfuron-methyl or orthosulfamuron, a triazolopyrimidinesulfonamide type such as flumetsulam, metosulam, diclosulam, cloransulam-methyl, florasulam, metosulfam or penoxsulam, an imidazolinone type such as imazapyr, imazethapyr, imazaquin, imazamox, imazameth, imazamethabenz or imazapic, a pyrimidinylsalicylic acid type such as pyrithiobac-sodium, bispyribac-sodium, pyriminobac-methyl, pyribenzoxim, pyriftalid or pyrimisulfan (KUH-021), a sulfonylaminocarbonyltriazolinone type such as flucarbazone or procarbazone-sodium, and others such as glyphosate, glyphosate-ammonium, glyphosate-isopropylamine, sulfosate, glufosinate, glufosinate-ammonium and bilanafos.

(8) Those which are believed to exhibit herbicidal effects by inhibiting cell mitoses of plants, such as a dinitroaniline type such as trifluralin, oryzalin, nitralin, pendimethalin, ethalfluralin, benfluralin or prodiamine, an amide type such as bensulide, napronamide or pronamide, an organic phosphorus type such as amiprofos-methyl, butamifos, anilofos or piperophos, a phenylcarbamate type such as propham, chlorpropham or barban, a cumylamine type such as daimuron, cumyluron or bromobutide, and others such as asulam, dithiopyr, thiazopyr, cafenstrole and indanofan.

(9) Those which are believed to exhibit herbicidal effects by inhibiting protein biosynthesis or lipid biosynthesis of plants, such as a chloroacetamide type such as alachlor, metazachlor, butachlor, pretilachlor, metolachlor, S-metolachlor, thenylchlor, pethoxamid, acetochlor, propachlor or propisochlor, a carbamate type such as molinate, dimepiperate or pyributicarb, and others such as etobenzanid, mefenacet, flufenacet, tridiphane, fentrazamide, oxaziclomefone, dimethenamid and benfuresate.

(10) A thiocarbamate type such as EPTC, butylate, vernolate, pebulate, cycloate, prosulfocarb, esprocarb, thiobencarb, diallate or triallate, and others such as MSMA, DSMA, endothall, ethofumesate, sodium chlorate, pelargonic acid, fosamine, pinoxaden and HOK-201.

(11) Those which are believed to exhibit herbicidal effects by being parasitic on plants, such as Xanthomonas campestris, Epicoccosurus nematosurus, Exserohilum monoseras and Drechsrela monoceras.

The herbicidal composition of the present invention may be prepared by mixing the compound of the formula (I) or its salt, and the compound (B), as active ingredients, with various additives in accordance with conventional formulation methods for agricultural chemicals, and applied in the form of various formulations such as dusts, granules, water dispersible granules, wettable powders, tablets, pills, capsules (including a formulation packaged by a water soluble film), water-based suspensions, oil-based suspensions, microemulsions, suspoemulsions, water soluble powders, emulsifiable concentrates, soluble concentrates or pastes. It may be formed into any formulation which is commonly used in this field, so long as the object of the present invention is thereby met.

At the time of the formulation, the compound of the formula (I) or its salt and the compound (B) may be mixed together for the formulation, or they may be separately formulated and mixed together at the time of the application.

The additives to be used for the formulation include, for example, a solid carrier such as diatomaceous earth, slaked lime, calcium carbonate, talc, white carbon, kaoline, bentonite, a mixture of kaolinite and sericite, clay, sodium carbonate, sodium bicarbonate, mirabilite, zeolite or starch; a solvent such as water, toluene, xylene, solvent naphtha, dioxane, acetone, isophorone, methyl isobutyl ketone, chlorobenzene, cyclohexane, dimethyl sulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenyl ether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or an alkylnaphthalene sulfonate condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used. The mix ratio by weight of the active ingredients to such various additives in the herbicidal composition of the present invention may be from 0.001:99.999 to 95:5, preferably from 0.005:99.995 to 90:10.

Now, some preferred embodiments of the present invention will be exemplified. However, the present invention is by no means restricted thereto.

As a method for applying the herbicidal composition of the present invention, various methods may be employed and may suitably be selected for use depending upon various conditions such as the application sites, the types of the formulations, the types or growth conditions of the plants to be controlled. For example, the following methods may be mentioned.

1. The compound of the formula (I) or its salt, and the compound (B) are mixed together to prepare a formulation, which is applied as it is.

2. The compound of the formula (I) or its salt, and the compound (B) are mixed together to prepare a formulation which is diluted to a predetermined concentration with e.g. water, and, if necessary, various spreaders (a surfactant, a vegetable oil, a mineral oil, etc.) are added, followed by the application.

3. The compound of the formula (I) or its salt, and the compound (B) are separately formulated and applied as formulated.

4. The compound of the formula (I) or its salt, and the compound (B) are separately formulated and respectively diluted to the predetermined concentrations with e.g. water and, if necessary, various spreaders (a surfactant, a vegetable oil, a mineral oil, etc.) are added, followed by the application.

5. The compound of the formula (I) or its salt, and the compound (B) are separately formulated and then mixed at the time of diluting them to the predetermined concentrations by e.g. water, and if necessary, various spreaders (a surfactant, a vegetable oil, a mineral oil, etc.) are added, followed by the application.

(1) A herbicidal composition comprising (A) a compound of the formula (I) or its salt, and (B) at least one compound selected from the group consisting of (B1.1) bensulfuron-methyl, (B1.2) azimsulfuron, (B1.3) pyrazosulfuron-ethyl, (B1.4) imazosulfuron, (B1.5) ethoxysulfuron, (B2.1) pyriminobac-methyl, (B2.2) KUH-021 and (B11.1) penoxsulam, which shows amino acid biosynthesis inhibition, as active ingredients; and a method for controlling undesired plants or inhibiting their growth, which comprises applying a herbicidally effective amount of such a herbicidal composition.

(2) A method for controlling undesired plants or inhibiting their growth, which comprises applying a herbicidally effective amount of (A) a compound of the formula (I) or its salt, and a herbicidally effective amount of (B) at least one compound selected from the group consisting of (B1.1) bensulfuron-methyl, (B1.2) azimsulfuron, (B1.3) pyrazosulfuron-ethyl, (B1.4) imazosulfuron, (B1.5) ethoxysulfuron, (B2.1) pyriminobac-methyl, (B2.2) KUH-021 and (B11.1) penoxsulam, which shows amino acid biosynthesis inhibition.

(3) A herbicidal composition comprising (A) a compound of the formula (I) or its salt, and (B) at least one compound selected from the group consisting of (B3.1) pretilachlor, (B3.2) thenylchlor and (B8.1) benfuresate, which shows lipid biosynthesis inhibition, as active ingredients; and a method for controlling undesired plants or inhibiting their growth, which comprises applying a herbicidally effective amount of such a herbicidal composition.

(4) A method for controlling undesired plants or inhibiting their growth, which comprises applying a herbicidally effective amount of (A) a compound of the formula (I) or its salt, and a herbicidally effective amount of (B) at last one compound selected from the group consisting of (B3.1) pretilachlor, (B3.2) thenylchlor and (B8.1) benfuresate, which shows lipid biosynthesis inhibition.

(5) A herbicidal composition comprising (A) a compound represented by the formula (I) or its salt, and (B) at least one compound selected from the group consisting of (B4.1) benzobicyclon, (B4.2) mesotrione, (B4.3) pyrazoxyfen, (B4.4) AVH-301, (B4.5) pyrazolynate and (B4.6) benzofenap, which shows plant chromogenesis inhibition, as active ingredients; and a method for controlling undesired plants or inhibiting their growth which comprises applying a herbicidally effective amount of such a herbicidal composition.

(6) A method for controlling undesired plants or inhibiting their growth, which comprises applying a herbicidally effective amount of (A) a compound of the formula (I) or its salt, and a herbicidally effective amount of (B) at least one compound selected from the group consisting of (B4.1) benzobicyclon, (B4.2) mesotrione, (B4.3) pyrazoxyfen, (B4.4) AVH-301, (B4.5) pyrazolynate and (B4.6) benzofenap, which shows plant chromogenesis inhibition.

(7) A herbicidal composition comprising (A) a compound of the formula (I) or its salt, and (B) at least one compound selected from the group consisting of (B5.1) simetryn and (B7.1) bentazone, which shows photosynthesis inhibition, as active ingredients; and a method for controlling undesired plants or inhibiting their growth, which comprises applying a herbicidally effective amount of such a herbicidal composition.

(8) A method for controlling undesired plants or inhibiting their growth, which comprises applying a herbicidally effective amount of (A) a compound of the formula (I) or its salt, and a herbicidally effective amount of (B) at least one compound selected from the group consisting of (B5.1) simetryn and (B7.1) bentazone, which shows photosynthesis inhibition.

(9) A herbicidal composition comprising (A) a compound of the formula (I) or its salt, and (B) at least one compound selected from the group consisting of (B6.1) bromobutide, (B6.2) cumyluron, (B9.1) cafenstrole and (B10.1) indanofan, which shows cell mitoses inhibition, as active ingredients; and a method for controlling undesired plants or inhibiting their growth, which comprises a herbicidally effective amount of such a herbicidal composition.

(10) A method for controlling undesired plants or inhibiting their growth, which comprises applying a herbicidally effective amount of (A) a compound of the formula (I) or its salt, and a herbicidally effective amount of (B) at least one compound selected from the group consisting of (B6.1) bromobutide, (B6.2) cumyluron, (B9.1) cafenstrole and (B10.1) indanofan, which shows cell mitoses inhibition.

As a method for applying the herbicidal composition of the present invention, various methods may be employed and may suitably be selected for use depending upon various conditions such as the application sites, the types of the formulations, the types or growth conditions of the plants to be controlled. For example, the following methods may be mentioned.

1. The compound of the formula (I) or its salt, and the compound of the formula (II), its salt or its alkyl ester are mixed together to prepare a formulation, which is applied as it is.

2. The compound of the formula (I) or its salt, and the compound of the formula (II), its salt or its alkyl ester are mixed together to prepare a formulation which is diluted to the predetermined concentration with e.g. water, and, if necessary, various spreaders (a surfactant, a vegetable oil, a mineral oil, etc.) are added, followed by the application.

3. The compound of the formula (I) or its salt, and the compound of the formula (II), its salt or its alkyl ester are separately formulated and applied as formulated.

4. The compound of the formula (I) or its salt, and the compound of the formula (II), its salt or its alkyl ester are separately formulated and respectively diluted to the predetermined concentrations with e.g. water and, if necessary, various spreaders (a surfactant, a vegetable oil, a mineral oil, etc.) are added, followed by the application.

5. The compound of the formula (I) or its salt, and the compound of the formula (II), its salt or its alkyl ester are separately formulated and then mixed at the time of diluting them to the predetermined concentrations with e.g. water, and if necessary, various spreaders (a surfactant, a vegetable oil, a mineral oil, etc.) are added, followed by the application.

When the compound (α) and the compound (D) are applied, they can be applied simultaneously or continuously in the desired order, at the time of application to the crop plants or to the soil or at the time of irrigation. For example, the following methods 1. to 5. may be mentioned.

1. The compound (α) and the compound (D) are mixed together to prepare a formulation, which is applied as it is.

2. The compound (α) and the compound (D) are mixed together to prepare a formulation which is diluted to the predetermined concentration with e.g. water, and, if necessary, various spreaders (a surfactant, a vegetable oil, a mineral oil, etc.) are added, followed by the application.

3. The compound (α) and the compound (D) are separately formulated and applied as formulated.

4. The compound (α) and the compound (D) are separately formulated and respectively diluted to the predetermined concentrations with e.g. water and, if necessary, various spreaders (a surfactant, a vegetable oil, a mineral oil, etc.) are added, followed by the application.

5. The compound (α) and the compound (D) are separately formulated and then mixed at the time of diluting them to the predetermined concentrations with e.g. water, and if necessary, various spreaders (a surfactant, a vegetable oil, a mineral oil, etc.) are added, followed by the application.

Further, when the compound (α) and the compound (D) are applied, they may be applied to seeds of the crop plants as pretreatment (such as immersion of seeds).

### EXAMPLES

Now, Formulation Examples for the herbicidal composition of the present invention will be described, but the present invention is by no means restricted thereto.

### Formulation Example 1

| | | | |
|---|---|---|---|
| (1) | Compound A2 | 4.47 | g |
| (2) | Compound (B1.1) | 10.37 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 79.16 | g |

The above components are mixed in the above mix ratio and then pulverized by a centrifugal mill (a screen with a diameter of 1.0 mm) to obtain a wettable powder.

### Formulation Example 2

| | | | |
|---|---|---|---|
| (1) | Compound A2 | 11.18 | g |
| (2) | Compound (B1.2) | 3.03 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.DX-C, manufactured by | | |
| | TAKEMOTO OIL & FAT CO., LTD.) | | |
| (5) | Clay | 79.79 | g |

The above components are mixed in the above mix ratio and then pulverized by a centrifugal mill (a screen with a diameter of 1.0 mm) to obtain a wettable powder.

### Formulation Example 3

| | | | |
|---|---|---|---|
| (1) | Compound A2 | 11.18 | g |
| (2) | Compound (B1.3) | 10.74 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 72.08 | g |

The above components are mixed in the above mix ratio and then pulverized by a centrifugal mill (a screen with a diameter of 1.0 mm) to obtain a wettable powder.

### Formulation Example 4

| | | | |
|---|---|---|---|
| (1) | Compound A2 | 4.47 | g |
| (2) | Compound (B1.4) | 18.52 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 71.01 | g |

The above components are mixed in the above mix ratio and then pulverized by a centrifugal mill (a screen with a diameter of 1.0 mm) to obtain a wettable powder.

### Formulation Example 5

| | | | |
|---|---|---|---|
| (1) | Compound A2 | 11.18 | g |
| (2) | Compound (B1.5) | 10.85 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 71.97 | g |

The above components are mixed in the above mix ratio and then pulverized by a centrifugal mill (a screen with a diameter of 1.0 mm) to obtain a wettable powder.

### Formulation Example 6

| | | | |
|---|---|---|---|
| (1) | Compound A2 | 11.18 | g |
| (2) | Compound (B2.1) | 23.20 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 59.62 | g |

The above components are mixed in the above mix ratio and then pulverized by a centrifugal mill (a screen with a diameter of 1.0 mm) to obtain a wettable powder.

### Formulation Example 7

| | | | |
|---|---|---|---|
| (1) | Compound A2 | 2.24 | g |
| (2) | Compound (B3.1) | 20.83 | g |
| (3) | Polyoxyethylene styrylphenyl ether and | 15.00 | g |
| | calcium dodecylbenzenesulfonate (tradename: | | |
| | Sorpol 3661S, manufactured by TOHO Chemical | | |
| | Industry Co., Ltd.) | | |
| (4) | Aromatic hydrocarbon (tradename: Solvesso 150, | 51.93 | g |
| | manufactured by EXXON CHEMICAL) | | |
| (5) | N-methyl-2-pyrrolidone | 10.00 | g |

Compound A2 is dissolved in N-methyl-2-pyrrolidone at room temperature, and then Solvesso 150, compound (B3.1) and Sorpol 3661S are mixed in the above mix ratio to obtain an emulsifiable concentrate.

### Formulation Example 8

| | | | |
|---|---|---|---|
| (1) | Compound A2 | 2.24 | g |
| (2) | Compound (B3.2) | 25.30 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 66.46 | g |

The above components are mixed in the above mix ratio and then pulverized by a centrifugal mill (a screen with a diameter of 1.0 mm) to obtain a wettable powder.

### Formulation Example 9

| | | | |
|---|---|---|---|
| (1) | Compound A2 | 2.24 | g |
| (2) | Compound (B4.1) | 20.04 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 71.72 | g |

The above components are mixed in the above mix ratio and then pulverized by a centrifugal mill (a screen with a diameter of 1.0 mm) to obtain a wettable powder.

### Formulation Example 10

| | | | |
|---|---|---|---|
| (1) | Compound A2 | 4.47 | g |
| (2) | Compound (B4.2) | 10.31 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 79.22 | g |

The above components are mixed in the above mix ratio and then pulverized by a centrifugal mill (a screen with a diameter of 1.0 mm) to obtain a wettable powder.

### Formulation Example 11

| | | | |
|---|---|---|---|
| (1) | Compound A2 | 0.45 | g |
| (2) | Compound (B4.3) | 31.32 | g |
| (3) | Sodium naphthalene sulfonate condensed with | 5.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 60.23 | g |

The above components are mixed in the above mix ratio and then pulverized by a centrifugal mill (a screen with a diameter of 1.0 mm) to obtain a wettable powder.

### Formulation Example 12

| | | | |
|---|---|---|---|
| (1) | Compound A2 | 2.24 | g |
| (2) | Compound (B4.4) | 30.6 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 61.16 | g |

The above components are mixed in the above mix ratio and then pulverized by a centrifugal mill (a screen with a diameter of 1.0 mm) to obtain a wettable powder.

### Formulation Example 13

| | | | |
|---|---|---|---|
| (1) | Compound A2 | 0.45 | g |
| (2) | Compound (B4.4) | 6.12 | g |
| (3) | Polyoxyethylene tridecyl ether (tradename: | 10.0 | g |
| | NOIGEN TDS-30, manufactured by | | |
| | DAI-ICHI KOGYO SEIYAKU CO., LTD.) | | |
| (4) | Normal paraffin (tradename: N-13, | 83.43 | g |
| | manufactured by Nippon Mining Co., Ltd.) | | |

The above components are mixed and subjected to wet milling to an average particle size of at most 5 μm to obtain an oil-based suspension.

### Formulation Example 14

| | | | |
|---|---|---|---|
| (1) | Compound A2 | 2.24 | g |
| (2) | Compound (B5.1) | 45.78 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 45.98 | g |

The above components are mixed in the above mix ratio and then pulverized by a centrifugal mill (a screen with a diameter of 1.0 mm) to obtain a wettable powder.

### Formulation Example 15

| | | | |
|---|---|---|---|
| (1) | Compound A2 | 1.12 | g |
| (2) | Compound (B6.1) | 51.71 | g |
| (3) | Sodium naphthalene sulfonate condensed with | 6.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 6.0 | g |
| | (tradename: NK.BX-C, manufactured by | | |
| | TAKEMOTO OIL & FAT CO., LTD.) | | |
| (5) | Clay | 35.17 | g |

The above components are mixed in the above mix ratio and then pulverized by a centrifugal mill (a screen with a diameter of 1.0 mm) to obtain a wettable powder.

### Formulation Example 16

| | | | |
|---|---|---|---|
| (1) | Compound A2 | 0.45 | g |
| (2) | Compound (B6.2) | 30.93 | g |
| (3) | Sodium naphthalene sulfonate condensed with | 5.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 60.62 | g |

The above components are mixed in the above mix ratio and then pulverized by a centrifugal mill (a screen with a diameter of 1.0 mm) to obtain a wettable powder.

### Formulation Example 17

| | | | |
|---|---|---|---|
| (1) | Compound A2 | 0.224 | g |
| (2) | Compound (B7.1) | 25.00 | g |
| (3) | Sodium dialkylnaphthalene sulfonate | 3.0 | g |
| | (tradename: NK.BX-C, manufactured by | | |
| | TAKEMOTO OIL & FAT CO., LTD.) | | |
| (4) | Sodium alkylnaphthalene sulfonate | 3.0 | g |
| | (tradename: NK.WG-1, manufactured by | | |
| | TAKEMOTO OIL & FAT CO., LTD.) | | |
| (5) | Bentonite | 30.0 | g |
| (6) | Calcium carbonate | 38.776 | g |

The above components are mixed in the above mix ratio and then pulverized by a centrifugal mill (a screen with a diameter of 1.0 mm). Then, the pulverized mixture is kneaded with water and granulated with a basket type extruder equipped with a screen having a diameter of 0.8 mm. The granulated product is dried for 30 minutes by a fluidized bed dryer set at 60° C. and then sieved (to from 14 to 60 mesh) to obtain granules.

### Formulation Example 18

| | | | |
|---|---|---|---|
| (1) | Compound A2 | 0.224 | g |
| (2) | Compound (B8.1) | 3.086 | g |
| (3) | Sodium dialkylnaphthalene sulfonate | 3.0 | g |
| | (tradename: NK.BX-C, manufactured by | | |
| | TAKEMOTO OIL & FAT CO., LTD.) | | |
| (4) | Sodium alkylnaphthalene sulfonate | 3.0 | g |
| | (tradename: NK.WG-1, manufactured by | | |
| | TAKEMOTO OIL & FAT CO., LTD.) | | |
| (5) | White carbon | 10.0 | g |
| (6) | Bentonite | 30.0 | g |
| (7) | Calcium carbonate | 50.69 | g |

Compound (B8.1) is heated at 60° C., and white carbon is added. To the mixture, compound A2, sodium dialkylnaphthalene sulfonate, sodium alkylnaphthalene sulfonate, bentonite and calcium carbonate are mixed in the above mix ratio, and the mixture is pulverized by a centrifugal mill (a screen with a diameter of 1.0 mm). Then, the pulverized mixture is kneaded with water and granulated with a basket type extruder equipped with a screen having a diameter of 0.8 mm. The granulated product is dried for 30 minutes by a fluidized bed dryer set at 60° C. and then sieved (to from 14 to 60 mesh) to obtain granules.

### Formulation Example 19

| | | | |
|---|---|---|---|
| (1) | Compound A2 | 2.24 | g |
| (2) | Compound (B9.1) | 20.32 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 71.44 | g |

The above components are mixed in the above mix ratio and then pulverized by a centrifugal mill (a screen with a diameter of 1.0 mm) to obtain a wettable powder.

### Formulation Example 20

| | | | |
|---|---|---|---|
| (1) | Compound A2 | 2.24 | g |
| (2) | Compound (B10.1) | 15.13 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 76.63 | g |

The above components are mixed in the above mix ratio and then pulverized by a centrifugal mill (a screen with a diameter of 1.0 mm) to obtain a wettable powder.

### Formulation Example 21

| | | |
|---|---|---|
| (1) | Compound A2 | 11.18 g |
| (2) | Compound (B11.1) | 15.38 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 67.44 g |

The above components are mixed in the above mix ratio and then pulverized by a centrifugal mill (a screen with a diameter of 1.0 mm) to obtain a wettable powder.

### Formulation Example 22

| | | |
|---|---|---|
| (1) | Compound A2 | 0.45 g |
| (2) | Compound (B11.1) | 0.62 g |
| (3) | Polyoxyethylene tristyrylphenyl ether | 5.0 g |
| | phosphoric acid ester (tradename: Soprophor | |
| | 3D33, manufactured by Rhodia Nicca, Ltd.) | |
| (4) | Polydimethyl siloxane | 0.1 g |
| | (tradename: Rhodorsil antifoam 432, | |
| | manufactured by Rhodia Nicca, Ltd.) | |
| (5) | Propylene glycol | 5.0 g |
| (6) | Water | 88.83 g |

The above components are mixed and then subjected to wet milling to an average particle size of at most 5 μm to obtain a water-based suspension.

### Formulation Example 23

| | | |
|---|---|---|
| (1) | Compound A2 | 1.52 g |
| (2) | Compound C6 | 18.80 g |
| (3) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.00 g |
| | (tradename: Newkalgen BX-C, manufactured | |
| | by TAKEMOTO OIL & FAT CO., LTD.) | |
| (5) | White carbon | 15.00 g |
| (6) | Kaoline | 58.68 g |

Compound C6 is mixed with white carbon, and then the other components are mixed to obtain a wettable powder.

### Formulation Example 24

| | | |
|---|---|---|
| (1) | Compound A2 | 4.56 g |
| (2) | Compound C1 | 50.10 g |
| (3) | Lavelin FA-N (tradename) | 3.00 g |
| (4) | Newkalgen BX-C (tradename) | 3.00 g |
| (5) | Kaoline | 39.34 g |

The above components are mixed to obtain a wettable powder.

### Formulation Example 25

| | | |
|---|---|---|
| (1) | Compound A2 | 1.52 g |
| (2) | Compound C2 | 18.40 g |
| (3) | Sodium naphthalene sulfonate condensed with | 5.00 g |
| | formaldehyde (tradename: Newkalgen WG-2 | |
| | manufactured by TAKEMOTO OIL & FAT CO., | |
| | LTD.) | |
| (4) | Sodium alkylnaphthalene sulfonate | 3.00 g |
| | (tradename: Newkalgen WG-1, manufactured | |
| | by TAKEMOTO OIL & FAT CO., LTD.) | |
| (5) | White carbon | 15.00 g |
| (6) | Starch | 27.08 g |
| (7) | Calcium carbonate | 30.00 g |

Compound C2 is mixed with white carbon, and then the other components are mixed, and the mixture is kneaded with water. The kneaded product is granulated with a basket type extruder equipped with a screen having a diameter of 0.8 mm and dried for 30 minutes by a fluidized bed dryer set at 60° C. and then sieved (to from 14 to 60 mesh) to obtain water dispersible granules.

### Formulation Example 26

| | | |
|---|---|---|
| (1) | Bentonite containing 10 wt % of compound A2 | 3.05 g |
| (2) | Bentonite containing 10 wt % of compound C4 | 24.80 g |
| (3) | Newkalgen BX-C (tradename) | 3.00 g |
| (4) | Newkalgen WG-1 (tradename) | 3.00 g |
| (5) | Bentonite | 10.00 g |
| (6) | Calcium carbonate | 56.15 g |

The above components are mixed and kneaded with water. The kneaded product is granulated with a basket type extruder equipped with a screen having a diameter of 0.8 mm and dried for 30 minutes by a fluidized bed dryer set at 60° C. and then sieved (to from 14 to 60 mesh) to obtain granules.

### Formulation Example 27

| | | |
|---|---|---|
| (1) | Compound A2 | 3.05 g |
| (2) | Compound C3 | 21.80 g |
| (3) | Lavelin FA-N (tradename) | 3.00 g |
| (4) | Newkalgen BX-C (tradename) | 3.00 g |
| (5) | Kaoline | 69.15 g |

The above components are mixed to obtain a wettable powder.

### Formulation Example 28

| | | |
|---|---|---|
| (1) | Compound A2 | 0.45 g |
| (2) | Compound (D1.1) | 31.09 g |
| (3) | Sodium naphthalene sulfonate condensed with | 5.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 60.46 g |

The above components are mixed in the above mix ratio and then pulverized by a centrifugal mill (a screen with a diameter of 1.0 mm) to obtain a wettable powder.

### Formulation Example 29

| | | |
|---|---|---|
| (1) | Compound A2 | 0.15 g |
| (2) | Compound (D2.2) | 16.49 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | White carbon | 25.0 g |
| (6) | Clay | 52.36 g |

Oily molinate is absorbed in white carbon so that they are mixed, and the other components are mixed, and then the mixture is pulverized by a centrifugal mill (a screen with a diameter of 1.0 mm) to obtain a wettable powder.

### Formulation Example 30

| | | |
|---|---|---|
| (1) | Compound A2 | 2.24 g |
| (2) | Compound (D2.3) | 51.71 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 40.05 g |

The above components are mixed and then pulverized by a centrifugal mill (a screen with a diameter of 1.0 mm) to obtain a wettable powder.

### Formulation Example 31

| | | |
|---|---|---|
| (1) | Compound A2 (purity 98.4%) | 2.24 g |
| (2) | Compound (B2.2) (purity 95.0%) | 7.05 g |
| (3) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.00 g |
| | (tradename: NK.BX-C, manufactured by | |
| | TAKEMOTO OIL & FAT CO., LTD.) | |
| (5) | Clay | 84.71 g |

The above components are mixed in the above mix ratio and then pulverized by a centrifugal mill (a screen with a diameter of 1.0 mm) to obtain a wettable powder.

### Formulation Example 32

| | | |
|---|---|---|
| (1) | Compound A2 (purity 98.4%) | 2.24 g |
| (2) | Compound (B2.2) (purity 95.0%) | 7.05 g |
| (3) | Polyoxyethylene styrylphenyl ether and | 15.00 g |
| | calcium dodecylbenzenesulfonate (tradename: | |
| | Sorpol 3661S, manufactured by TOHO Chemical | |
| | Industry Co., Ltd.) | |
| (4) | Aromatic hydrocarbon (tradename: Solvesso 150, | 35.71 g |
| | manufactured by EXXON CHEMICAL) | |
| (5) | N-methyl-2-pyrrolidone | 40.00 g |

Compound A2 and compound (B2.2) are dissolved in N-methyl-2-pyrrolidone at room temperature, and then Solvesso 150 and Sorpol 3661S are mixed in the above mix ratio to obtain an emulsifiable concentrate.

### Formulation Example 33

| | | |
|---|---|---|
| (1) | Compound A2 (purity 98.4%) | 0.45 g |
| (2) | Compound (B8.1) (purity 97.0%) | 12.37 g |
| (3) | Compound (B5.1) (purity 98.3%) | 9.16 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | White carbon | 7.00 g |
| | (tradename: Carplex #80, manufactured | |
| | by DSL. Japan Co., Ltd.) | |
| (7) | Clay | 65.02 g |

Compound (B8.1) is heated at 60° C. and mixed with white carbon, and then compound A2, compound (B5.1), sodium naphthalene sulfonate condensed with formaldehyde, sodium dialkylnaphthalene sulfonate and clay are mixed in the above mix ratio, and the mixture is pulverized by a centrifugal mill (a screen with a diameter of 1.0 mm) to obtain a wettable powder.

### Formulation Example 34

| | | |
|---|---|---|
| (1) | Compound A2 (purity 98.4%) | 0.45 g |
| (2) | Compound (B8.1) (purity 97.0%) | 12.37 g |
| (3) | Compound (B4.3) (purity 95.8%) | 37.58 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | White carbon | 7.00 g |
| | (tradename: Carplex #80, manufactured | |
| | by DSL. Japan Co., Ltd.) | |
| (7) | Clay | 36.60 g |

Compound (B8.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 35

| | | |
|---|---|---|
| (1) | Compound A2 (purity 98.4%) | 2.24 g |
| (2) | Compound (B1.2) (purity 99.0%) | 0.61 g |
| (3) | Compound (B5.1) (purity 98.3%) | 45.78 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 45.37 g |

The above components are mixed in the above mix ratio and then pulverized by a centrifugal mill (a screen with a diameter of 1.0 mm) to obtain a wettable powder.

### Formulation Example 36

| | | |
|---|---|---|
| (1) | Compound A2 (purity 98.4%) | 2.24 g |
| (2) | Compound (B1.2) (purity 99.0%) | 1.01 g |
| (3) | Compound (B5.1) (purity 98.3%) | 45.78 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 44.97 g |

The above components are mixed in the above mix ratio and then pulverized by a centrifugal mill (a screen with a diameter of 1.0 mm) to obtain a wettable powder.

### Formulation Example 37

| | | |
|---|---|---|
| (1) | Compound A2 (purity 98.4%) | 0.30 g |
| (2) | Compound (B3.1) (purity 96.0%) | 8.33 g |
| (3) | Compound (B8.1) (purity 97.0%) | 12.37 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | White carbon | 12.00 g |
| | (tradename: Carplex #80, manufactured | |
| | by DSL. Japan Co., Ltd.) | |
| (7) | Clay | 61.00 g |

Compound (B3.1) and Compound (B8.1) are heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 38

| | | |
|---|---|---|
| (1) | Compound A2 (purity 98.4%) | 0.30 g |
| (2) | Compound (B3.1) (purity 96.0%) | 8.33 g |
| (3) | Compound (B4.1) (purity 99.8%) | 4.01 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | White carbon | 5.00 g |
| | (tradename: Carplex #80, manufactured | |
| | by DSL. Japan Co., Ltd.) | |
| (7) | Clay | 76.36 g |

Compound (B3.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 39

| | | |
|---|---|---|
| (1) | Compound A2 (purity 98.4%) | 0.30 g |
| (2) | Compound (B3.1) (purity 96.0%) | 8.33 g |
| (3) | Compound (B6.1) (purity 96.7%) | 20.68 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | White carbon | 5.00 g |
| | (tradename: Carplex #80, manufactured | |
| | by DSL. Japan Co., Ltd.) | |
| (7) | Clay | 59.69 g |

Compound (B3.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 40

| | | |
|---|---|---|
| (1) | Compound A2 (purity 98.4%) | 0.30 g |
| (2) | Compound (B9.1) (purity 98.4%) | 4.27 g |
| (3) | Compound (B8.1) (purity 97.0%) | 12.37 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | White carbon | 7.00 g |
| | (tradename: Carplex #80, manufactured | |
| | by DSL. Japan Co., Ltd.) | |
| (7) | Clay | 70.06 g |

Compound (B8.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 41

| | | |
|---|---|---|
| (1) | Compound A2 (purity 98.4%) | 1.52 g |
| (2) | Compound (B9.1) (purity 98.4%) | 21.34 g |
| (3) | Compound (B4.1) (purity 99.8%) | 20.04 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 51.10 g |

The above components are mixed in the above mix ratio and then pulverized by a centrifugal mill (a screen with a diameter of 1.0 mm) to obtain a wettable powder.

### Formulation Example 42

| | | |
|---|---|---|
| (1) | Compound A2 (purity 98.4%) | 0.51 g |
| (2) | Compound (B9.1) (purity 98.4%) | 7.11 g |
| (3) | Compound (B6.1) (purity 96.7%) | 34.47 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 51.91 g |

The above components are mixed in the above mix ratio and then pulverized by a centrifugal mill (a screen with a diameter of 1.0 mm) to obtain a wettable powder.

### Formulation Example 43

| | | |
|---|---|---|
| (1) | Compound A2 (purity 98.4%) | 0.30 g |
| (2) | Compound (B3.2) (purity 95.0%) | 5.26 g |
| (3) | Compound (B8.1) (purity 97.0%) | 12.37 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | White carbon | 7.00 g |
| | (tradename: Carplex #80, manufactured | |
| | by DSL. Japan Co., Ltd.) | |
| (7) | Clay | 69.07 g |

Compound (B8.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 44

| | | |
|---|---|---|
| (1) | Compound A2 (purity 98.4%) | 1.52 g |
| (2) | Compound (B3.2) (purity 95.0%) | 26.32 g |
| (3) | Compound (B4.1) (purity 99.8%) | 20.04 g |
| (4) | Sodium naphthalene sulfonate condensed with | 3.00 g |
| | formaldehyde (tradename: Lavelin FA-N, | |
| | manufactured by DAI-ICHI KOGYO SEIYAKU Co., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 46.12 g |

The above components are mixed in the above mix ratio and then pulverized by a centrifugal mill (a screen with a diameter of 1.0 mm) to obtain a wettable powder.

### Formulation Example 45

| | | |
|---|---|---|
| (1) | Compound A2 (purity 98.4%) | 0.76 g |
| (2) | Compound (B3.2) (purity 95.0%) | 13.16 g |
| (3) | Compound (B6.1) (purity 96.7%) | 51.71 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 28.37 g |

The above components are mixed in the above mix ratio and then pulverized by a centrifugal mill (a screen with a diameter of 1.0 mm) to obtain a wettable powder.

### Formulation Example 46

| | | |
|---|---|---|
| (1) | Compound A2 (purity 98.4%) | 0.30 g |
| (2) | Compound (D2.3) (purity 96.0%) | 13.02 g |
| (3) | Compound (B8.1) (purity 97.0%) | 12.37 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | White carbon | 7.00 g |
| | (tradename: Carplex #80, manufactured | |
| | by DSL. Japan Co., Ltd.) | |
| (7) | Clay | 61.31 g |

Compound (B8.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 47

| | | |
|---|---|---|
| (1) | Compound A2 (purity 98.4%) | 0.76 g |
| (2) | Compound (D2.3) (purity 96.0%) | 31.25 g |
| (3) | Compound (B4.1) (purity 99.8%) | 10.02 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 51.97 g |

The above components are mixed in the above mix ratio and then pulverized by a centrifugal mill (a screen with a diameter of 1.0 mm) to obtain a wettable powder.

### Formulation Example 48

| | | |
|---|---|---|
| (1) | Compound A2 (purity 98.4%) | 0.51 g |
| (2) | Compound (D2.3) (purity 96.0%) | 20.83 g |
| (3) | Compound (B6.1) (purity 96.7%) | 34.47 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 38.19 g |

The above components are mixed in the above mix ratio and then pulverized by a centrifugal mill (a screen with a diameter of 1.0 mm) to obtain a wettable powder.

### Formulation Example 49

| | | |
|---|---|---|
| (1) | Compound A2 (purity 98.4%) | 0.30 g |
| (2) | Compound (B10.1) (purity 98.4%) | 3.05 g |
| (3) | Compound (B8.1) (purity 97.0%) | 12.37 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | White carbon | 7.00 g |
| | (tradename: Carplex #80, manufactured | |
| | by DSL. Japan Co., Ltd.) | |
| (7) | Clay | 71.28 g |

Compound (B8.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 50

| | | |
|---|---|---|
| (1) | Compound A2 (purity 98.4%) | 1.52 g |
| (2) | Compound (B10.1) (purity 98.4%) | 15.24 g |
| (3) | Compound (B4.1) (purity 99.8%) | 20.04 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 57.20 g |

The above components are mixed in the above mix ratio and then pulverized by a centrifugal mill (a screen with a diameter of 1.0 mm) to obtain a wettable powder.

### Formulation Example 51

| | | |
|---|---|---|
| (1) | Compound A2 (purity 98.4%) | 0.76 g |
| (2) | Compound (B10.1) (purity 98.4%) | 7.62 g |
| (3) | Compound (B6.1) bromobutide (purity 96.7%) | 51.71 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 33.91 g |

The above components are mixed in the above mix ratio and then pulverized by a centrifugal mill (a screen with a diameter of 1.0 mm) to obtain a wettable powder.

### Formulation Example 52

| | | |
|---|---|---|
| (1) | Compound A2 (purity 98.4%) | 2.24 g |
| (2) | Compound (B1.6) (purity 95.0%) | 6.32 g |
| (3) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.00 g |
| | (tradename: NK.BX-C, manufactured by | |
| | TAKEMOTO OIL & FAT CO., LTD.) | |
| (5) | Clay | 85.44 g |

The above components are mixed in the above mix ratio and then pulverized by a centrifugal mill (a screen with a diameter of 1.0 mm) to obtain a wettable powder.

### Formulation Example 53

| | | |
|---|---|---|
| (1) | Compound A2 (purity 98.4%) | 0.45 g |
| (2) | Compound (B4.5) (purity 96.0%) | 20.83 g |
| (3) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.00 g |
| | (tradename: NK.BX-C, manufactured by | |
| | TAKEMOTO OIL & FAT CO., LTD.) | |
| (5) | Clay | 72.72 g |

The above components are mixed in the above mix ratio and then pulverized by a centrifugal mill (a screen with a diameter of 1.0 mm) to obtain a wettable powder.

### Formulation Example 54

| | | |
|---|---|---|
| (1) | Compound A2 (purity 98.4%) | 0.75 g |
| (2) | Compound (B4.6) (purity 96.0%) | 20.83 g |
| (3) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 72.42 g |

The above components are mixed in the above mix ratio and then pulverized by a centrifugal mill (a screen with a diameter of 1.0 mm) to obtain a wettable powder.

### Formulation Example 55

| | | |
|---|---|---|
| (1) | Compound A1 | 4.47 g |
| (2) | Compound (B1.1) | 10.37 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 79.16 g |

The above components are mixed in the above mix ratio and then pulverized by a centrifugal mill (a screen with a diameter of 1.0 mm) to obtain a wettable powder.

### Formulation Example 56

| | | |
|---|---|---|
| (1) | Compound A1 | 11.18 g |
| (2) | Compound (B1.2) | 3.03 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 79.79 g |

The above components are mixed in the above mix ratio and then pulverized by a centrifugal mill (a screen with a diameter of 1.0 mm) to obtain a wettable powder.

### Formulation Example 57

| | | |
|---|---|---|
| (1) | Compound A1 | 11.18 g |
| (2) | Compound (B1.3) | 10.74 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 72.08 g |

The above components are mixed in the above mix ratio and then pulverized by a centrifugal mill (a screen with a diameter of 1.0 mm) to obtain a wettable powder.

### Formulation Example 58

| | | |
|---|---|---|
| (1) | Compound A1 | 4.47 g |
| (2) | Compound (B1.4) | 18.52 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 59.62 g |

(tradename: NK.BX-C, manufactured by

TAKEMOTO OIL & FAT CO., LTD.) 3.0 g
(5) Clay 71.01 g

The above components are mixed in the above mix ratio and then pulverized by a centrifugal mill (a screen with a diameter of 1.0 mm) to obtain a wettable powder.

### Formulation Example 59

(1) Compound A1 11.18 g
(2) Compound (B1.5) 10.85 g
(3) Sodium naphthalene sulfonate condensed with formaldehyde (tradename: Lavelin FA-N, manufactured by DAI-ICHI KOGYO SEIYAKU CO., LTD.) 3.0 g
(4) Sodium dialkylnaphthalene sulfonate (tradename: NK.BX-C, manufactured by TAKEMOTO OIL & FAT CO., LTD.) 3.0 g
(5) Clay 71.97 g

The above components are mixed in the above mix ratio and then pulverized by a centrifugal mill (a screen with a diameter of 1.0 mm) to obtain a wettable powder.

### Formulation Example 60

(1) Compound A11.18 g
(2) Compound (B2.1) 23.20 g
(3) Sodium naphthalene sulfonate condensed with formaldehyde (tradename: Lavelin FA-N, manufactured by DAI-ICHI KOGYO SEIYAKU CO., LTD.) 3.0 g

The above components are mixed in the above mix ratio and then pulverized by a centrifugal mill (a screen with a diameter of 1.0 mm) to obtain a wettable powder.

### Formulation Example 61

| | | |
|---|---|---|
| (1) | Compound A1 | 2.24 g |
| (2) | Compound (B3.1) | 20.83 g |
| (3) | Polyoxyethylene styrylphenyl ether and | 15.00 g |
| | calcium dodecylbenzenesulfonate (tradename: | |
| | Sorpol 3661S, manufactured by TOHO Chemical | |
| | Industry Co., Ltd.) | |
| (4) | Aromatic hydrocarbon (tradename: Solvesso 150, | 51.93 g |
| | manufactured by EXXON CHEMICAL) | |
| (5) | N-methyl-2-pyrrolidone | 10.00 g |

Compounds A1 is dissolved in N-methyl-2-pyrrolidone at room temperature, and then Solvesso 150, compound (B3.1) and Sorpol 3661S are mixed in the above mix ratio to obtain an emulsifiable concentrate.

### Formulation Example 62

| | | |
|---|---|---|
| (1) | Compound A1 | 2.24 g |
| (2) | Compound (B3.2) | 25.30 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 66.46 g |

The above components are mixed and then pulverized by a centrifugal mill (a screen with a diameter of 1.0 mm) to obtain a wettable powder.

### Formulation Example 63

| | | |
|---|---|---|
| (1) | Compound A1 | 2.24 g |
| (2) | Compound (B4.1) | 20.04 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 71.72 g |

The above components are mixed in the above mix ratio and then pulverized by a centrifugal mill (a screen with a diameter of 1.0 mm) to obtain a wettable powder.

### Formulation Example 64

| | | |
|---|---|---|
| (1) | Compound A1 | 4.47 g |
| (2) | Compound (B4.2) | 10.31 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 79.22 g |

The above components are mixed in the above mix ratio and then pulverized by a centrifugal mill (a screen with a diameter of 1.0 mm) to obtain a wettable powder.

### Formulation Example 65

| | | |
|---|---|---|
| (1) | Compound A1 | 0.45 g |
| (2) | Compound (B4.3) | 31.32 g |
| (3) | Sodium naphthalene sulfonate condensed with | 5.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 60.23 g |

The above components are mixed in the above mix ratio and then pulverized by a centrifugal mill (a screen with a diameter of 1.0 mm) to obtain a wettable powder.

### Formulation Example 66

| | | | |
|---|---|---|---|
| (1) | Compound A1 | 2.24 | g |
| (2) | Compound (B4.4) | 30.6 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 61.16 | g |

The above components are mixed in the above mix ratio and then pulverized by a centrifugal mill (a screen with a diameter of 1.0 mm) to obtain a wettable powder.

### Formulation Example 67

| | | |
|---|---|---|
| (1) | Compound A1 | 0.45 g |
| (2) | Compound (B4.4) | 6.12 g |
| (3) | Polyoxyethylene tridecyl ether (tradename: | 10.0 g |
| | NOIGEN TDS-30, manufactured by | |
| | DAI-ICHI KOGYO SEIYAKU CO., LTD.) | |
| (4) | Normal paraffin (tradename: N-13, | 83.43 g |
| | manufactured by Nippon Mining CO., Ltd.) | |

The above components are mixed and subjected to wet milling to an average particle size of at most 5 μm to obtain an oil-based suspension.

### Formulation Example 68

| | | |
|---|---|---|
| (1) | Compound A1 | 2.24 g |
| (2) | Compound (B5.1) | 45.78 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 45.98 g |

The above components are mixed in the above mix ratio and then pulverized by a centrifugal mill (a screen with a diameter of 1.0 mm) to obtain a wettable powder.

### Formulation Example 69

| | | |
|---|---|---|
| (1) | Compound A1 | 1.12 g |
| (2) | Compound (B6.1) | 51.71 g |
| (3) | Sodium naphthalene sulfonate condensed with | 6.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 6.0 g |
| | (tradename: NK.BX-C, manufactured by | |
| | TAKEMOTO OIL & FAT CO., LTD.) | |
| (5) | Clay | 35.17 g |

The above components are mixed in the above mix ratio and then pulverized by a centrifugal mill (a screen with a diameter of 1.0 mm) to obtain a wettable powder.

### Formulation Example 70

| | | |
|---|---|---|
| (1) | Compound A1 | 0.45 g |
| (2) | Compound (B6.2) | 30.93 g |
| (3) | Sodium naphthalene sulfonate condensed with | 5.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 60.62 g |

The above components are mixed in the above mix ratio and then pulverized by a centrifugal mill (a screen with a diameter of 1.0 mm) to obtain a wettable powder.

### Formulation Example 71

| | | |
|---|---|---|
| (1) | Compound A1 | 0.224 g |
| (2) | Compound (B7.1) | 25.00 g |
| (3) | Sodium dialkylnaphthalene sulfonate | 3.0 g |
| | (tradename: NK.BX-C, manufactured by | |
| | TAKEMOTO OIL & FAT CO., LTD.) | |
| (4) | Sodium alkylnaphthalene sulfonate | 3.0 g |
| | (tradename: NK.WG-1, manufactured by | |
| | TAKEMOTO OIL & FAT CO., LTD.) | |
| (5) | Bentonite | 30.0 g |
| (6) | Calcium carbonate | 38.776 g |

The above components are mixed in the above mix ratio and then pulverized by a centrifugal mill (a screen with a diameter of 1.0 mm). Then, the pulverized mixture is kneaded with water and granulated with a basket type extruder equipped with a screen having a diameter of 0.8 mm. The granulated product is dried for 30 minutes by a fluidized bed dryer set at 60° C. and then sieved (to from 14 to 60 mesh) to obtain granules.

### Formulation Example 72

| | | |
|---|---|---|
| (1) | Compound A1 | 0.224 g |
| (2) | Compound (B8.1) | 3.086 g |
| (3) | Sodium dialkylnaphthalene sulfonate | 3.0 g |
| | (tradename: NK.BX-C, manufactured by | |
| | TAKEMOTO OIL & FAT CO., LTD.) | |
| (4) | Sodium alkylnaphthalene sulfonate | 3.0 g |
| | (tradename: NK.WG-1, manufactured by | |
| | TAKEMOTO OIL & FAT CO., LTD.) | |
| (5) | White carbon | 10.0 g |
| (6) | Bentonite | 30.0 g |
| (7) | Calcium carbonate | 50.69 g |

Compound (B8.1) is heated at 60° C., and white carbon is added. To the mixture, compound A1, sodium dialkylnaphthalene sulfonate, sodium alkylnaphthalene sulfonate, bentonite and calcium carbonate are mixed in the above mix ratio, and the mixture is pulverized by a centrifugal mill (a screen with a diameter of 1.0 mm). Then, the pulverized mixture is kneaded with water and granulated with a basket type extruder equipped with a screen having a diameter of 0.8 mm. The granulated product is dried for 30 minutes by a fluidized bed dryer set at 60° C. and then sieved (to from 14 to 60 mesh) to obtain granules.

### Formulation Example 73

| | | |
|---|---|---|
| (1) | Compound A1 | 2.24 g |
| (2) | Compound (B9.1) | 20.32 g |
| (3) | Sodium naphthalene sulfonate condensed with | 3.0 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.0 g |
| | (tradename: NK.BX-C, manufactured by | |
| | TAKEMOTO OIL & FAT CO., LTD.) | |
| (5) | Clay | 71.44 g |

The above components are mixed and then pulverized by a centrifugal mill (a screen with a diameter of 1.0 mm) to obtain a wettable powder.

### Formulation Example 74

| | | | |
|---|---|---|---|
| (1) | Compound A1 | 2.24 | g |
| (2) | Compound (B10.1) | 15.13 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 76.63 | g |

The above components are mixed in the above mix ratio and then pulverized by a centrifugal mill (a screen with a diameter of 1.0 mm) to obtain a wettable powder.

### Formulation Example 75

| | | | |
|---|---|---|---|
| (1) | Compound A1 | 11.18 | g |
| (2) | Compound (B11.1) | 15.38 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 67.44 | g |

The above components are mixed and then pulverized by a centrifugal mill (a screen with a diameter of 1.0 mm) to obtain a wettable powder.

### Formulation Example 76

| | | | |
|---|---|---|---|
| (1) | Compound A1 | 0.45 | g |
| (2) | Compound (B11.1) | 0.62 | g |
| (3) | Polyoxyethylene tristyrylphenyl ether | 5.0 | g |
| | phosphoric acid ester (tradename: Soprophor | | |
| | 3D33, manufactured by Rhodia Nicca, Ltd.) | | |
| (4) | Polydimethyl siloxane | 0.1 | g |
| | (tradename: Rhodorsil antifoam 432, | | |
| | manufactured by Rhodia Nicca, Ltd.) | | |
| (5) | Propylene glycol | 5.0 | g |
| (6) | Water | 88.83 | g |

The above components are mixed and then subjected to wet milling to an average particle size of at most 5 μm to obtain a water-based suspension.

### Formulation Example 77

| | | | |
|---|---|---|---|
| (1) | Compound A1 | 1.52 | g |
| (2) | Compound C6 | 18.80 | g |
| (3) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.00 | g |
| | (tradename: Newkalgen BX-C, manufactured | | |
| | by TAKEMOTO OIL & FAT CO., LTD.) | | |
| (5) | White carbon | 15.00 | g |
| (6) | Kaoline | 58.68 | g |

Compound C6 is mixed with white carbon, and then the other components are mixed to obtain a wettable powder.

### Formulation Example 78

| | | | |
|---|---|---|---|
| (1) | Compound A1 | 4.56 | g |
| (2) | Compound C1 | 50.10 | g |
| (3) | Lavelin FA-N (tradename) | 3.00 | g |
| (4) | Newkalgen BX-C (tradename) | 3.00 | g |
| (5) | Kaoline | 39.34 | g |

The above components are mixed to obtain a wettable powder.

### Formulation Example 79

| | | |
|---|---|---|
| (1) | Compound A1 | 1.52 g |
| (2) | Compound C2 | 18.40 g |
| (3) | Sodium naphthalene sulfonate condensed with | 5.00 g |
| | formaldehyde (tradename: Newkalgen WG-2 | |
| | manufactured by TAKEMOTO OIL & FAT CO., | |
| | LTD.) | |
| (4) | Sodium alkylnaphthalene sulfonate | 3.00 g |
| | (tradename: Newkalgen WG-1, manufactured | |
| | by TAKEMOTO OIL & FAT CO., LTD.) | |
| (5) | White carbon | 15.00 g |
| (6) | Starch | 27.08 g |
| (7) | Calcium carbonate | 30.00 g |

Compound C2 is mixed with white carbon, and then the other components are mixed, and the mixture is kneaded with water. The kneaded product is granulated with a basket type extruder equipped with a screen having a diameter of 0.8 mm and dried for 30 minutes by a fluidized bed dryer set at 60° C. and then sieved (to from 14 to 60 mesh) to obtain water dispersible granules.

### Formulation Example 80

| | | |
|---|---|---|
| (1) | Bentonite containing 10 wt % of compound A1 | 3.05 g |
| (2) | Bentonite containing 10 wt % of compound C4 | 24.80 g |
| (3) | Newkalgen BX-C (tradename) | 3.00 g |
| (4) | Newkalgen WG-1 (tradename) | 3.00 g |
| (5) | Bentonite | 10.00 g |
| (6) | Calcium carbonate | 56.15 g |

The above components are mixed and kneaded with water. The kneaded product is granulated with a basket type extruder equipped with a screen having a diameter of 0.8 mm and dried for 30 minutes by a fluidized bed dryer set at 60° C. and then sieved (to from 14 to 60 mesh) to obtain granules.

### Formulation Example 81

| | | |
|---|---|---|
| (1) | Compound A1 | 3.05 g |
| (2) | Compound C3 | 21.80 g |
| (3) | Lavelin FA-N (tradename) | 3.00 g |
| (4) | Newkalgen BX-C (tradename) | 3.00 g |
| (5) | Kaoline | 69.15 g |

The above components are mixed to obtain a wettable powder.

### Formulation Example 82

| | | | |
|---|---|---|---|
| (1) | Compound A1 | 0.45 | g |
| (2) | Compound (D1.1) | 31.09 | g |
| (3) | Sodium naphthalene sulfonate condensed with | 5.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 60.46 | g |

The above components are mixed and then pulverized by a centrifugal mill (a screen with a diameter of 1.0 mm) to obtain a wettable powder.

### Formulation Example 83

| | | | |
|---|---|---|---|
| (1) | Compound A1 | 0.15 | g |
| (2) | Compound (D2.2) | 16.49 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | White carbon | 25.0 | g |
| (6) | Clay | 52.36 | g |

Oily molinate is absorbed in white carbon so that they are mixed, and the other components are mixed, and then the mixture is pulverized by a centrifugal mill (a screen with a diameter of 1.0 mm) to obtain a wettable powder.

### Formulation Example 84

| | | | |
|---|---|---|---|
| (1) | Compound A1 | 2.24 | g |
| (2) | Compound (D2.3) | 51.71 | g |
| (3) | Sodium naphthalene sulfonate condensed with | 3.0 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.0 | g |
| | (tradename: NK.BX-C, manufactured by | | |
| | TAKEMOTO OIL & FAT CO., LTD.) | | |
| (5) | Clay | 40.05 | g |

The above components are mixed in the above mix ratio and then pulverized by a centrifugal mill (a screen with a diameter of 1.0 mm) to obtain a wettable powder.

### Formulation Example 85

| | | | |
|---|---|---|---|
| (1) | Compound A1 (purity 98.4%) | 2.24 | g |
| (2) | Compound (B2.2) (purity 95.0%) | 7.05 | g |
| (3) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (4) | Sodium dialkylnaphthalene sulfonate | 3.00 | g |
| | (tradename: NK.BX-C, manufactured by | | |
| | TAKEMOTO OIL & FAT CO., LTD.) | | |
| (5) | Clay | 84.71 | g |

The above components are mixed in the above mix ratio and then pulverized by a centrifugal mill (a screen with a diameter of 1.0 mm) to obtain a wettable powder.

### Formulation Example 86

| | | | |
|---|---|---|---|
| (1) | Compound A1 (purity 98.4%) | 2.24 | g |
| (2) | Compound (B2.2) (purity 95.0%) | 7.05 | g |
| (3) | Polyoxyethylene styrylphenyl ether and | 15.00 | g |
| | calcium dodecylbenzenesulfonate (tradename: | | |
| | Sorpol 3661S, manufactured by TOHO Chemical | | |
| | Industry Co., Ltd.) | | |
| (4) | Aromatic hydrocarbon (tradename: Solvesso 150, | 35.71 | g |
| | manufactured by EXXON CHEMICAL) | | |
| (5) | N-methyl-2-pyrrolidone | 40.00 | g |

Compound A1 and compound (B2.2) are dissolved in N-methyl-2-pyrrolidone at room temperature, and then Solvesso 150 and Sorpol 3661S are mixed in the above mix ratio to obtain an emulsifiable concentrate.

### Formulation Example 87

| | | | |
|---|---|---|---|
| (1) | Compound A1 (purity 98.4%) | 0.45 | g |
| (2) | Compound (B8.1) (purity 97.0%) | 12.37 | g |
| (3) | Compound (B5.1) (purity 98.3%) | 9.16 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | White carbon | 7.00 | g |
| | (tradename: Carplex #80, manufactured | | |
| | by DSL. Japan Co., Ltd.) | | |
| (7) | Clay | 65.02 | g |

Compound (B8.1) is heated at 60° C. and mixed with white carbon, and then compound A1, compound (B5.1), sodium naphthalene sulfonate condensed with formaldehyde, sodium dialkylnaphthalene sulfonate and clay are mixed in the above mix ratio, and the mixture is pulverized by a centrifugal mill (a screen with a diameter of 1.0 mm) to obtain a wettable powder.

### Formulation Example 88

| | | | |
|---|---|---|---|
| (1) | Compound A1 (purity 98.4%) | 0.45 | g |
| (2) | Compound (B8.1) (purity 97.0%) | 12.37 | g |
| (3) | Compound (B4.3) (purity 95.8%) | 37.58 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | White carbon | 7.00 | g |
| | (tradename: Carplex #80, manufactured | | |
| | by DSL. Japan Co., Ltd.) | | |
| (7) | Clay | 36.60 | g |

Compound (B8.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 89

| | | | |
|---|---|---|---|
| (1) | Compound A1 (purity 98.4%) | 2.24 | g |
| (2) | Compound (B1.2) (purity 99.0%) | 0.61 | g |
| (3) | Compound (B5.1) (purity 98.3%) | 45.78 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | Clay | 45.37 | g |

The above components are mixed in the above mix ratio and then pulverized by a centrifugal mill (a screen with a diameter of 1.0 mm) to obtain a wettable powder.

### Formulation Example 90

| | | | |
|---|---|---|---|
| (1) | Compound A1 (purity 98.4%) | 2.24 | g |
| (2) | Compound (B1.2) (purity 99.0%) | 1.01 | g |
| (3) | Compound (B5.1) (purity 98.3%) | 45.78 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | Clay | 44.97 | g |

The above components are mixed in the above mix ratio and then pulverized by a centrifugal mill (a screen with a diameter of 1.0 mm) to obtain a wettable powder.

### Formulation Example 91

| | | | |
|---|---|---|---|
| (1) | Compound A1 (purity 98.4%) | 0.30 | g |
| (2) | Compound (B3.1) (purity 96.0%) | 8.33 | g |
| (3) | Compound (B8.1) (purity 97.0%) | 12.37 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | White carbon | 12.00 | g |
| | (tradename: Carplex #80, manufactured | | |
| | by DSL. Japan Co., Ltd.) | | |
| (7) | Clay | 61.00 | g |

Compound (B3.1) and compound (B8.1) are heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 92

| | | | |
|---|---|---|---|
| (1) | Compound A1 (purity 98.4%) | 0.30 | g |
| (2) | Compound (B3.1) (purity 96.0%) | 8.33 | g |
| (3) | Compound (B4.1) (purity 99.8%) | 4.01 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | White carbon | 5.00 | g |
| | (tradename: Carplex #80, manufactured | | |
| | by DSL. Japan Co., Ltd.) | | |
| (7) | Clay | 76.36 | g |

Compound (B3.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 93

| | | | |
|---|---|---|---|
| (1) | Compound A1 (purity 98.4%) | 0.30 | g |
| (2) | Compound (B3.1) (purity 96.0%) | 8.33 | g |
| (3) | Compound (B6.1) (purity 96.7%) | 20.68 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | White carbon | 5.00 | g |
| | (tradename: Carplex #80, manufactured | | |
| | by DSL. Japan Co., Ltd.) | | |
| (7) | Clay | 59.69 | g |

Compound (B3.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 94

| | | | |
|---|---|---|---|
| (1) | Compound A1 (purity 98.4%) | 0.30 | g |
| (2) | Compound (B9.1) (purity 98.4%) | 4.27 | g |
| (3) | Compound (B8.1) (purity 97.0%) | 12.37 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | White carbon | 7.00 | g |
| | (tradename: Carplex #80, manufactured | | |
| | by DSL. Japan Co., Ltd.) | | |
| (7) | Clay | 70.06 | g |

Compound (B8.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 95

| | | | |
|---|---|---|---|
| (1) | Compound A1 (purity 98.4%) | 1.52 | g |
| (2) | Compound (B9.1) (purity 98.4%) | 21.34 | g |
| (3) | Compound (B4.1) (purity 99.8%) | 20.04 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | Clay | 51.10 | g |

The above components are mixed in the above mix ratio and then pulverized by a centrifugal mill (a screen with a diameter of 1.0 mm) to obtain a wettable powder.

### Formulation Example 96

| | | | |
|---|---|---|---|
| (1) | Compound A1 (purity 98.4%) | 0.51 | g |
| (2) | Compound (B9.1) (purity 98.4%) | 7.11 | g |
| (3) | Compound (B6.1) (purity 96.7%) | 34.47 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | Clay | 51.91 | g |

The above components are mixed in the above mix ratio and then pulverized by a centrifugal mill (a screen with a diameter of 1.0 mm) to obtain a wettable powder.

### Formulation Example 97

| | | | |
|---|---|---|---|
| (1) | Compound A1 (purity 98.4%) | 0.30 | g |
| (2) | Compound (B3.2) (purity 95.0%) | 5.26 | g |
| (3) | Compound (B8.1) (purity 97.0%) | 12.37 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | White carbon | 7.00 | g |
| | (tradename: Carplex #80, manufactured | | |
| | by DSL. Japan Co., Ltd.) | | |
| (7) | Clay | 69.07 | g |

Compound (B8.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 98

| | | | |
|---|---|---|---|
| (1) | Compound A1 (purity 98.4%) | 1.52 | g |
| (2) | Compound (B3.2) (purity 95.0%) | 26.32 | g |
| (3) | Compound (B4.1) (purity 99.8%) | 20.04 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | Clay | 46.12 | g |

The above components are mixed in the above mix ratio and then pulverized by a centrifugal mill (a screen with a diameter of 1.0 mm) to obtain a wettable powder.

### Formulation Example 99

| | | | |
|---|---|---|---|
| (1) | Compound A1 (purity 98.4%) | 0.76 | g |
| (2) | Compound (B3.2) (purity 95.0%) | 13.16 | g |
| (3) | Compound (B6.1) (purity 96.7%) | 51.71 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | Clay | 28.37 | g |

The above components are mixed in the above mix ratio and then pulverized by a centrifugal mill (a screen with a diameter of 1.0 mm) to obtain a wettable powder.

### Formulation Example 100

| | | | |
|---|---|---|---|
| (1) | Compound A1 (purity 98.4%) | 0.30 | g |
| (2) | Compound (B2.3) (purity 96.0%) | 13.02 | g |
| (3) | Compound (B8.1) (purity 97.0%) | 12.37 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | White carbon | 7.00 | g |
| | (tradename: Carplex #80, manufactured | | |
| | by DSL. Japan Co., Ltd.) | | |
| (7) | Clay | 61.31 | g |

Compound (B8.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 101

| | | | |
|---|---|---|---|
| (1) | Compound A1 (purity 98.4%) | 0.76 | g |
| (2) | Compound (B2.3) (purity 96.0%) | 31.25 | g |
| (3) | Compound (B4.1) (purity 99.8%) | 10.02 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | Clay | 51.97 | g |

The above components are mixed in the above mix ratio and then pulverized by a centrifugal mill (a screen with a diameter of 1.0 mm) to obtain a wettable powder.

### Formulation Example 102

| | | | |
|---|---|---|---|
| (1) | Compound A1 (purity 98.4%) | 0.51 | g |
| (2) | Compound (B2.3) (purity 96.0%) | 20.83 | g |
| (3) | Compound (B6.1) (purity 96.7%) | 34.47 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | Clay | 38.19 | g |

The above components are mixed in the above mix ratio and then pulverized by a centrifugal mill (a screen with a diameter of 1.0 mm) to obtain a wettable powder.

### Formulation Example 103

| | | | |
|---|---|---|---|
| (1) | Compound A1 (purity 98.4%) | 0.30 | g |
| (2) | Compound (B10.1) (purity 98.4%) | 3.05 | g |
| (3) | Compound (B8.1) (purity 97.0%) | 12.37 | g |
| (4) | Sodium naphthalene sulfonate condensed with | 3.00 | g |
| | formaldehyde (tradename: Lavelin FA-N, | | |
| | manufactured by DAI-ICHI KOGYO SEIYAKU CO., | | |
| | LTD.) | | |
| (5) | Sodium dialkylnaphthalene sulfonate | 3.00 | g |
| | (tradename: NK.BX-C, manufactured by | | |
| | TAKEMOTO OIL & FAT CO., LTD.) | | |
| (6) | White carbon | 7.00 | g |
| | (tradename: Carplex #80, manufactured | | |
| | by DSL. Japan Co., Ltd.) | | |
| (7) | Clay | 71.28 | g |

Compound (B8.1) is heated at 60° C. and mixed with white carbon, and the other components are mixed in the above mix ratio, and then the mixture is pulverized by a centrifugal mill (a screen with a diameter of 1.0 mm) to obtain a wettable powder.

### Formulation Example 104

| | | |
|---|---|---|
| (1) | Compound A1 (purity 98.4%) | 1.52 g |
| (2) | Compound (B10.1) (purity 98.4%) | 15.24 g |
| (3) | Compound (B4.1) (purity 99.8%) | 20.04 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 57.20 g |

The above components are mixed in the above mix ratio and then pulverized by a centrifugal mill (a screen with a diameter of 1.0 mm) to obtain a wettable powder.

### Formulation Example 105

| | | |
|---|---|---|
| (1) | Compound A1 (purity 98.4%) | 0.76 g |
| (2) | Compound (B10.1) (purity 98.4%) | 7.62 g |
| (3) | Compound (B6.1) (purity 96.7%) | 51.71 g |
| (4) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (5) | Sodium dialkylnaphthalene sulfonate | 3.00 g |
| | (tradename: NK.BX-C, manufactured by | |
| | TAKEMOTO OIL & FAT CO., LTD.) | |
| (6) | Clay | 33.91 g |

The above components are mixed in the above mix ratio and then pulverized by a centrifugal mill (a screen with a diameter of 1.0 mm) to obtain a wettable powder.

### Formulation Example 106

| | | |
|---|---|---|
| (1) | Compound A1 (purity 98.4%) | 2.24 g |
| (2) | Compound (B1.6) (purity 95.0%) | 6.32 g |
| (3) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.00 g |
| | (tradename: NK.BX-C, manufactured by | |
| | TAKEMOTO OIL & FAT CO., LTD.) | |
| (5) | Clay | 85.44 g |

The above components are mixed in the above mix ratio and then pulverized by a centrifugal mill (a screen with a diameter of 1.0 mm) to obtain a wettable powder.

### Formulation Example 107

| | | |
|---|---|---|
| (1) | Compound A1 (purity 98.4%) | 0.45 g |
| (2) | Compound (B4.5) (purity 96.0%) | 20.83 g |
| (3) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.00 g |
| | (tradename: NK.BX-C, manufactured by | |
| | TAKEMOTO OIL & FAT CO., LTD.) | |
| (5) | Clay | 72.72 g |

The above components are mixed in the above mix ratio and then pulverized by a centrifugal mill (a screen with a diameter of 1.0 mm) to obtain a wettable powder.

### Formulation Example 108

| | | |
|---|---|---|
| (1) | Compound A1 (purity 98.4%) | 0.75 g |
| (2) | Compound (B4.6) (purity 96.0%) | 20.83 g |
| (3) | Sodium naphthalene sulfonate condensed with | 3.00 g |
| | formaldehyde (tradename: Lavelin FA-N, | |
| | manufactured by DAI-ICHI KOGYO SEIYAKU CO., | |
| | LTD.) | |
| (4) | Sodium dialkylnaphthalene sulfonate | 3.00 g |
| | (tradename: NK.BX-C, manufactured by | |
| | TAKEMOTO OIL & FAT CO., LTD.) | |
| (5) | Clay | 72.42 g |

The above components are mixed in the above mix ratio and then pulverized by a centrifugal mill (a screen with a diameter of 1.0 mm) to obtain a wettable powder.

Now, Test Examples of the present invention will be described.

### Test Example 1

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.0 to 2.5 leaf stage, wettable powders of compound A2 and compound (B1.1) were, respectively, diluted with water and applied under submerged condition so that the active ingredients became the prescribed amounts, respectively. The state of growth was visually observed 21 days after application, and the growth inhibition rate (%) evaluated in accordance with the following evaluation standard (observed value) and the growth inhibition rate (%) calculated by the above-mentioned Colby method (expected value) are shown in Table 1.

Growth inhibition rate (%)=0% (equivalent to the non-treated area) to 100% (complete kill)

TABLE 1

| | |
|---|---|
| Amount of | |
| application of | Growth inhibition |
| active | rate (%) |

| Compounds | ingredients (g/a) | Observed | Expected |
|---|---|---|---|
| A2 | 0.165 | 90 | — |
| | 0.11 | 90 | — |
| (B1.1) | 0.51 | 57 | — |
| | 0.26 | 47 | — |
| A2 + (B1.1) | 0.165 + 0.51 | 100 | 96 |
| | 0.165 + 0.26 | 100 | 95 |
| | 0.11 + 0.51 | 98 | 96 |
| | 0.11 + 0.26 | 99 | 95 |

### Test Example 2

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.0 to 2.5 leaf stage, wettable powders of compound A2 and compound (B2.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 2.

TABLE 2

| | |
|---|---|
| Amount of | |
| application of | Growth inhibition |
| active | rate (%) |

| Compounds | ingredients (g/a) | Observed | Expected |
|---|---|---|---|
| A2 | 0.165 | 90 | — |
| | 0.11 | 90 | — |
| (B2.1) | 0.45 | 80 | — |
| | 0.225 | 60 | — |
| A2 + (B2.1) | 0.165 + 0.45 | 100 | 98 |
| | 0.165 + 0.225 | 100 | 96 |
| | 0.11 + 0.45 | 100 | 98 |
| | 0.11 + 0.225 | 100 | 96 |

### Test Example 3

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.0 to 2.5 leaf stage, a wettable powder of compound A2 and an emulsifiable concentrate of compound (B3.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 3.

TABLE 3

| | |
|---|---|
| Amount of | |
| application of | Growth inhibition |
| active | rate (%) |

| Compounds | ingredients (g/a) | Observed | Expected |
|---|---|---|---|
| A2 | 0.165 | 90 | — |
| | 0.11 | 90 | — |
| (B3.1) | 2 | 33 | — |
| | 1 | 17 | — |
| A2 + (B3.1) | 0.165 + 2 | 100 | 93 |
| | 0.165 + 1 | 100 | 92 |
| | 0.11 + 2 | 100 | 93 |
| | 0.11 + 1 | 100 | 92 |

### Test Example 4

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.0 to 2.5 leaf stage, wettable powders of compound A2 and compound (B4.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 4.

TABLE 4

| | |
|---|---|
| Amount of | |
| application of | Growth inhibition |
| active | rate (%) |

| Compounds | ingredients (g/a) | Observed | Expected |
|---|---|---|---|
| A2 | 0.165 | 90 | — |
| | 0.11 | 90 | — |
| (B4.1) | 2 | 33 | — |
| | 1 | 13 | — |
| A2 + (B4.1) | 0.165 + 2 | 97 | 93 |
| | 0.165 + 1 | 99 | 91 |
| | 0.11 + 2 | 100 | 93 |
| | 0.11 + 1 | 98 | 92 |

### Test Example 5

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.0 to 2.5 leaf stage, a wettable powder of compound A2 and an oil-based suspension of compound (B4.2) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 5.

TABLE 5

| | |
|---|---|
| Amount of | |
| application of | Growth inhibition |
| active | rate (%) |

| Compounds | ingredients (g/a) | Observed | Expected |
|---|---|---|---|
| A2 | 0.165 | 90 | — |
| | 0.11 | 90 | — |
| (B4.2) | 0.5 | 0 | — |
| | 0.25 | 0 | — |
| A2 + (B4.2) | 0.165 + 0.5 | 100 | 90 |
| | 0.165 + 0.25 | 100 | 90 |
| | 0.11 + 0.5 | 98 | 90 |
| | 0.11 + 0.25 | 100 | 90 |

### Test Example 6

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.0 to 2.5 leaf stage, wettable powders of compound A2 and compound (B5.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 6.

TABLE 6

| | |
|---|---|
| Amount of | |
| application of | Growth |
| active | inhibition rate (%) |

| Compounds | ingredients (g/a) | Observed | Expected |
|---|---|---|---|
| A2 | 0.165 | 90 | — |
| | 0.11 | 90 | — |
| (B5.1) | 4.5 | 5 | — |
| | 2.25 | 2 | — |
| A2 + (B5.1) | 0.165 + 4.5 | 98 | 91 |
| | 0.165 + 2.25 | 100 | 90 |
| | 0.11 + 4.5 | 99 | 91 |
| | 0.11 + 2.25 | 100 | 90 |

### Test Example 7

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.0 to 2.5 leaf stage, wettable powders of compound A2 and compound (B6.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 7.

TABLE 7

| | |
|---|---|
| Amount of | |
| application of | Growth |
| active | inhibition rate (%) |

| Compounds | ingredients (g/a) | Observed | Expected |
|---|---|---|---|
| A2 | 0.165 | 90 | — |
| | 0.11 | 90 | — |
| (B6.1) | 10 | 10 | — |
| | 5 | 0 | — |
| A2 + (B6.1) | 0.165 + 10 | 100 | 91 |
| | 0.165 + 5 | 100 | 90 |
| | 0.11 + 10 | 100 | 91 |
| | 0.11 + 5 | 100 | 90 |

### Test Example 8

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.0 to 2.5 leaf stage, wettable powders of compound A2 and compound (B6.2) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 8.

TABLE 8

| | |
|---|---|
| Amount of | |
| application of | Growth |
| active | inhibition rate (%) |

| Compounds | ingredients (g/a) | Observed | Expected |
|---|---|---|---|
| A2 | 0.165 | 90 | — |
| | 0.11 | 90 | — |
| (B6.2) | 15 | 3 | — |
| | 7.5 | 3 | — |
| A2 + (B6.2) | 0.165 + 15 | 100 | 90 |
| | 0.165 + 7.5 | 99 | 90 |
| | 0.11 + 15 | 100 | 90 |
| | 0.11 + 7.5 | 100 | 90 |

### Test Example 9

Paddy field soil was put into a 1/10,000 are pot, and seeds of Japanese bulrush (Scirpus juncoides) were sown and left to stand under an irrigated condition with a water depth of 3.5 cm. When Japanese bulrush reached 2.3 to 2.6 leaf stage, a wettable powder of compound A2 and granules of compound (B7.1) were, respectively, diluted with water and applied under submerged condition so that the active ingredients became the prescribed amounts, respectively. The state of growth was visually observed 10 days after application, and evaluation and calculation were carried out in the same manner as in the above Test Example 1. The results are shown in Table 9.

TABLE 9

| | |
|---|---|
| Amount of | |
| application of | Growth |
| active | inhibition rate (%) |

| Compounds | ingredients (g/a) | Observed | Expected |
|---|---|---|---|
| A2 | 0.1 | 63 | — |
| | 0.05 | 40 | — |
| | 0.025 | 27 | — |
| (B7.1) | 16.5 | 13 | — |
| | 8.25 | 10 | — |
| | 4.13 | 10 | — |
| A2 + (B7.1) | 0.1 + 16.5 | 77 | 68 |
| | 0.1 + 8.25 | 75 | 67 |
| | 0.1 + 4.13 | 70 | 67 |
| | 0.05 + 16.5 | 73 | 48 |
| | 0.05 + 8.25 | 72 | 46 |
| | 0.05 + 4.13 | 72 | 46 |
| | 0.025 + 16.5 | 67 | 36 |
| | 0.025 + 8.25 | 62 | 34 |

### Test Example 10

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.0 to 2.5 leaf stage, a wettable powder of compound A2 and an emulsifiable concentrate of compound (B8.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 10.

TABLE 10

| | |
|---|---|
| Amount of | |
| application of | Growth |
| active | inhibition rate (%) |

| Compounds | ingredients (g/a) | Observed | Expected |
|---|---|---|---|
| A2 | 0.165 | 90 | — |
| | 0.11 | 90 | — |
| (B8.1) | 3 | 33 | — |
| | 1.5 | 10 | — |
| A2 + (B8.1) | 0.165 + 3 | 100 | 93 |
| | 0.165 + 1.5 | 100 | 91 |
| | 0.11 + 3 | 100 | 90 |
| | 0.11 + 1.5 | 100 | 90 |

### Test Example 11

Paddy field soil was put into a 1/10,000 are pot, and seeds of Japanese bulrush (Scirpus juncoides) were sown and left to stand under an irrigated condition with a water depth of 3.5 cm. When Japanese bulrush reached 2.3 to 2.6 leaf stage, a wettable powder of compound A2 and an emulsifiable concentrate of compound (B3.1) were, respectively, diluted with water and applied under submerged condition so that the active ingredients became the prescribed amounts, respectively. The state of growth was visually observed 10 days after application, and evaluation and calculation were carried out in the same manner as in the above Test Example 1. The results are shown in Table 11.

TABLE 11

| | |
|---|---|
| Amount of | |
| application of | Growth |
| active | inhibition rate (%) |

| Compounds | ingredients (g/a) | Observed | Expected |
|---|---|---|---|
| A2 | 0.1 | 63 | — |
| | 0.05 | 40 | — |
| | 0.025 | 27 | — |
| (B3.1) | 1 | 10 | — |
| | 0.5 | 3 | — |
| A2 + (B3.1) | 0.1 + 1 | 70 | 67 |
| | 0.1 + 0.5 | 70 | 65 |
| | 0.05 + 1 | 73 | 46 |
| | 0.05 + 0.5 | 60 | 42 |
| | 0.025 + 1 | 67 | 34 |

### Test Example 12

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.5 to 3.0 leaf stage, wettable powders of compound A2 and compound (B1.2) were, respectively, diluted with water and applied under submerged condition so that the active ingredients became the prescribed amounts, respectively. The state of growth was visually observed 22 days after application, and evaluation and calculation were carried out in the same manner as in the above Test Example 1. The results are shown in Table 12.

TABLE 12

| | |
|---|---|
| Amount of | |
| application of | Growth |
| active | inhibition rate (%) |

| Compounds | ingredients (g/a) | Observed | Expected |
|---|---|---|---|
| A2 | 0.165 | 89 | — |
| | 0.11 | 83 | — |
| | 0.083 | 67 | — |
| (B1.2) | 0.045 | 53 | — |
| | 0.023 | 0 | — |
| A2 + (B1.2) | 0.165 + 0.045 | 99 | 95 |
| | 0.165 + 0.023 | 90 | 89 |
| | 0.11 + 0.045 | 96 | 92 |
| | 0.11 + 0.023 | 93 | 83 |
| | 0.083 + 0.045 | 91 | 84 |
| | 0.083 + 0.023 | 94 | 67 |

### Test Example 13

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.5 to 3.0 leaf stage, wettable powders of compound A2 and compound (B1.3) were, respectively, diluted with water and applied under submerged condition so that the active ingredients became the prescribed amounts, respectively. The state of growth was visually observed 22 days after application, and evaluation and calculation were carried out in the same manner as in the above Test Example 1. The results are shown in Table 13.

TABLE 13

| | |
|---|---|
| Amount of | |
| application of | Growth |
| active | inhibition rate (%) |

| Compounds | ingredients (g/a) | Observed | Expected |
|---|---|---|---|
| A2 | 0.165 | 89 | — |
| | 0.11 | 83 | — |
| | 0.083 | 67 | — |
| (B1.3) | 0.158 | 70 | — |
| | 0.079 | 50 | — |
| A2 + (B1.3) | 0.165 + 0.158 | 99 | 97 |
| | 0.165 + 0.079 | 100 | 94 |
| | 0.11 + 0.158 | 97 | 95 |
| | 0.11 + 0.079 | 93 | 92 |
| | 0.083 + 0.158 | 96 | 90 |
| | 0.083 + 0.079 | 88 | 83 |

### Test Example 14

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.5 to 3.0 leaf stage, wettable powders of compound A2 and compound (B1.4) were, respectively, diluted with water and applied under submerged condition so that the active ingredients became the prescribed amounts, respectively. The state of growth was visually observed 22 days after application, and evaluation and calculation were carried out in the same manner as in the above Test Example 1. The results are shown in Table 14.

TABLE 14

| | |
|---|---|
| Amount of | |
| application of | Growth |
| active | inhibition rate (%) |

| Compounds | ingredients (g/a) | Observed | Expected |
|---|---|---|---|
| A2 | 0.165 | 89 | — |
| | 0.11 | 83 | — |
| | 0.083 | 67 | — |
| (B1.4) | 0.675 | 57 | — |
| | 0.338 | 53 | — |
| A2 + (B1.4) | 0.165 + 0.338 | 96 | 95 |
| | 0.11 + 0.338 | 96 | 92 |
| | 0.083 + 0.675 | 92 | 86 |
| | 0.083 + 0.338 | 88 | 84 |

### Test Example 15

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.5 to 3.0 leaf stage, a wettable powder of compound A2 and water dispersible granules of compound (B1.5) were, respectively, diluted with water and applied under submerged condition so that the active ingredients became the prescribed amounts, respectively. The state of growth was visually observed 22 days after application, and evaluation and calculation were carried out in the same manner as in the above Test Example 1. The results are shown in Table 15.

TABLE 15

| | |
|---|---|
| Amount of | |
| application of | Growth |
| active | inhibition rate (%) |

| Compounds | ingredients (g/a) | Observed | Expected |
|---|---|---|---|
| A2 | 0.165 | 89 | — |
| | 0.11 | 83 | — |
| | 0.083 | 67 | — |
| (B1.5) | 0.158 | 3 | — |
| | 0.079 | 0 | — |
| A2 + (B1.5) | 0.165 + 0.158 | 97 | 89 |
| | 0.165 + 0.079 | 94 | 89 |
| | 0.11 + 0.158 | 97 | 93 |
| | 0.11 + 0.079 | 94 | 92 |
| | 0.083 + 0.158 | 99 | 68 |
| | 0.083 + 0.079 | 88 | 67 |

### Test Example 16

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.5 to 3.0 leaf stage, wettable powders of compound A2 and compound (B4.3) were, respectively, diluted with water and applied under submerged condition so that the active ingredients became the prescribed amounts, respectively. The state of growth was visually observed 22 days after application, and evaluation and calculation were carried out in the same manner as in the above Test Example 1. The results are shown in Table 16.

TABLE 16

| | |
|---|---|
| Amount of | |
| application of | |
| active | Growth inhibition rate (%) |

| Compounds | ingredients (g/a) | Observed | Expected |
|---|---|---|---|
| A2 | 0.165 | 89 | — |
| | 0.11 | 83 | — |
| | 0.083 | 67 | — |
| (B4.3) | 11.25 | 10 | — |
| | 5.63 | 0 | — |
| A2 + (B4.3) | 0.165 + 11.25 | 97 | 90 |
| | 0.165 + 5.63 | 90 | 89 |
| | 0.11 + 11.25 | 96 | 85 |
| | 0.11 + 5.63 | 92 | 83 |
| | 0.083 + 11.25 | 94 | 70 |
| | 0.083 + 5.63 | 92 | 67 |

### Test Example 17

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.1 to 3.2 leaf stage, wettable powders of compound A2 and compound (B9.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 17.

TABLE 17

| | |
|---|---|
| Amount of | |
| application of | |
| active | Growth inhibition rate (%) |

| Compounds | ingredients (g/a) | Observed | Expected |
|---|---|---|---|
| A2 | 0.165 | 96 | — |
| | 0.11 | 92 | — |
| | 0.083 | 90 | — |
| (B9.1) | 0.788 | 57 | — |
| A2 + (B9.1) | 0.165 + 0.788 | 100 | 98 |
| | 0.11 + 0.788 | 100 | 96 |
| | 0.083 + 0.788 | 99 | 96 |

### Test Example 18

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.1 to 3.2 leaf stage, wettable powders of compound A2 and compound (B10.1) were, respectively, diluted with water and applied under submerged condition so that the active ingredients became the prescribed amounts, respectively. The state of growth was visually observed 22 days after application, and evaluation and calculation were carried out in the same manner as in the above Test Example 1. The results are shown in Table 18.

TABLE 18

| | Amount of | | |
|---|---|---|---|
| | application of | | |
| | active | Growth inhibition rate (%) | |
| Compounds | ingredients (g/a) | Observed | Expected |
| A2 | 0.165 | 96 | — |
| | 0.11 | 92 | — |
| | 0.083 | 90 | — |
| (B10.1) | 0.563 | 40 | — |
| A2 + (B10.1) | 0.165 + 0.563 | 100 | 98 |
| | 0.11 + 0.563 | 98 | 95 |
| | 0.083 + 0.563 | 99 | 94 |

### Test Example 19

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.1 to 3.2 leaf stage, wettable powders of compound A2 and compound (B4.4) were, respectively, diluted with water and applied under submerged condition so that the active ingredients became the prescribed amounts, respectively. The state of growth was visually observed 22 days after application, and evaluation and calculation were carried out in the same manner as in the above Test Example 1. The results are shown in Table 19.

TABLE 19

| | |
|---|---|
| Amount of | |
| application of | |
| active | Growth inhibition rate (%) |

| Compounds | ingredients (g/a) | Observed | Expected |
|---|---|---|---|
| A2 | 0.165 | 96 | — |
| | 0.11 | 92 | — |
| | 0.083 | 90 | — |
| (B4.4) | 2.25 | 13 | — |
| | 1.125 | 13 | — |
| A2 + | 0.165 + 2.25 | 99 | 97 |
| (B4.4) | 0.165 + 1.125 | 100 | 97 |
| | 0.11 + 2.25 | 100 | 99 |
| | 0.11 + 1.125 | 100 | 99 |
| | 0.083 + 2.25 | 92 | 91 |
| | 0.083 + 1.125 | 95 | 91 |

### Test Example 20

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 1.0 to 3.0 leaf stage, wettable powders of compound A1 and compound (B5.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 20.

TABLE 20

| | |
|---|---|
| Amount of | |
| application of | |
| active | Growth inhibition rate (%) |

| Compounds | ingredients (g/a) | Observed | Expected |
|---|---|---|---|
| A1 | 0.165 | 98 | — |
| | 0.11 | 97 | — |
| | 0.083 | 83 | — |
| (B5.1) | 3.38 | 10 | — |
| | 1.69 | 3 | — |
| A1 + (B5.1) | 0.165 + 3.38 | 100 | 98 |
| | 0.165 + 1.69 | 100 | 98 |
| | 0.11 + 3.38 | 100 | 98 |
| | 0.11 + 1.69 | 100 | 97 |
| | 0.083 + 3.38 | 100 | 85 |
| | 0.083 + 1.69 | 100 | 84 |

### Test Example 21

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.8 to 3.2 leaf stage, wettable powders of compound A2 and compound (B9.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 21.

TABLE 21

| | |
|---|---|
| Amount of | |
| application of | |
| active | Growth inhibition rate (%) |

| Compounds | ingredients (g/a) | Observed | Expected |
|---|---|---|---|
| A2 | 0.11 | 75 | — |
| | 0.083 | 65 | — |
| | 0.055 | 55 | — |
| (B9.1) | 1.05 | 10 | — |
| | 0.525 | 2 | — |
| A2 + (B9.1) | 0.11 + 1.05 | 92 | 78 |
| | 0.11 + 0.525 | 83 | 75 |
| | 0.083 + 1.05 | 88 | 69 |
| | 0.083 + 0.525 | 85 | 66 |
| | 0.055 + 1.05 | 80 | 60 |
| | 0.055 + 0.525 | 70 | 56 |

### Test Example 22

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.8 to 3.2 leaf stage, wettable powders of compound A2 and compound (B10.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 22.

TABLE 22

| | Amount of | | |
|---|---|---|---|
| | application of | | |
| | active | Growth inhibition rate (%) | |
| Compounds | ingredients (g/a) | Observed | Expected |
| A2 | 0.11 | 75 | — |
| | 0.083 | 65 | — |
| | 0.055 | 55 | — |
| (B10.1) | 0.75 | 13 | — |
| | 0.375 | 0 | — |
| A2 + (B10.1) | 0.11 + 0.75 | 88 | 78 |
| | 0.11 + 0.375 | 85 | 75 |
| | 0.083 + 0.75 | 83 | 70 |
| | 0.083 + 0.375 | 87 | 65 |
| | 0.055 + 0.75 | 80 | 61 |
| | 0.055 + 0.375 | 70 | 55 |

### Test Example 23

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.8 to 3.2 leaf stage, wettable powders of compound A2 and compound (B3.2) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 23.

TABLE 23

| | |
|---|---|
| Amount of | |
| application of | |
| active | Growth inhibition rate (%) |

| Compounds | ingredients (g/a) | Observed | Expected |
|---|---|---|---|
| A2 | 0.11 | 75 | — |
| | 0.083 | 65 | — |
| (B3.2) | 1.875 | 27 | — |
| | 0.938 | 5 | — |
| A2 + (B3.2) | 0.11 + 1.875 | 88 | 82 |
| | 0.11 + 0.938 | 88 | 76 |
| | 0.083 + 1.875 | 77 | 74 |
| | 0.083 + 0.938 | 73 | 67 |

### Test Example 24

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 3.0 to 3.3 leaf stage, a wettable powder of compound A2 and a water-based suspension of compound (B11.1) were, respectively, diluted with water in an amount of 1,000 liter/ha, followed by foliar application with a small sprayer. The state of growth was visually observed 21 days after application, and evaluation and calculation were carried out in the same manner as in the above Test Example 1. The results are shown in Table 24.

TABLE 24

| | Amount of | | |
|---|---|---|---|
| | application of | | |
| | active | Growth inhibition rate (%) | |
| Compounds | ingredients (g/a) | Observed | Expected |
| A2 | 0.165 | 60 | — |
| | 0.11 | 50 | — |
| | 0.083 | 23 | — |
| (B11.1) | 0.188 | 80 | — |
| | 0.094 | 47 | — |
| | 0.047 | 10 | — |
| A2 + (B11.1) | 0.165 + 0.188 | 99 | 92 |
| | 0.165 + 0.094 | 94 | 79 |
| | 0.165 + 0.047 | 80 | 64 |
| | 0.11 + 0.188 | 100 | 90 |
| | 0.11 + 0.094 | 85 | 73 |
| | 0.11 + 0.047 | 68 | 55 |
| | 0.083 + 0.188 | 88 | 85 |
| | 0.083 + 0.094 | 75 | 59 |
| | 0.083 + 0.047 | 37 | 31 |

### Test Example 25

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 3.0 to 3.3 leaf stage, wettable powders of compound A1 and compound (B1.2) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 25.

TABLE 25

| | |
|---|---|
| Amount of | |
| application of | |
| active | Growth inhibition rate (%) |

| Compounds | ingredients (g/a) | Observed | Expected |
|---|---|---|---|
| A1 | 0.165 | 75 | — |
| | 0.11 | 60 | — |
| | 0.083 | 43 | |
| (B1.2) | 0.045 | 7 | — |
| | 0.023 | 0 | — |
| A1 + (B1.2) | 0.165 + 0.045 | 82 | 77 |
| | 0.165 + 0.023 | 77 | 75 |
| | 0.11 + 0.045 | 65 | 63 |
| | 0.11 + 0.023 | 62 | 60 |
| | 0.083 + 0.045 | 57 | 47 |
| | 0.083 + 0.023 | 45 | 43 |

### Test Example 26

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 3.0 to 3.3 leaf stage, a wettable powder of compound A1 and an emulsifiable concentrate of compound (B8.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 26.

TABLE 26

| | |
|---|---|
| Amount of | |
| application of | |
| active | Growth inhibition rate (%) |

| Compounds | ingredients (g/a) | Observed | Expected |
|---|---|---|---|
| A1 | 0.165 | 75 | — |
| | 0.11 | 60 | — |
| | 0.083 | 43 | — |
| (B8.1) | 3.0 | 0 | — |
| | 1.5 | 0 | — |
| A1 + (B8.1) | 0.165 + 1.5 | 77 | 75 |
| | 0.11 + 3.0 | 77 | 60 |
| | 0.11 + 1.5 | 70 | 60 |
| | 0.083 + 3.0 | 47 | 43 |
| | 0.083 + 1.5 | 45 | 43 |

### Test Example 27

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 3.0 to 3.3 leaf stage, a wettable powder of compound A1 and granules of compound (B7.1) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 27.

TABLE 27

| | |
|---|---|
| Amount of | |
| application of | Growth inhibition |
| active | rate (%) |

| Compounds | ingredients (g/a) | Observed | Expected |
|---|---|---|---|
| A1 | 0.165 | 75 | — |
| | 0.11 | 60 | — |
| (B7.1) | 44 | 0 | — |
| | 33 | 0 | — |
| A1 + (B7.1) | 0.165 + 44 | 80 | 75 |
| | 0.165 + 33 | 80 | 75 |
| | 0.11 + 44 | 70 | 60 |

### Test Example 28

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 3.0 to 3.3 leaf stage, wettable powders of compound A1 and compound (B1.3) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 28.

TABLE 28

| | |
|---|---|
| Amount of | |
| application of | Growth inhibition |
| active | rate (%) |

| Compounds | ingredients (g/a) | Observed | Expected |
|---|---|---|---|
| A1 | 0.083 | 43 | — |
| (B1.3) | 0.158 | 37 | — |
| | 0.079 | 20 | — |
| A1 + (B1.3) | 0.083 + 0.158 | 75 | 64 |
| | 0.083 + 0.079 | 65 | 55 |

### Test Example 29

Paddy field soil was put into a 1/10,000 are pot, and tubers of flatsedge (Cyperus serotinus) were planted and left to stand under an irrigated condition with a water depth of 3.5 cm. When flatsedge reached 2.8 to 3.2 leaf stage, wettable powders of compound A2 and compound (B1.2) were, respectively, diluted with water and applied under submerged condition so that the active ingredients became the prescribed amounts, respectively. The state of growth was visually observed 29 days after application, and evaluation and calculation were carried out in the same manner as in the above Test Example 1. The results are shown in Table 29.

TABLE 29

| | |
|---|---|
| Amount of | |
| application of | Growth inhibition |
| active | rate (%) |

| Compounds | ingredients (g/a) | Observed | Expected |
|---|---|---|---|
| A2 | 0.0275 | 0 | — |
| (B1.2) | 0.0188 | 58 | — |
| | 0.015 | 33 | — |
| | 0.0125 | 20 | — |
| A2 + (B1.2) | 0.0275 + 0.0188 | 78 | 58 |
| | 0.0275 + 0.015 | 60 | 33 |
| | 0.0275 + 0.0125 | 50 | 20 |

### Test Example 30

Paddy field soil was put into a 1/1,700 are pot, and mixed seeds of false pimpernel (Lindernia pyxidaria), abunome (Dopatrium junceum), long stem waterwort (Elatine triandra SCHK.) and toothcup (Rotala india) were sown and left to stand under an irrigated condition with a water depth of 3.5 cm. When false pimpernel reached one leaf-pair stage, wettable powders of compound A2 and compound (B1.2) were, respectively, diluted with water and applied under submerged condition so that the active ingredients became the prescribed amounts, respectively. The state of growth was visually observed 21 days after application, and evaluation and calculation were carried out in the same manner as in the above Test Example 1. The results are shown in Table 30.

TABLE 30

| | |
|---|---|
| Amount of | |
| application of | Growth inhibition |
| active | rate (%) |

| Compounds | ingredients (g/a) | Observed | Expected |
|---|---|---|---|
| A2 | 0.22 | 90 | — |
| (B1.2) | 0.12 | 60 | — |
| A2 + (B1.2) | 0.22 + 0.12 | 100 | 96 |

### Test Example 31

Paddy field soil was put into a 1/1,700 are pot, and mixed seeds of false pimpernel (Lindernia pyxidaria), abunome (Dopatrium junceum), long stem waterwort (Elatine triandra SCHK.) and toothcup (Rotala india) were sown and left to stand under an irrigated condition with a water depth of 3.5 cm. When false pimpernel reached two leaf-pair stage, a wettable powder of compound A2 and an emulsifiable concentrate of compound (B8.1) were, respectively, diluted with water and applied under submerged condition so that the active ingredients became the prescribed amounts, respectively. The state of growth was visually observed 22 days after application, and evaluation and calculation were carried out in the same manner as in the above Test Example 1. The results are shown in Table 31.

TABLE 31

| | |
|---|---|
| Amount of | |
| application of | Growth inhibition |
| active | rate (%) |

| Compounds | ingredients (g/a) | Observed | Expected |
|---|---|---|---|
| A2 | 0.22 | 65 | — |
| (B8.1) | 12 | 70 | — |
| A2 + (B8.1) | 0.22 + 12 | 100 | 90 |

### Test Example 32

Paddy field soil was put into a 1/3,000 are pot, and tubers of flatsedge (Cyperus serotinus) were planted and left to stand under an irrigated condition with a water depth of 3.5 cm. When flatsedge reached 4 leaf stage, a wettable powder of compound A2 and an emulsifiable concentrate of compound C4 were, respectively, diluted with water and applied under submerged condition so that the active ingredients became the prescribed amounts, respectively. The state of growth was visually observed 21 days after application, and the growth inhibition rate (%) evaluated in the same manner as in the above Test Example 1 (observed value) and the growth inhibition rate (%) calculated by the above-mentioned Colby method (expected value) are shown in Table 32.

TABLE 32

| | |
|---|---|
| Amount of | |
| application of | Growth inhibition |
| active | rate (%) |

| Compounds | ingredients (g/a) | Observed | Expected |
|---|---|---|---|
| A2 | 0.4 | 50 | — |
| | 0.2 | 20 | — |
| C4 | 2.4 | 57 | — |
| | 2.0 | 33 | — |
| A2 + C4 | 0.4 + 2.0 | 75 | 67 |
| | 0.2 + 2.4 | 89 | 66 |
| | 0.2 + 2.0 | 57 | 46 |

### Test Example 33

Paddy field soil was put into a 1/10,000 are pot, and seeds of Japanese bulrush (Scirpus juncoides) were sown and left to stand under an irrigated condition with a water depth of 3.5 cm. When Japanese bulrush reached 2 leaf stage, wettable powders of compound A2, C2 and C4 and granules of compound C6 were, respectively, diluted with water and applied under submerged condition so that the active ingredients became the prescribed amounts, respectively. The state of growth was visually observed 19 days after application, and the growth inhibition rate (%) evaluated in the same manner as in the above Test Example 1 (observed value) and the growth inhibition rate (%) calculated by the above-mentioned Colby method (expected value) are shown in Tables 33, 34 and 35.

TABLE 33

| | |
|---|---|
| Amount of | |
| application of | Growth inhibition |
| active | rate (%) |

| Compounds | ingredients (g/a) | Observed | Expected |
|---|---|---|---|
| A2 | 0.05 | 70 | — |
| | 0.025 | 43 | — |
| C2 | 2.0 | 35 | — |
| | 1.0 | 23 | — |
| | 0.5 | 13 | — |
| A2 + C2 | 0.05 + 2.0 | 89 | 81 |
| | 0.05 + 1.0 | 82 | 77 |
| | 0.05 + 0.5 | 85 | 74 |
| | 0.025 + 2.0 | 80 | 63 |
| | 0.025 + 1.0 | 68 | 57 |
| | 0.025 + 0.5 | 53 | 51 |

TABLE 34

| | |
|---|---|
| Amount of | |
| application of | Growth inhibition |
| active | rate (%) |

| Compounds | ingredients (g/a) | Observed | Expected |
|---|---|---|---|
| A2 | 0.05 | 70 | — |
| | 0.025 | 43 | — |
| C4 | 2.0 | 55 | — |
| | 1.0 | 27 | — |
| | 0.5 | 10 | — |
| A2 + C4 | 0.05 + 2.0 | 88 | 87 |
| | 0.05 + 1.0 | 87 | 78 |
| | 0.05 + 0.5 | 88 | 73 |
| | 0.025 + 2.0 | 82 | 75 |
| | 0.025 + 1.0 | 75 | 58 |
| | 0.025 + 0.5 | 53 | 49 |

TABLE 35

| | |
|---|---|
| Amount of | |
| application of | Growth inhibition |
| active | rate (%) |

| Compounds | ingredients (g/a) | Observed | Expected |
|---|---|---|---|
| A2 | 0.05 | 70 | — |
| | 0.025 | 43 | — |
| C6 | 2.0 | 53 | — |
| | 1.0 | 33 | — |
| | 0.5 | 23 | — |
| A2 + C6 | 0.05 + 2.0 | 87 | 86 |
| | 0.05 + 1.0 | 85 | 80 |
| | 0.05 + 0.5 | 84 | 77 |
| | 0.025 + 2.0 | 81 | 74 |
| | 0.025 + 1.0 | 75 | 62 |
| | 0.025 + 0.5 | 60 | 57 |

### Test Example 34

Paddy field soil was put into a 1/10,000 are pot, and seeds of Japanese bulrush (Scirpus juncoides) were sown and left to stand under an irrigated condition with a water depth of 3.5 cm. When Japanese bulrush reached 2 leaf stage, wettable powders of compound A2, C2 and C4 and granules of compound C6 were, respectively, diluted with water and applied under submerged condition so that the active ingredients became the prescribed amounts, respectively. The state of growth was visually observed 19 days after application, and the growth inhibition rate (%) evaluated in the same manner as in the above Test Example 1 (observed value) and the growth inhibition rate (%) calculated by the above-mentioned Colby method (expected value) are shown in Tables 36, 37 and 38.

TABLE 36

| | |
|---|---|
| Amount of | |
| application of | Growth inhibition |
| active | rate (%) |

| Compounds | ingredients (g/a) | Observed | Expected |
|---|---|---|---|
| A2 | 1.5 | 87 | — |
| | 0.167 | 79 | — |
| | 0.125 | 50 | — |
| C2 | 10 | 68 | — |
| | 3.75 | 45 | — |
| | 1.5 | 20 | — |
| A2 + C2 | 1.5 + 3.75 | 94 | 93 |
| | 1.5 + 1.5 | 93 | 89 |
| | 0.167 + 10 | 94 | 93 |
| | 0.125 + 10 | 91 | 84 |

TABLE 37

| | |
|---|---|
| Amount of | |
| application of | Growth inhibition |
| active | rate (%) |

| Compounds | ingredients (g/a) | Observed | Expected |
|---|---|---|---|
| A2 | 1.5 | 87 | — |
| | 0.167 | 79 | — |
| | 0.125 | 50 | — |
| C4 | 10 | 68 | — |
| | 1.5 | 20 | — |
| A2 + C4 | 1.5 + 1.5 | 88 | 87 |
| | 0.167 + 10 | 94 | 92 |
| | 0.125 + 10 | 91 | 80 |

TABLE 38

| | |
|---|---|
| Amount of | |
| application of | Growth inhibition |
| active | rate (%) |

| Compounds | ingredients (g/a) | Observed | Expected |
|---|---|---|---|
| A2 | 1.5 | 87 | — |
| | 0.167 | 79 | — |
| | 0.125 | 50 | — |
| C6 | 10 | 68 | — |
| | 3.75 | 45 | — |
| | 1.5 | 20 | — |
| A2 + C6 | 1.5 + 3.75 | 88 | 87 |
| | 1.5 + 1.5 | 88 | 87 |
| | 0.167 + 10 | 82 | 81 |
| | 0.125 + 10 | 65 | 53 |

### Test Example 35

Paddy field soil was put into a 1/500,000 hectare pot, harrowed and irrigated with a depth of 3 cm. On the next day, rice (Oryza sativa var. Nihonbare) at 2 leaf stage was implanted with a depth of 3 cm. A wettable powder of compound A2 and a wettable powder of compound D were, respectively, diluted with water and applied under submerged condition 5 days after implantation so that the active ingredients became the prescribed amounts, respectively. The state of growth of rice was visually observed 7 days and 21 days after application, and the growth inhibition rate (%) was evaluated in the same is manner as in the above Test Example 1. The results (average of continuous six times) are shown in Table 39.

TABLE 39

| | |
|---|---|
| Compound A2 | Compound D |

| | | |
|---|---|---|
| amount of | Amount of | |
| application of | application | Growth inhibition |
| active | of active | rate (%) |
| ingredient | ingredient | (average) |

| (g/ha) | Types | (g/ha) | 7 days | 21 days |
|---|---|---|---|---|
| 60 | (D1.1) | 600 | 2 | 10 |
| | (D2.1) | | 5 | 10 |
| | (D2.2) | | 7 | 17 |
| | (D2.3) | | 3 | 5 |
| | (Not | — | 23 | 33 |
| | applied) | | | |

### Test Example 36

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 3 leaf stage, wettable powders of compound A2 and compound (D1.1) were, respectively, diluted with water and applied under submerged condition so that the active ingredients became the prescribed amounts, respectively. The state of growth was visually observed 22 days after application, and the growth inhibition rate (%) evaluated in the same manner as in the above Test Example 1 (observed value) and the growth inhibition rate (%) calculated by the above-mentioned Colby method (expected value) are shown in Tables 40.

TABLE 40

| | |
|---|---|
| Amount of | |
| application of | Growth inhibition |
| active ingredients | rate (%) |

| Compounds | (g/ha) | Observed | Expected |
|---|---|---|---|
| A2 | 16.5 | 89 | — |
| | 11 | 83 | — |
| | 8.3 | 67 | — |
| (D1.1) | 1,125 | 10 | — |
| | 563 | 0 | — |
| A2 + (D1.1) | 16.5 + 1,125 | 99 | 90 |
| | 16.5 + 563 | 90 | 89 |
| | 11 + 1,125 | 89 | 85 |
| | 11 + 563 | 85 | 83 |
| | 8.3 + 1,125 | 87 | 70 |
| | 8.3 + 563 | 87 | 67 |

### Test Example 37

Paddy field soil was put into a 1/10,000 are pot, and seeds of Japanese bulrush (Scirpus juncoides) were sown and left to stand under an irrigated condition with a water depth of 3.5 cm. When Japanese bulrush reached 3 leaf stage, wettable powders of compound A2 and compound (D2.2) were, respectively, diluted with water and applied under submerged condition so that the active ingredients became the prescribed amounts, respectively. The state of growth was visually observed 19 days after application, and the growth inhibition rate (%) evaluated in the same manner as in the above Test Example 1 (observed value) and the growth inhibition rate (%) calculated by the above-mentioned Colby method (expected value) are shown in Tables 41.

TABLE 41

| | |
|---|---|
| Amount of | |
| application of | Growth inhibition |
| active ingredients | rate (%) |

| Compounds | (g/ha) | Observed | Expected |
|---|---|---|---|
| A2 | 8.3 | 70 | — |
| (D2.2) | 1,800 | 60 | — |
| | 900 | 60 | — |
| A2 + (D2.2) | 8.3 + 1,800 | 90 | 88 |
| | 8.3 + 900 | 89 | 88 |

### Test Example 38

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 3 leaf stage, wettable powders of compound A2 and compound (D2.3) were, respectively, diluted with water and applied under submerged condition so that the active ingredients became the prescribed amounts, respectively. The state of growth was visually observed 22 days after application, and the growth inhibition rate (%) evaluated in the same manner as in the above Test Example 1 (observed value) and the growth inhibition rate (%) calculated by the above-mentioned Colby method (expected value) are shown in Tables 42.

TABLE 42

| | |
|---|---|
| Amount of | |
| application of | Growth inhibition |
| active ingredients | rate (%) |

| Compounds | (g/ha) | Observed | Expected |
|---|---|---|---|
| A2 | 16.5 | 98 | — |
| | 11 | 96 | — |
| | 8.3 | 83 | — |
| (D2.3) | 375 | 7 | — |
| | 188 | 3 | — |
| A2 + (D2.3) | 16.5 + 375 | 99 | 98 |
| | 16.5 + 188 | 100 | 98 |
| | 11 + 375 | 97 | 96 |
| | 11 + 188 | 99 | 96 |
| | 8.3 + 375 | 92 | 84 |
| | 8.3 + 188 | 99 | 84 |

### Test Example 39

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.8 to 3.2 leaf stage, a wettable powder of compound A2 and an emulsifiable concentrate of compound (B2.2) were, respectively, diluted with water and applied under submerged condition so that the active ingredients became the prescribed amounts, respectively. The state of growth was visually observed 21 days after application, and the growth inhibition rate (%) evaluated in the same manner as in the above Test Example 1 (observed value) and the growth inhibition rate (%) calculated by the above-mentioned Colby method (expected value) are shown in Tables 43.

TABLE 43

| | |
|---|---|
| Amount of | |
| application of | Growth inhibition |
| active | rate (%) |

| Compounds | ingredients (g/a) | Observed | Expected |
|---|---|---|---|
| A2 | 0.11 | 70 | — |
| | 0.083 | 55 | — |
| (B2.2) | 0.335 | 68 | — |
| | 0.25 | 60 | — |
| A2 + (B2.2) | 0.11 + 0.25 | 89 | 88 |
| | 0.083 + 0.335 | 88 | 85 |
| | 0.083 + 0.25 | 85 | 82 |

### Test Example 40

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.8 to 3.2 leaf stage, a wettable powder of compound A1 and an emulsifiable concentrate of compound (B2.2) were, respectively, diluted with water and applied under submerged condition so that the active ingredients became the prescribed amounts, respectively. The state of growth was visually observed 21 days after application, and the growth inhibition rate (%) evaluated in the same manner as in the above Test Example 1 (observed value) and the growth inhibition rate (%) calculated by the above-mentioned Colby method (expected value) are shown in Tables 44.

TABLE 44

| | |
|---|---|
| Amount of | |
| application of | Growth inhibition |
| active | rate (%) |

| Compounds | ingredients (g/a) | Observed | Expected |
|---|---|---|---|
| A1 | 0.11 | 67 | — |
| | 0.083 | 57 | — |
| (B2.2) | 0.335 | 68 | — |
| | 0.25 | 60 | — |
| A1 + (B2.2) | 0.11 + 0.25 | 88 | 87 |
| | 0.083 + 0.335 | 87 | 86 |
| | 0.083 + 0.25 | 85 | 83 |

### Test Example 41

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.8 to 3.2 leaf stage, wettable powders of compound A1 and compound (D2.3) were, respectively, diluted with water and applied under submerged condition so that the active ingredients became the prescribed amounts, respectively. The state of growth was visually observed 21 days after application, and the growth inhibition rate (%) evaluated in the same manner as in the above Test Example 1 (observed value) and the growth inhibition rate (%) calculated by the above-mentioned Colby method (expected value) are shown in Tables 45.

TABLE 45

| | |
|---|---|
| Amount of | |
| application of | Growth inhibition |
| active | rate (%) |

| Compounds | ingredients (g/a) | Observed | Expected |
|---|---|---|---|
| A1 | 0.165 | 78 | — |
| | 0.11 | 67 | — |
| | 0.083 | 57 | — |
| (D2.3) | 3.75 | 0 | — |
| | 1.88 | 0 | — |
| A1 + (D2.3) | 0.165 + 3.75 | 87 | 78 |
| | 0.165 + 1.88 | 82 | 78 |
| | 0.11 + 3.75 | 83 | 67 |
| | 0.11 + 1.88 | 86 | 67 |
| | 0.083 + 3.75 | 80 | 57 |
| | 0.083 + 1.88 | 78 | 57 |

### Test Example 42

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.8 to 3.2 leaf stage, a wettable powder of compound A1 and an emulsifiable concentrate of compound (B3.1) were, respectively, diluted with water and applied under submerged condition so that the active ingredients became the prescribed amounts, respectively. The state of growth was visually observed 21 days after application, and the growth inhibition rate (%) evaluated in the same manner as in the above Test Example 1 (observed value) and the growth inhibition rate (%) calculated by the above-mentioned Colby method (expected value) are shown in Tables 46.

TABLE 46

| | |
|---|---|
| Amount of | |
| application of | Growth inhibition |
| active | rate (%) |

| Compounds | ingredients (g/a) | Observed | Expected |
|---|---|---|---|
| A1 | 0.165 | 78 | — |
| | 0.11 | 67 | — |
| | 0.083 | 57 | — |
| (B3.1) | 2 | 0 | — |
| | 1 | 0 | — |
| A1 + (B3.1) | 0.165 + 2 | 83 | 78 |
| | 0.165 + 1 | 80 | 78 |
| | 0.11 + 2 | 78 | 67 |
| | 0.11 + 1 | 75 | 67 |
| | 0.083 + 2 | 75 | 57 |
| | 0.083 + 1 | 75 | 57 |

### Test Example 43

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.8 to 3.2 leaf stage, a wettable powder of compound A1 and an emulsifiable concentrate of compound (B3.2) were, respectively, diluted with water and applied under submerged condition so that the active ingredients became the prescribed amounts, respectively. The state of growth was visually observed 21 days after application, and the growth inhibition rate (%) evaluated in the same manner as in the above Test Example 1 (observed value) and the growth inhibition rate (%) calculated by the above-mentioned Colby method (expected value) are shown in Tables 47.

TABLE 47

| | |
|---|---|
| Amount of | |
| application of | Growth inhibition rate |
| active | (%) |

| Compounds | ingredients (g/a) | Observed | Expected |
|---|---|---|---|
| A1 | 0.165 | 78 | — |
| | 0.11 | 67 | — |
| | 0.083 | 57 | — |
| (B3.2) | 1.88 | 15 | — |
| | 0.94 | 0 | — |
| A1 + (B3.2) | 0.165 + 1.88 | 84 | 82 |
| | 0.165 + 0.94 | 83 | 78 |
| | 0.11 + 1.88 | 84 | 72 |
| | 0.11 + 0.94 | 75 | 67 |
| | 0.083 + 1.88 | 80 | 63 |
| | 0.083 + 0.94 | 73 | 57 |

### Test Example 44

Paddy field soil was put into a 1/1,700 are pot, and seeds of Japanese bulrush (Scirpus juncoides) were sown and left to stand under an irrigated condition with a water depth of 3.5 cm. When Japanese bulrush reached 2.2 to 2.8 leaf stage, a wettable powder of compound A2, an emulsifiable concentrate of compound (B8.1) and a wettable powder of compound (B5.1) were, respectively, diluted with water and applied under submerged condition so that the active ingredients became the prescribed amounts, respectively. The state of growth was visually observed 29 days after application, and evaluated in the same manner as in the above Test Example 1. The results are shown in Table 48.

TABLE 48

| | | Growth inhibition |
|---|---|---|
| | Amount of application of | rate (%) |
| Compounds | active ingredients (g/a) | Observed |
| A2 | 0.22 | 87 |
| (B8.1) | 12 | 89 |
| | 9 | 89 |
| | 6 | 90 |
| (B5.1) | 4.5 | 25 |
| A2 + (B8.1) + (B5.1) | 0.22 + 12 + 4.5 | 93 |
| | 0.22 + 9 + 4.5 | 93 |
| | 0.22 + 6 + 4.5 | 97 |

### Test Example 45

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.4 to 3.2 leaf stage, wettable powders of compound A2, compound (B1.2) and compound (B5.1) were, respectively, diluted with water and applied under submerged condition so that the active ingredients became the prescribed amounts, respectively. The state of growth was visually observed 29 days after application, and evaluated in the same manner as in the above Test Example 1. The results are shown in Table 49.

TABLE 49

| | | Growth inhibition |
|---|---|---|
| | Amount of application of | rate (%) |
| Compounds | active ingredients (g/a) | Observed |
| A2 | 0.11 | 96 |
| (B1.2) | 0.075 | 60 |
| | 0.06 | 57 |
| | 0.03 | 30 |
| (B5.1) | 2.25 | 5 |
| A2 + (B1.2) + (B5.1) | 0.11 + 0.075 + 2.25 | 100 |
| | 0.11 + 0.06 + 2.25 | 97 |
| | 0.11 + 0.03 + 2.25 | 97 |

### Test Example 46

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (D2.3) and compound (B4.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 50.

TABLE 50

| | | Growth inhibition |
|---|---|---|
| | Amount of application of | rate (%) |
| Compounds | active ingredients (g/a) | Observed |
| A2 | 0.15 | 40 |
| (D2.3) | 6 | 20 |
| (B4.1) | 2 | 60 |
| A2 + (D2.3) + (B4.1) | 0.15 + 6 + 2 | 78 |

### Test Example 47

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (D2.3) and compound (B6.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 51.

TABLE 51

| | | Growth inhibition |
|---|---|---|
| | Amount of application of | rate (%) |
| Compounds | active ingredients (g/a) | Observed |
| A2 | 0.15 | 40 |
| (D2.3) | 6 | 20 |
| (B6.1) | 10 | 35 |
| A2 + (D2.3) + (B6.1) | 0.15 + 6 + 10 | 70 |

### Test Example 48

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (D2.3) and compound (B8.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 52.

TABLE 52

| | | Growth inhibition |
|---|---|---|
| | Amount of application of | rate (%) |
| Compounds | active ingredients (g/a) | Observed |
| A2 | 0.15 | 40 |
| (D2.3) | 6 | 20 |
| (B8.1) | 6 | 93 |
| A2 + (D2.3) + (B8.1) | 0.15 + 6 + 6 | 95 |

### Test Example 49

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (B3.2) and compound (B4.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 53.

TABLE 53

| | | Growth inhibition |
|---|---|---|
| | Amount of application of | rate (%) |
| Compounds | active ingredients (g/a) | Observed |
| A2 | 0.15 | 40 |
| (B3.2) | 2.5 | 35 |
| (B4.1) | 2 | 60 |
| A2 + (B3.2) + (B4.1) | 0.15 + 2.5 + 2 | 65 |

### Test Example 50

Paddy field soil was put into a 1/10,000 are pot, and seeds of Japanese bulrush (Scirpus juncoides) were sown and left to stand under an irrigated condition with a water depth of 3.5 cm. When Japanese bulrush reached 2.6 to 3.1 leaf stage, wettable powders of compound A2, compound (B3.2) and compound (B6.1) were, respectively, diluted with water and applied under submerged condition so that the active ingredients became the prescribed amounts, respectively. The state of growth was visually observed 22 days after application, and evaluated in the same manner as in the above Test Example 1. The results are shown in Table 54.

TABLE 54

| | | Growth inhibition |
|---|---|---|
| | Amount of application of | rate (%) |
| Compounds | active ingredients (g/a) | Observed |
| A2 | 0.15 | 93 |
| | 0.075 | 94 |
| A2 + (B3.2) + (B6.1) | 0.15 + 2.5 + 10 | 98 |
| | 0.075 + 1.25 + 5 | 97 |

### Test Example 51

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (B3.2) and compound (B8.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 55.

TABLE 55

| | | Growth inhibition |
|---|---|---|
| | Amount of application of | rate (%) |
| Compounds | active ingredients (g/a) | Observed |
| A2 | 0.15 | 40 |
| (B3.2) | 2.5 | 35 |
| (B8.1) | 6 | 93 |
| A2 + (B3.2) + (B8.1) | 0.15 + 2.5 + 6 | 100 |

### Test Example 52

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (B10.1) and compound (B4.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 56.

TABLE 56

| | | Growth inhibition |
|---|---|---|
| | Amount of application of | rate (%) |
| Compounds | active ingredients (g/a) | Observed |
| A2 | 0.15 | 40 |
| (B10.1) | 1.5 | 25 |
| (B4.1) | 2 | 60 |
| A2 + (B10.1) + (B4.1) | 0.15 + 1.5 + 2 | 65 |

### Test Example 53

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, compound A2, compound (B10.1) and compound (B8.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 57.

TABLE 57

| | | Growth inhibition |
|---|---|---|
| | Amount of application of | rate (%) |
| Compounds | active ingredients (g/a) | Observed |
| A2 | 0.15 | 40 |
| (B10.1) | 1.5 | 25 |
| (B8.1) | 6 | 93 |
| A2 + (B10.1) + (B8.1) | 0.15 + 1.5 + 6 | 98 |

### Test Example 54

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (B9.1) and compound (B4.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 58.

TABLE 58

| | | Growth inhibition |
|---|---|---|
| | Amount of application of | rate (%) |
| Compounds | active ingredients (g/a) | Observed |
| A2 | 0.15 | 40 |
| (B9.1) | 2.1 | 35 |
| (B4.1) | 2 | 60 |
| A2 + (B9.1) + (B4.1) | 0.15 + 2.1 + 2 | 65 |

### Test Example 55

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (B9.1) and compound (B6.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 59.

TABLE 59

| | | Growth inhibition |
|---|---|---|
| | Amount of application of | rate (%) |
| Compounds | active ingredients (g/a) | Observed |
| A2 | 0.15 | 40 |
| (B9.1) | 2.1 | 35 |
| (B6.1) | 10 | 35 |
| A2 + (B9.1) + (B6.1) | 0.15 + 2.1 + 10 | 60 |

### Test Example 56

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, compound A2, compound (B9.1) and compound (B8.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 60.

TABLE 60

| | | Growth inhibition |
|---|---|---|
| | Amount of application of | rate (%) |
| Compounds | active ingredients (g/a) | Observed |
| A2 | 0.15 | 40 |
| (B9.1) | 2.1 | 35 |
| (B8.1) | 6 | 93 |
| A2 + (B9.1) + (B8.1) | 0.15 + 2.1 + 6 | 100 |

### Test Example 57

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (B3.1) and compound (B4.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 61.

TABLE 61

| | | Growth inhibition |
|---|---|---|
| | Amount of application of | rate (%) |
| Compounds | active ingredients (g/a) | Observed |
| A2 | 0.15 | 40 |
| (B3.1) | 4 | 20 |
| (B4.1) | 2 | 60 |
| A2 + (B3.1) + (B4.1) | 0.15 + 4 + 2 | 65 |

### Test Example 58

Paddy field soil was put into a 1/10,000 are pot, and seeds of Japanese bulrush (Scirpus juncoides) were sown and left to stand under an irrigated condition with a water depth of 3.5 cm. When Japanese bulrush reached 2.6 to 3.1 leaf stage, wettable powders of compound A2, compound (B3.1) and compound (B6.1) were, respectively, diluted with water and applied under submerged condition so that the active ingredients became the prescribed amounts, respectively. The state of growth was visually observed 22 days after application, and evaluated in the same manner as in the above Test Example 1. The results are shown in Table 62.

TABLE 62

| | | Growth inhibition |
|---|---|---|
| | Amount of application of | rate (%) |
| Compounds | active ingredients (g/a) | Observed |
| A2 | 0.15 | 93 |
| | 0.075 | 94 |
| A2 + (B3.1) + (B6.1) | 0.15 + 4 + 10 | 97 |
| | 0.075 + 2 + 5 | 98 |

### Test Example 59

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (B3.1) and compound (B8.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 63.

TABLE 63

| | | Growth inhibition |
|---|---|---|
| | Amount of application of | rate (%) |
| Compounds | active ingredients (g/a) | Observed |
| A2 | 0.15 | 40 |
| (B3.1) | 4 | 20 |
| (B8.1) | 6 | 93 |
| A2 + (B3.1) + (B8.1) | 0.15 + 4 + 6 | 100 |

### Test Example 60

Paddy field soil was put into a 1/10,000 are pot, and tubers of flatsedge (Cyperus serotinus) were planted and left to stand under an irrigated condition with a water depth of 3.5 cm. When flatsedge reached 2.5 to 3.0 leaf stage, wettable powders of compound A2, compound (D1.1) and compound (B4.1) were, respectively, diluted with water and applied under submerged condition so that the active ingredients became the prescribed amounts, respectively. The state of growth was visually observed 30 days after application, and evaluated in the same manner as in the above Test Example 1. The results are shown in Table 64.

TABLE 64

| | | Growth inhibition |
|---|---|---|
| | Amount of application of | rate (%) |
| Compounds | active ingredients (g/a) | Observed |
| A2 | 0.15 | 40 |
| (D1.1) | 15 | 20 |
| (B4.1) | 2 | 60 |
| A2 + (D1.1) + (B4.1) | 0.15 + 15 + 2 | 65 |

### Test Example 61

Paddy field soil was put into a 1/10,000 are pot, and seeds of Japanese bulrush (Scirpus juncoides) were sown and left to stand under an irrigated condition with a water depth of 3.5 cm. When Japanese bulrush reached 3.8 to 4.2 leaf stage, a wettable powder of compound A1 and granules of compound (B7.1) were, respectively, diluted with water and applied under submerged condition so that the active ingredients became the prescribed amounts, respectively. The state of growth was visually observed 21 days after application, and evaluated in the same manner as in the above Test Example 1. The results are shown in Table 65.

TABLE 65

| | |
|---|---|
| Amount of | |
| application of | Growth inhibition rate |
| active | (%) |

| Compounds | ingredients (g/a) | Observed | Expected |
|---|---|---|---|
| A1 | 0.11 | 65 | — |
| (B7.1) | 7.5 | 98 | — |
| A1 + (B7.1) | 0.11 + 7.5 | 100 | 99 |

### Test Example 62

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.2 leaf stage, wettable powders of compound A1 and compound (B9.1) were, respectively, diluted with water and applied under submerged condition so that the active ingredients became the prescribed amounts, respectively. The state of growth was visually observed 19 days after application, and evaluated in the same manner as in the above Test Example 1. The results are shown in Table 66.

TABLE 66

| | |
|---|---|
| Amount of | |
| application of | Growth inhibition rate |
| active | (%) |

| Compounds | ingredients (g/a) | Observed | Expected |
|---|---|---|---|
| A1 | 0.165 | 94 | — |
| | 0.11 | 93 | — |
| | 0.083 | 55 | — |
| (B9.1) | 1.58 | 10 | — |
| | 0.788 | 10 | — |
| A1 + (B9.1) | 0.165 + 1.58 | 97 | 95 |
| | 0.165 + 0.788 | 98 | 95 |
| | 0.11 + 0.788 | 99 | 93 |
| | 0.083 + 1.58 | 80 | 60 |
| | 0.083 + 0.788 | 93 | 60 |

### Test Example 63

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.2 leaf stage, wettable powders of compound A2 and compound (B1.6) were, respectively, diluted with water and applied under submerged condition so that the active ingredients became the prescribed amounts, respectively. The state of growth was visually observed 19 days after application, and evaluated in the same manner as in the above Test Example 1. The results are shown in Table 67.

TABLE 67

| | |
|---|---|
| Amount of | |
| application of | Growth inhibition |
| active | rate (%) |

| Compounds | ingredients (g/a) | Observed | Expected |
|---|---|---|---|
| A2 | 0.165 | 73 | — |
| | 0.11 | 68 | — |
| | 0.083 | 55 | — |
| (B1.6) | 0.6 | 40 | — |
| | 0.3 | 25 | — |
| A2 + (B1.6) | 0.165 + 0.6 | 100 | 84 |
| | 0.165 + 0.3 | 100 | 79 |
| | 0.11 + 0.6 | 100 | 81 |
| | 0.11 + 0.3 | 100 | 76 |
| | 0.083 + 0.6 | 95 | 73 |
| | 0.083 + 0.3 | 95 | 66 |

### Test Example 64

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.2 leaf stage, wettable powders of compound A2 and compound (B4.5) (pyrazolate) were, respectively, diluted with water and applied under submerged condition so that the active ingredients became the prescribed amounts, respectively. The state of growth was visually observed 19 days after application, and evaluated in the same manner as in the above Test Example 1. The results are shown in Table 68.

TABLE 68

| | |
|---|---|
| Amount of | |
| application of | Growth inhibition |
| active | rate (%) |

| Compounds | ingredients (g/a) | Observed | Expected |
|---|---|---|---|
| A2 | 0.165 | 73 | — |
| | 0.11 | 68 | — |
| | 0.083 | 55 | — |
| (B4.5) | 10 | 0 | — |
| | 5 | 0 | — |
| A2 + (B4.5) | 0.165 + 10 | 99 | 73 |
| | 0.165 + 5 | 100 | 73 |
| | 0.11 + 10 | 93 | 68 |
| | 0.11 + 5 | 93 | 68 |
| | 0.083 + 10 | 80 | 55 |
| | 0.083 + 5 | 80 | 55 |

### Test Example 65

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.2 leaf stage, wettable powders of compound A2 and compound (B4.6) were, respectively, diluted with water and applied under submerged condition so that the active ingredients became the prescribed amounts, respectively. The state of growth was visually observed 19 days after application, and evaluated in the same manner as in the above Test Example 1. The results are shown in Table 69.

TABLE 69

| | |
|---|---|
| Amount of | |
| application of | Growth inhibition |
| active | rate (%) |

| Compounds | ingredients (g/a) | Observed | Expected |
|---|---|---|---|
| A2 | 0.165 | 73 | — |
| | 0.11 | 68 | — |
| | 0.083 | 55 | — |
| (B4.6) | 10 | 0 | — |
| | 5 | 0 | — |
| A2 + (B4.6) | 0.165 + 10 | 100 | 73 |
| | 0.165 + 5 | 100 | 73 |
| | 0.11 + 10 | 99 | 68 |
| | 0.11 + 5 | 95 | 68 |
| | 0.083 + 10 | 78 | 55 |
| | 0.083 + 5 | 85 | 55 |

### Test Example 66

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.4 leaf stage, wettable powders of compound A1 and compound (B1.1) were, respectively, diluted with water and applied under submerged condition so that the active ingredients became the prescribed amounts, respectively. The state of growth was visually observed 14 days after application, and evaluated in the same manner as in the above Test Example 1. The results are shown in Table 70.

TABLE 70

| | |
|---|---|
| Amount of | |
| application of | Growth inhibition |
| active | rate (%) |

| Compounds | ingredients (g/a) | Observed | Expected |
|---|---|---|---|
| A1 | 0.11 | 53 | — |
| | 0.083 | 40 | — |
| (B1.1) | 0.51 | 45 | — |
| | 0.255 | 30 | — |
| A1 + (B1.1) | 0.11 + 0.51 | 75 | 74 |
| | 0.11 + 0.255 | 68 | 67 |
| | 0.083 + 0.51 | 68 | 67 |
| | 0.083 + 0.255 | 60 | 58 |

### Test Example 67

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.4 leaf stage, wettable powders of compound A1 and compound (B1.4) were, respectively, diluted with water and applied under submerged condition so that the active ingredients became the prescribed amounts, respectively. The state of growth was visually observed 14 days after application, and evaluated in the same manner as in the above Test Example 1. The results are shown in Table 71.

TABLE 71

| | |
|---|---|
| Amount of | |
| application of | Growth inhibition |
| active | rate (%) |

| Compounds | ingredients (g/a) | Observed | Expected |
|---|---|---|---|
| A1 | 0.165 | 70 | — |
| | 0.11 | 53 | — |
| | 0.083 | 40 | — |
| (B1.4) | 0.9 | 40 | — |
| | 0.45 | 25 | — |
| A1 + (B1.4) | 0.165 + 0.9 | 83 | 82 |
| | 0.165 + 0.45 | 88 | 78 |
| | 0.11 + 0.9 | 73 | 72 |
| | 0.11 + 0.45 | 65 | 64 |
| | 0.083 + 0.9 | 78 | 64 |
| | 0.083 + 0.45 | 75 | 55 |

### Test Example 68

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.4 leaf stage, wettable powders of compound A1 and compound (B1.5) were, respectively, diluted with water and applied under submerged condition so that the active ingredients became the prescribed amounts, respectively. The state of growth was visually observed 14 days after application, and evaluated in the same manner as in the above Test Example 1. The results are shown in Table 72.

TABLE 72

| | |
|---|---|
| Amount of | |
| application of | Growth inhibition |
| active | rate (%) |

| Compounds | ingredients (g/a) | Observed | Expected |
|---|---|---|---|
| A1 | 0.165 | 70 | — |
| | 0.11 | 53 | — |
| | 0.083 | 40 | — |
| (B1.5) | 0.21 | 20 | — |
| | 0.105 | 10 | — |
| A1 + (B1.5) | 0.165 + 0.21 | 83 | 76 |
| | 0.165 + 0.105 | 75 | 73 |
| | 0.11 + 0.21 | 83 | 62 |
| | 0.11 + 0.105 | 68 | 57 |
| | 0.083 + 0.21 | 73 | 52 |
| | 0.083 + 0.105 | 73 | 46 |

### Test Example 69

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.4 leaf stage, wettable powders of compound A1 and compound (B2.1) were, respectively, diluted with water and applied under submerged condition so that the active ingredients became the prescribed amounts, respectively. The state of growth was visually observed 14 days after application, and evaluated in the same manner as in the above Test Example 1. The results are shown in Table 73.

TABLE 73

| | |
|---|---|
| Amount of | |
| application of | Growth inhibition |
| active | rate (%) |

| Compounds | ingredients (g/a) | Observed | Expected |
|---|---|---|---|
| A1 | 0.11 | 53 | — |
| | 0.083 | 40 | — |
| (B2.1) | 0.9 | 60 | — |
| A1 + (B2.1) | 0.11 + 0.9 | 93 | 81 |
| | 0.083 + 0.9 | 88 | 76 |

### Test Example 70

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.4 leaf stage, a wettable powder of compound A1 and an emulsifiable concentrate of compound (B4.2) were, respectively, diluted with water and applied under submerged condition so that the active ingredients became the prescribed amounts, respectively. The state of growth was visually observed 14 days after application, and evaluated in the same manner as in the above Test Example 1. The results are shown in Table 74.

TABLE 74

| | |
|---|---|
| Amount of | |
| application of | Growth inhibition |
| active | rate (%) |

| Compounds | ingredients (g/a) | Observed | Expected |
|---|---|---|---|
| A1 | 0.165 | 70 | — |
| | 0.11 | 53 | — |
| | 0.083 | 40 | — |
| (B4.2) | 0.5 | 0 | — |
| | 0.25 | 0 | — |
| A1 + (B4.2) | 0.165 + 0.5 | 88 | 70 |
| | 0.165 + 0.25 | 78 | 70 |
| | 0.11 + 0.5 | 70 | 53 |
| | 0.11 + 0.25 | 73 | 53 |
| | 0.083 + 0.5 | 60 | 40 |
| | 0.083 + 0.25 | 70 | 40 |

### Test Example 71

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.4 leaf stage, wettable powders of compound A1 and compound (B4.4) were, respectively, diluted with water and applied under submerged condition so that the active ingredients became the prescribed amounts, respectively. The state of growth was visually observed 14 days after application, and evaluated in the same manner as in the above Test Example 1. The results are shown in Table 75.

TABLE 75

| | |
|---|---|
| Amount of | |
| application of | Growth inhibition |
| active | rate (%) |

| Compounds | ingredients (g/a) | Observed | Expected |
|---|---|---|---|
| A1 | 0.165 | 70 | — |
| | 0.11 | 53 | — |
| | 0.083 | 40 | — |
| (B4.4) | 2.25 | 0 | — |
| | 1.125 | 0 | — |
| A1 + (B4.4) | 0.165 + 2.25 | 73 | 70 |
| | 0.165 + 1.125 | 73 | 70 |
| | 0.11 + 2.25 | 55 | 53 |
| | 0.11 + 1.125 | 65 | 53 |
| | 0.083 + 2.25 | 45 | 40 |
| | 0.083 + 1.125 | 43 | 40 |

### Test Example 72

Paddy field soil was put into a 1/10,000 are pot, and seeds of barnyardgrass (Echinochloa oryzicola vasting) were sown and left to stand under an irrigated condition with a water depth of 3.5 cm. When barnyardgrass reached 2.8 to 3.4 leaf stage, wettable powders of compound A1 and compound (B6.1) were, respectively, diluted with water and applied under submerged condition so that the active ingredients became the prescribed amounts, respectively. The state of growth was visually observed 14 days after application, and evaluated in the same manner as in the above Test Example 1. The results are shown in Table 76.

TABLE 76

| | |
|---|---|
| Amount of | |
| application of | Growth inhibition |
| active | rate (%) |

| Compounds | ingredients (g/a) | Observed | Expected |
|---|---|---|---|
| A1 | 0.165 | 70 | — |
| | 0.11 | 53 | — |
| | 0.083 | 40 | — |
| (B6.1) | 10 | 10 | — |
| | 5 | 10 | — |
| A1 + (B6.1) | 0.165 + 10 | 75 | 73 |
| | 0.11 + 10 | 78 | 57 |
| | 0.11 + 5 | 58 | 57 |
| | 0.083 + 10 | 65 | 46 |
| | 0.083 + 5 | 68 | 46 |

### INDUSTRIAL APPLICABILITY

The herbicidal composition of the present invention is capable of controlling a wide range of weeds emerging in cropland or non-cropland, since not only it can be applied at a low dose as compared with a case where the respective active ingredients are applied individually, but also the herbicidal spectrum will be enlarged, and further the herbicidal effect will last over a long period of time.

The entire disclosures of Japanese Patent Application No. 2004-271283 filed on Sep. 17, 2004, Japanese Patent Application No. 2004-307850 filed on Oct. 22, 2004, Japanese Patent Application No. 2004-334938 filed on Nov. 18, 2004, Japanese Patent Application No. 2004-353851 filed on Dec. 7, 2004, Japanese Patent Application No. 2004-367296 filed on Dec. 20, 2004, Japanese Patent Application No. 2005-035195 filed on Feb. 10, 2005, Japanese Patent Application No. 2005-051663 filed on Feb. 25, 2005, Japanese Patent Application No. 2005-067110 filed on Mar. 10, 2005 and Japanese Patent Application No. 2005-202840 filed on Jul. 12, 2005 including specifications, claims and summaries are incorporated herein by reference in their entireties.

1. A herbicidal composition comprising (α): {a compound of the formula (I) or its salt: 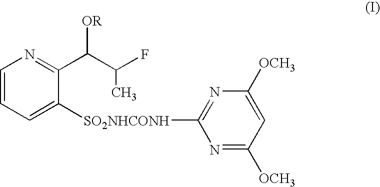
wherein R is a hydrogen atom or —COCH₂OCH₃} and
(β): at least one compound selected from the group consisting of [(B): {at least one sulfonylurea compound selected from (B1.1) bensulfuron-methyl, (B1.2) azimsulfuron, (B1.3) pyrazosulfuron-ethyl, (B1.4) imazosulfuron, (B1.5) ethoxysulfuron and (B1.6) halosulfuron-methyl;
at least one pyrimidinyl salicylic acid compound selected from (B2.1) pyriminobac-methyl and (B2.2) KUH-021;
at least one acetamide compound selected from (B3.1) pretilachlor and (B3.2) thenylchlor;
at least one benzoyl compound selected from (B4.1) benzobicyclon, (B4.2) mesotrione, (B4.3) pyrazoxyfen, (B4.4) AVH-301, (B4.5) pyrazolynate and (B4.6) benzofenap;
(B5.1) simetryn;
at least one cumylamine compound selected from
(B6.1) bromobutide and (B6.2) cumyluron;
(B7.1) bentazone;
(B8.1) benfuresate;
(B9.1) cafenstrole;
(B10.1) indanofan; and
(B11.1) penoxsulam},
(C): {a compound of the formula (II), its salt or its ester: 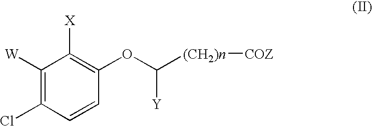
wherein W is a hydrogen atom or a methyl group, X is a chlorine atom or a methyl group, Y is a hydrogen atom or a methyl group, n is 0, 1 or 2, Z is —OH, —SH or —NT₁T₂, and each of T₁ and T₂ is a hydrogen atom, an alkyl group or a phenyl group which may be substituted}, and
(D): {(D1.1) 1-(1-methyl-1-phenylethyl)-3-p-tolylurea, (D2.1) S-1-methyl-1-phenylethyl piperidine-1-carbothioate, (D2.2) S-ethyl azepane-1-carbothioate, (D2.3) O-3-tert-butylphenyl 6-methoxy-2-pyridyl(methyl)thiocarbamate and their salts}] as active ingredients.

2. The herbicidal composition according to claim 1, wherein the compound (β) is at least one compound selected from the group consisting of (B): {at least one sulfonylurea compound selected from (B1.1) bensulfuron-methyl, (B1.2) azimsulfuron, (B1.3) pyrazosulfuron-ethyl, (B1.4) imazosulfuron, (B1.5) ethoxysulfuron and (B1.6) halosulfuron-methyl;
at least one pyrimidinyl salicylic acid compound selected from (B2.1) pyriminobac-methyl and (B2.2) KUH-021;
at least one acetamide compound selected from (B3.1) pretilachlor and (B3.2) thenylchlor;
at least one benzoyl compound selected from (B4.1) benzobicyclon, (B4.2) mesotrione, (B4.3) pyrazoxyfen, (B4.4) AVH-301, (B4.5) pyrazolynate and (B4.6) benzofenap;
(B5.1) simetryn;
at least one cumylamine compound selected from (B6.1) bromobutide and (B6.2) cumyluron;
(B7.1) bentazone;
(B8.1) benfuresate;
(B9.1) cafenstrole;
(B10.1) indanofan; and
(B11.1) penoxsulam}.

3. The herbicidal composition according to claim 1, wherein the compound (β) is at least one compound selected from the group consisting of (B1.1) bensulfuron-methyl, (B1.2) azimsulfuron, (B1.3) pyrazosulfuron-ethyl, (B1.4) imazosulfuron, (B1.5) ethoxysulfuron, (B1.6) halosulfuron-methyl, (B2.1) pyriminobac-methyl, (B2.2) KUH-021 and (B11.1) penoxsulam}, which shows amino acid biosynthesis inhibition.

4. The herbicidal composition according to claim 1, wherein the compound (β) is at least one compound selected from the group consisting of (B3.1) pretilachlor, (B3.2) thenylchlor and (B8.1) benfuresate, which shows lipid biosynthesis inhibition.

5. The herbicidal composition according to claim 1, wherein the compound (β) is at least one compound selected from the group consisting of (B4.1) benzobicyclon, (B4.2) mesotrione, (B4.3) pyrazoxyfen, (B4.4) AVH-301, (B4.5) pyrazolynate and (B4.6) benzofenap, which shows plant chromogenesis inhibition.

6. The herbicidal composition according to claim 1, wherein the compound (β) is at least one compound selected from the group consisting of (B5.1) simetryn and (B7.1) bentazone, which shows photosynthesis inhibition.

7. The herbicidal composition according to claim 1, wherein the compound (β) is at least one compound selected from the group consisting of (B6.1) bromobutide, (B6.2) cumyluron, (B9.1) cafenstrole and (B10.1) indanofan, which shows cell mitosis inhibition.

8. The herbicidal composition according to claim 1, wherein the compound (β) is at least one compound selected from the group consisting of (C): {a compound of the formula (II), its salt or its ester: 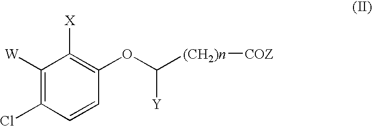
wherein W is a hydrogen atom or a methyl group, X is a chlorine atom or a methyl group, Y is a hydrogen atom or a methyl group, n is 0, 1 or 2, Z is —OH, —SH or —NT₁T₂, and each of T₁ and T₂ is a hydrogen atom, an alkyl group or a phenyl group which may be substituted}.

9. The herbicidal composition according to claim 1, wherein the compound (β) is at least one compound selected from the group consisting of (C1) 2-methyl-4-chlorophenoxyacetic acid (MCP), (C2) ethyl 2-methyl-4-chlorophenoxyacetate (MCP ethyl), (C3) 4-(2-methyl-4-chlorophenoxy)butyric acid (MCPB), (C4) ethyl 4-(2-methyl-4-chlorophenoxy)butyrate (MCPB ethyl), (C5) 2,4-dichlorophenoxyacetic acid (2,4-D) and (C6) ethyl 2,4-dichlorophenoxyacetate (2,4-D ethyl).

10. The herbicidal composition according to claim 1, wherein the compound (β) is at least one compound selected from the group consisting of (C2) MCP ethyl, (C4) MCPB ethyl and (C6) 2,4-D ethyl.

11. The herbicidal composition according to claim 1, wherein the compound (β) is at least one compound selected from the group consisting of (D): {(D1.1) 1-(1-methyl-1-phenylethyl)-3-p-tolylurea, (D2.1) S-1-methyl-1-phenylethyl piperidine-1-carbothioate, (D2.2) S-ethyl azepane-1-carbothioate, (D2.3) O-3-tert-butylphenyl 6-methoxy-2-pyridyl(methyl)thiocarbamate and their salts}.

12. The herbicidal composition according to claim 1, wherein the weight ratio of the compound (α) to the compound (D) is within a range of from 1:1,000 to 50:1.

13. The herbicidal composition according to claim 1, wherein the compound (β) is (D1.1) 1-(1-methyl-1-phenylethyl)-3-p-tolylurea.

14. The herbicidal composition according to claim 1, wherein the compound (β) is at least one carbamate compound selected from (D2.1) S-1-methyl-1-phenylethyl piperidine-1-carbothioate, (D2.2) S-ethyl azepane-1-carbothioate and (D2.3) O-3-tert-butylphenyl 6-methoxy-2-pyridyl(methyl)thiocarbamate.

15. The herbicidal composition according to claim 1, wherein the compound (D) is (D1.1) 1-(1-methyl-1-phenylethyl)-3-p-tolylurea, which shows cell mitosis inhibition.

16. The herbicidal composition according to claim 1, wherein the compound (D) is at least one compound selected from (D2.1) S-1-methyl-1-phenylethyl piperidine-1-carbothioate, (D2.2) S-ethyl azepane-1-carbothioate and (D2.3) O-3-tert-butylphenyl 6-methoxy-2-pyridyl(methyl)thiocarbamate, which shows lipid biosynthesis inhibition.

17. A method for controlling undesired plants or inhibiting their growth while reducing unfavorable effects of the compound (α) as defined in claim 1 against crop plants, which comprises applying an effective amount of the herbicidal composition containing the compound (α) and at least one compound selected from (D).

18. A method for controlling undesired plants or inhibiting their growth while reducing unfavorable effects of the compound (α) as defined in claim 1 against crop plants, which comprises applying an effective amount of the compound (α) and an effective amount of at least one compound selected from (D).

19. A method for reducing unfavorable effects of the compound (α) as defined in claim 1 against crop plants, which comprises applying an effective amount of the herbicidal composition containing the compound (α) and at least one compound selected from (D).

20. A method for reducing unfavorable effects of the compound (α) as defined in claim 1 against crop plants, which comprises applying an effective amount of the compound (α) and an effective amount of at least one compound selected from (D).

21. A method for controlling undesired plants or inhibiting their growth, which comprises applying an effective amount of the herbicidal composition containing the compound (α) and at least one compound selected from (D) as defined in claim 1.

22. A method for controlling undesired plants or inhibiting their growth, which comprises applying an effective amount of the compound (α) and an effective amount of at least one compound selected from (D) as defined in claim 13.

23. A method for reducing unfavorable effects of (α): {a compound of the formula (I) or its salt: 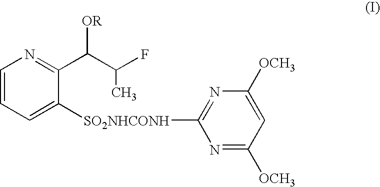
wherein R is a hydrogen atom or —COCH₂OCH₃} against crop plants, by at least one compound selected from the group consisting of (D): {(D1.1) 1-(1-methyl-1-phenylethyl)-3-p-tolylurea, (D2.1) S-1-methyl-1-phenylethyl piperidine-1-carbothioate, (D2.2) S-ethyl azepane-1-carbothioate, (D2.3) O-3-tert-butylphenyl 6-methoxy-2-pyridyl(methyl)thiocarbamate and their salts}.

24. A method for controlling undesired plants or inhibiting their growth, which comprises applying a herbicidally effective amount of the herbicidal composition as defined in claim 1.

25. A method for controlling undesired plants or inhibiting their growth, which comprises applying a herbicidally effective amount of the compound (α) or its salt and a herbicidally effective amount of the compound (β) as defined in claim 1.
